(19) United States
(12) Patent Application Publication
(10) Pub. No.: US 2026/0308192 A1
(43) Pub. Date: Oct. 8, 2026

(54) METALLOCENE COMPOUNDS AND METHOD FOR SYNTHESIS OF MONOCYCLOPENTADIENYL, MONOINDENYL, AND MONOFLUORENYL METALLOCENE COMPOUNDS

(71) Applicant: Chevron Phillips Chemical Company LP, The Woodlands, TX (US)

(72) Inventor: Chengbao NI, Bartlesville, OK (US)

(21) Appl. No.: 19/571,125

(22) Filed: Mar. 18, 2026

Related U.S. Application Data
(60) Provisional application No. 63/774,678, filed on Mar. 19, 2025.
(60) Provisional application No. 63/827,662, filed on Jun. 20, 2025.

(51) Int. Cl. C07F 17/00

(52) U.S. Cl. CPC C07F 17/00

(57) ABSTRACT

Aspects of the present disclosure generally relate to new methods of synthesizing monocyclopentadienyl, monoindenyl, and monofluorenyl metallocene compounds. These metallocene compounds may be utilized, for example, in the synthesis of unbridged asymmetric metallocene compounds. In an aspect is provided a method for synthesizing a mono-Cp metallocene compound. The method includes reacting a first mixture comprising a metallocene compound represented by formula (I) ((Cp^{A})₂M(X)₂), a metal salt, and a solvent to form a reaction product mixture comprising a liquid component and an optional solid component. The method further includes reacting a second mixture comprising the liquid component of the reaction product mixture and a donor molecule to form a mono-Cp metallocene compound represented by formula (II) ((Cp^{A})M(X)₃ (D)ₙ).

### CROSS-REFERENCE TO RELATED APPLICATIONS

This application claims benefit of and priority to U.S. Provisional Patent Application Ser. No. 63/774,678, filed on Mar. 19, 2025, and U.S. Provisional Patent Application Ser. No. 63/827,662, filed on Jun. 20, 2025, each of which is incorporated herein by reference in its entirety.

### FIELD

Aspects of the present disclosure generally relate to new methods of synthesizing monocyclopentadienyl, monoindenyl, and monofluorenyl metallocene compounds. These metallocene compounds may be utilized, for example, in the synthesis of unbridged asymmetric metallocene compounds.

### BACKGROUND

Monocyclopentadienyl, monoindenyl, and monofluorenyl zirconium trichloride compounds (collectively, mono-Cp metallocene compounds) are precursors to unbridged asymmetric metallocene compounds (collectively, bis-Cp metallocene compounds) that are a component of catalysts used in olefin polymerization processes. Various synthetic methods exist for forming such mono-cyclopentadienyl, -indenyl, and -fluorenyl compounds, each having their own set of challenges ranging from poor selectivity to complicated operation, among other challenges. One conventional method uses alkali metal-organic compounds, M-R, where Mis Li, Na, or K; and R is cyclopentadienyl, indenyl, or fluorenyl. This method involves the reaction of one equivalent of M-R with one equivalent of a metal salt such as zirconium tetrachloride (ZrCl₄). However, this reaction is non-selective, forming a complex mixture that includes the desired mono-Cp product (CpZrCl₃), and bis-Cp product (Cp₂ZrCl₂), where Cp refers to cyclopentadienyl, indenyl, or fluorenyl, and unreacted ZrCl₄. The crude product mixture also includes oligomers ({CpZrCl₃}n, n=2, 3, 4 . . . ) and byproducts. In addition, the mono-Cp product, CpZrCl₃, tends to form these oligomers and byproducts during solvent removal, further complicating this method. Another conventional method uses sublimation and complex work-up protocols. As an example of this sublimation method, monocyclopentadienyl zirconium trichloride is first sublimed from a melt of Cp₂ZrCl₂ and ZrCl₄. The solid sublimed material is then scraped out of the apparatus and/or off the cold finger and dissolved in toluene. Next, 1,3-dimethoxyethane is added to the dissolved substance, and the desired product is precipitated. This sublimation method requires many steps, thereby lowering efficiencies and increasing costs. Moreover, sublimation is challenging to scale up to industrial levels of production and some monocyclopentadienyl, monoindenyl, and monofluorenyl metallocene compounds do not possess the volatility necessary for sublimation. Overall, conventional methods of forming monocyclopentadienyl, monoindenyl, and monofluorenyl metallocene compounds require multiple steps or stages to obtain final products, include difficult operations to isolate and purify desired products, and are challenging to implement efficiently and cost-effectively on industrial scales.

There is a need for new methods of synthesizing monocyclopentadienyl, monoindenyl, and monofluorenyl metallocene compounds.

### SUMMARY

Aspects of the present disclosure generally relate to new methods of synthesizing monocyclopentadienyl, monoindenyl, and monofluorenyl metallocene compounds. As described herein, the inventor found a unique method for synthesizing the aforementioned mono-Cp metallocene compounds. The method may include reacting a biscyclopentadienyl, bisindenyl, or bisfluorenyl metallocene compound with a metal salt to form a reaction product mixture (or reaction solution). A donor molecule may then be added to the reaction product mixture to form the monocyclopentadienyl, monoindenyl, and monofluorenyl metallocene compound as a donor adduct. Use of the donor molecule allows for improved isolation and purification of the desired mono-Cp metallocene product. These monocyclopentadienyl, monoindenyl, and monofluorenyl metallocene compounds (donor adducts) may be utilized, for example, in the synthesis of bis-Cp metallocene compounds such as unbridged asymmetric metallocene compounds. The unbridged asymmetric metallocene compounds may be used as catalysts in, for example, olefin polymerization processes. Relative to state-of-the-art technologies, aspects described herein advantageously enable synthesis of mono-Cp metallocene compounds with high selectivity and high conversion. In addition, aspects of the present disclosure may be performed on industrial scales. Further, mono-Cp metallocene compounds formed by aspects described herein may have a longer shelf-life than conventional mono-Cp metallocene compounds.

In an aspect, a method of synthesizing a mono-Cp metallocene compound is provided. The method includes reacting a first mixture comprising a bis-Cp metallocene compound represented by formula (I), a metal salt, and a solvent to form a reaction product mixture comprising a liquid component and an optional solid component, the bis-Cp metallocene compound represented by formula (I) is:

(Cp^{A})₂M(X)₂ (I),

wherein: M of formula (I) is a Group 4 metal; Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; and each X of formula (I) is, independently, halogen (such as F, Cl, Br, or I), H (hydride), unsubstituted hydrocarbyl, substituted hydrocarbyl, or a functional group comprising at least one element from Group 13-16 of the periodic table of the elements. The method further includes reacting a second mixture comprising the liquid component of the reaction product mixture and a donor molecule to form a mono-Cp metallocene compound represented by formula (II):

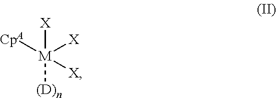

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, halogen (such as F, Cl, Br, or I), H (hydride), unsubstituted hydrocarbyl, substituted hydrocarbyl, or a functional group comprising at least one element from Group 13-16 of the periodic table of the elements; D of formula (II) is, independently, a monodentate donor ligand or a bidentate donor ligand; D and X of formula (II) are different; and n of formula (II) is a number greater than 0.

In another aspect, a method of synthesizing a mono-Cp metallocene compound is provided. The method includes reacting a first mixture comprising a bis-Cp metallocene compound represented by formula (I), a metal salt, and a solvent to form a reaction product mixture comprising a liquid component and a solid component, the bis-Cp metallocene compound represented by formula (I) is:

(Cp^{A})₂M(X)₂ (I),

wherein: M of formula (I) is a Group 4 metal; Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; and each X of formula (I) is, independently, halogen (such as F, Cl, Br, or I), H (hydride), unsubstituted hydrocarbyl, substituted hydrocarbyl, or a functional group comprising at least one element from Group 13-16 of the periodic table of the elements. The method further includes separating the liquid component of the reaction product mixture from the solid component of the reaction product mixture. The method further includes reacting a second mixture comprising the liquid component of the reaction product mixture and a donor molecule to form a mono-Cp metallocene compound represented by formula (II):

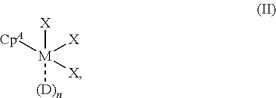

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, halogen (such as F, Cl, Br, or I), H (hydride), unsubstituted hydrocarbyl, substituted hydrocarbyl, or a functional group comprising at least one element from Group 13-16 of the periodic table of the elements; D of formula (II) is, independently, a monodentate donor ligand or a bidentate donor ligand; D and X of formula (II) are different; and n of formula (II) is a number greater than 0.

In another aspect, a method of synthesizing an unbridged asymmetric bis-Cp metallocene compound is provided. The method includes reacting a first mixture comprising a bis-Cp metallocene compound represented by formula (I), a metal salt, and a solvent to form a reaction product mixture comprising a liquid component and an optional solid component, the bis-Cp metallocene compound represented by formula (I) is:

(Cp^{A})₂M(X)₂ (I),

wherein: M of formula (I) is a Group 4 metal; Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; and each X of formula (I) is, independently, halogen (such as F, Cl, Br, or I), H (hydride), unsubstituted hydrocarbyl, substituted hydrocarbyl, or a functional group comprising at least one element from Group 13-16 of the periodic table of the elements. The method further includes reacting a second mixture comprising the liquid component of the reaction product mixture and a donor molecule to form a mono-Cp metallocene compound represented by formula (II):

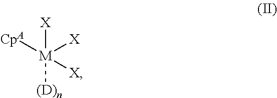

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, halogen (such as F, Cl, Br, or I), H (hydride), unsubstituted hydrocarbyl, substituted hydrocarbyl, or a functional group comprising at least one element from Group 13-16 of the periodic table of the elements; D of formula (II) is, independently, a monodentate donor ligand or a bidentate donor ligand; D and X of formula (II) are different; and n of formula (II) is a number greater than 0. The method further includes contacting the mono-Cp metallocene compound represented by formula (II) with a complex of a Cp^{B} ligand to form an unbridged asymmetric metallocene compound represented by formula (VII):

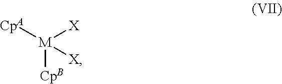

wherein: M of formula (VII) is the Group 4 metal; Cp^{A} is the unsubstituted cyclopentadienyl group, the substituted cyclopentadienyl group, the unsubstituted indenyl group, the substituted indenyl group, the unsubstituted fluorenyl group, or the substituted fluorenyl group; Cp^{B} of formula (VII) is an unsubstituted cyclopentadienyl group, a substituted cyclopentadienyl group, an unsubstituted indenyl group, a substituted indenyl group, an unsubstituted fluorenyl group, or a substituted fluorenyl group; Cp^{A} and Cp^{B} of formula (VII) are different; each X of formula (VII) is, independently halogen (such as F, Cl, Br, or I), H, unsubstituted hydrocarbyl, substituted hydrocarbyl, or a functional group comprising at least one element from Group 13-16 of the periodic table of the elements; and each X of formula (VII) is different from D of formula (II).

In another aspect, a method of synthesizing a mono-Cp metallocene compound is provided. The method includes (a) reacting a first mixture comprising a bis-Cp metallocene compound represented by formula (I), a metal salt, and a first solvent to form a reaction product mixture comprising a liquid component and an optional solid component, the liquid component comprising a metallocene compound represented by formula (III), the bis-Cp metallocene compound represented by formula (I) and the metallocene compound represented by formula (III) are:

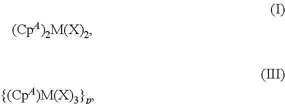

wherein: M of formula (I) and formula (III) is a Group 4 metal; Cp^{A} of formula (I) and formula (III) is an unsubstituted cyclopentadienyl group, a substituted cyclopentadienyl group, an unsubstituted indenyl group, a substituted indenyl group, an unsubstituted fluorenyl group, or a substituted fluorenyl group; each X of formula (I) and formula (III) is, independently, H (hydride), a halogen, unsubstituted hydrocarbyl, substituted hydrocarbyl, or a functional group comprising at least one element from Group 13-16 of the periodic table of the elements; and p of formula (III) is 1 or more. The method further includes (b) isolating the metallocene compound represented by formula (III) from the reaction product mixture. The method further includes (c) reacting a second mixture comprising the metallocene compound represented by formula (III) and a donor molecule to form a reaction product mixture comprising a mono-Cp metallocene compound represented by formula (II):

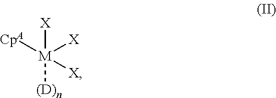

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, H (hydride), a halogen, unsubstituted hydrocarbyl, substituted hydrocarbyl, or a functional group comprising at least one element from Group 13-16 of the periodic table of the elements; D of formula (II) is, independently, a monodentate donor ligand or a bidentate donor ligand; D and X of formula (II) are different; and n of formula (II) is a number greater than 0. The method further includes (d) precipitating the mono-Cp metallocene compound represented by formula (II) from the reaction product mixture formed at (c) by adding a second solvent to the reaction product mixture formed at (c), the first solvent and the second solvent being the same or different.

In another aspect, a method of synthesizing an unbridged asymmetric metallocene compound is provided. The method includes (a) reacting a first mixture comprising a bis-Cp metallocene compound represented by formula (I), a metal salt, and a first solvent to form a reaction product mixture comprising a liquid component and an optional solid component, the liquid component comprising a metallocene compound represented by formula (III), the bis-Cp metallocene compound represented by formula (I) and the metallocene compound represented by formula (III) are:

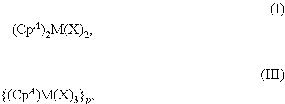

wherein: M of formula (I) and formula (III) is a Group 4 metal; Cp^{A} of formula (I) and formula (III) is an unsubstituted cyclopentadienyl group, a substituted cyclopentadienyl group, an unsubstituted indenyl group, a substituted indenyl group, an unsubstituted fluorenyl group, or a substituted fluorenyl group; each X of formula (I) and formula (III) is, independently, H (hydride), a halogen, unsubstituted hydrocarbyl, substituted hydrocarbyl, or a functional group comprising at least one element from Group 13-16 of the periodic table of the elements; and p of formula (III) is 1 or more. The method further includes (b) isolating the metallocene compound represented by formula (III) from the reaction product mixture. The method further includes (c) reacting a second mixture comprising the metallocene compound represented by formula (III) and a donor molecule to form a reaction product mixture comprising a mono-Cp metallocene compound represented by formula (II):

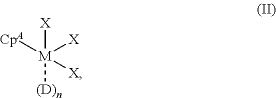

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, H (hydride), a halogen, unsubstituted hydrocarbyl, substituted hydrocarbyl, or a functional group comprising at least one element from Group 13-16 of the periodic table of the elements; D of formula (II) is, independently, a monodentate donor ligand or a bidentate donor ligand; D and X of formula (II) are different; and n of formula (II) is a number greater than 0. The method further includes (d) precipitating the mono-Cp metallocene compound represented by formula (II) from the reaction product mixture formed at (c) by adding a second solvent to the reaction product mixture formed at (c), the first solvent and the second solvent being the same or different. The method further includes (e) contacting the mono-Cp metallocene compound represented by formula (II) with a complex of a Cp^{B} ligand to form an unbridged asymmetric metallocene compound represented by formula (VII):

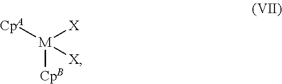

wherein: M of formula (VII) is the Group 4 metal; each of Cp^{A} and Cp^{B} of formula (VII) are, independently, an unsubstituted cyclopentadienyl group, a substituted cyclopentadienyl group, an unsubstituted indenyl group, a substituted indenyl group, an unsubstituted fluorenyl group, or a substituted fluorenyl group; Cp^{A} and Cp^{B} of formula (VII) are different; each X of formula (VII) is, independently, H (hydride), a halogen, unsubstituted hydrocarbyl, substituted hydrocarbyl, or a functional group comprising at least one element from Group 13-16 of the periodic table of the elements; and each X of formula (VII) is different from D of formula (II).

### BRIEF DESCRIPTION OF THE DRAWINGS

So that the manner in which the above recited features of the present disclosure may be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, may admit to other equally effective aspects.

FIG. 1A is a flow diagram showing selected operations of a method of synthesizing a mono-Cp metallocene compound according to at least one aspect of the present disclosure.

FIG. 1B is a flow diagram showing selected operations of a method of synthesizing a mono-Cp metallocene compound according to at least one aspect of the present disclosure.

To facilitate understanding, identical reference numerals have been used, where possible, to designate identical elements that are common to the figures. It is contemplated that elements and features of one aspect may be beneficially incorporated in other aspects without further recitation.

### DETAILED DESCRIPTION

Aspects of the present disclosure generally relate to new methods of synthesizing monocyclopentadienyl, monoindenyl, and monofluorenyl metallocene compounds (collectively, mono-Cp metallocene compounds). The method may include reacting a biscyclopentadienyl, bisindenyl, or bisfluorenyl metallocene compound (collectively, bis-Cp metallocene compounds) with a metal salt to form a reaction product mixture (or reaction solution). A donor molecule may then be added to the reaction product mixture to form the mono-Cp metallocene compound as a donor adduct.

Scheme A shows a general, and non-limiting, reaction diagram for synthesizing mono-Cp metallocene compounds according to aspects described herein. As shown in Scheme A, a bis-Cp metallocene compound represented by formula (I) and a metal salt (MX₄) may be reacted to form a metallocene compound represented by formula (III). A donor molecule (“donor” in Scheme A) may then be added to the metallocene compound represented by formula (III) to form a mono-Cp metallocene compound represented by formula (II). The mono-Cp metallocene compound represented by formula (II) may be interchangeably referred to herein as a donor adduct or as ((Cp^{A})M(X)₃(D)ₙ). Cp^{A}, M, X, p, D, and n of formulas (I), (II), and (III) are further described herein. “Bis-Cp metallocene compound represented by formula (I)” is interchangeably referred to herein as “metallocene compound represented by formula (I)”. “Mono-Cp metallocene compound represented by formula (II)” is interchangeably referred to herein as “metallocene compound represented by formula (II)”.

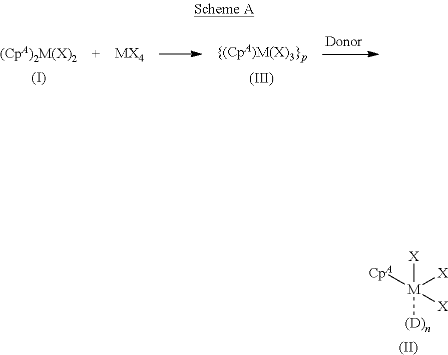

The inventor found that the donor molecule significantly improves the isolation, the yield, and the purity of the desired mono-Cp metallocene compound represented by formula (II). Here, addition of the donor molecule may significantly improve isolation of the desired mono-Cp metallocene compound from an otherwise oily or glassy crude material. As further described herein, the donor molecule may be added directly to a reaction product mixture comprising the metallocene represented by formula (III). Additionally, or alternatively, the donor molecule may be added to a liquid component (e.g., filtrate) separated from the reaction product mixture comprising the metallocene represented by formula (III). When the donor molecule is incorporated into the mono-Cp metallocene compound as a donor ligand, the mono-Cp metallocene compound represented by formula (II) is characterized as having a longer shelf-life than conventional mono-Cp metallocene compounds without a donor ligand. Use of the donor molecule enables uncomplicated monitoring of the synthesis process using analytical techniques such as proton nuclear magnetic resonance (¹H NMR) spectroscopy.

Further, the inventor found that use of the donor molecule may mitigate, or may be configured to mitigate, the formation of oligomers and byproducts from the metallocene compound represented by formula (III) in addition to converting any of metallocene compound represented by formula (III) that is formed into the mono-Cp metallocene compound represented by formula (II), providing an advantage over conventional technologies. Here, the metal centers in (Cp^{A})M(X)₃ are coordinatively unsaturated. These types of compounds are prone to form oligomers ({(Cp^{A})M(X)₃}ₚ, p=2, 3, 4, etc.) and/or undergo undesired reactions (for example, decomposition) to form byproducts. Unlike aspects of the present disclosure which enable high yield and purity mono-Cp metallocene compounds, conventional methods of synthesizing mono-Cp metallocene compounds form large amounts of undesired oligomers and byproducts, and add complicated work-up procedures or purification protocols to remove the oligomers and byproducts.

In further contrast to conventional methods, aspects described herein do not require sublimation and complicated re-solvation and purification procedures. Instead, aspects of the present disclosure may be characterized as solution-based methods that are efficient and uncomplicated to implement.

As shown in Scheme B, the mono-Cp metallocene compound, or donor adduct, represented by formula (II) may be utilized in the synthesis of bis-Cp metallocenes such as unbridged asymmetric metallocene compounds represented by formula (VII). Unbridged asymmetric metallocene compounds represented by formula (VII) may include bis-Cp metallocene compounds with two different cyclopentadienyl moieties, bis-Cp metallocene compounds with two different indenyl moieties, bis-Cp metallocene compounds with two different fluorenyl moieties, and bis-Cp metallocene compounds with two types of coordination moieties, such as cyclopentadienyl/indenyl, cyclopentadienyl/fluorenyl, and indenyl/fluorenyl. These unbridged asymmetric metallocene compounds represented by formula (VII) may be utilized as catalysts in, for example, olefin polymerization process.

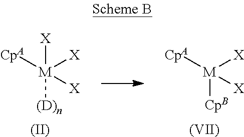

The use of headings is for purposes of convenience only and does not limit the scope of the present disclosure. Aspects described herein may be combined with other aspects.

Aspects of the present disclosure generally relate to new methods of synthesizing mono-Cp metallocene compounds.

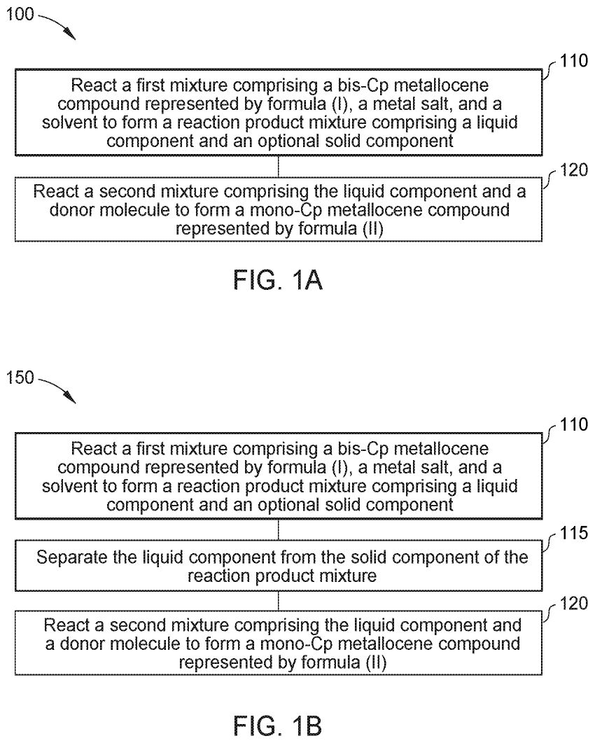

FIG. 1A is a flow diagram showing selected operations of a method 100 of synthesizing a mono-Cp metallocene compound according to at least one aspect of the present disclosure. Aspects and implementations of method 100 may be combined with other aspects and implementations described herein, such as aspects and implementations described with respect to method 150 of FIG. 1B. In general, method 100 enables conversion of bis-Cp metallocene compounds to mono-Cp metallocene compounds. Method 100 is a solution-based method.

The method 100 may begin with reacting a first mixture comprising a bis-Cp metallocene compound, a metal salt, and a solvent to form a reaction product mixture at operation 110. The reaction product mixture may include a liquid component and an optional solid component. The liquid component of the reaction product mixture comprises solvent and the metallocene compound represented by formula (III). The solid component of the reaction product mixture may include, for example, the metal salt used to form the first mixture. The reaction product mixture may include a solid component normally comprising the unreacted metal salt, for example, a molar ratio of the metal salt in the first mixture to the bis-Cp metallocene compound represented by formula (I) in the first mixture is greater than 1:1 (metal salt:bis-Cp metallocene compound represented by formula (I)). The metal salt is generally insoluble in the reaction solvent. When there is unreacted metal salt in the reaction product mixture, there might be a solid component. When the molar ratio of metal salt/metallocene is greater than 1 in the first reaction mixture, there will be unreacted metal salt. When the molar ratio of metal salt/metallocene is less than 1 in the first reaction mixture, unreacted metal salt could also exist in case undesired reactions involving the metallocene compound occur.

Scheme C shows a general reaction diagram for operation 110 according to at least one aspect of the present disclosure.

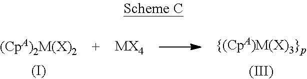

In formula (I), each Cp^{A} is bonded to M and each X is bonded to M.

M of formula (I) is a Group 4 metal of the periodic table of the elements, such as Ti, Zr, or Hf, such as Zr or Hf, such as Zr. Each X of formula (I) is, independently, a monoanionic ligand as further described herein. Each Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group.

When Cp^{A} of formula (I) is unsubstituted, it contains no additional substituents other than hydrogen. When Cp^{A} of formula (I) is substituted, it may be further substituted with one substituent, two substituents, three substituents, four substituents, and so forth. If a substituent other than hydrogen is present on Cp^{A} of formula (I), each substituent on Cp^{A} of formula (I) may be, independently, a C1-C36 unsubstituted hydrocarbyl group, a C1-C36 substituted hydrocarbyl group (for example, a C1-C36 halogenated hydrocarbyl group, a C1-C36 hydrocarboxy group, or a C1-C36 hydrocarbylsilyl group), a halogen (such as F, Cl, Br, or I), or a functional group comprising at least one element from Group 13-16 of the periodic table of the elements (for example, a phosphide, etc.).

If a C1-C36 unsubstituted hydrocarbyl group is a substituent on Cp^{A} of formula (I), the C1-C36 unsubstituted hydrocarbyl group may be a C1-C18 unsubstituted hydrocarbyl group, such as a C1-C12 unsubstituted hydrocarbyl group, such as a C1-C10 unsubstituted hydrocarbyl group, such as a C1-C8 unsubstituted hydrocarbyl group. If a C1-C36 substituted hydrocarbyl group is a substituent on Cp^{A} of formula (I), the C1-C36 substituted hydrocarbyl group may be a C1-C18 substituted hydrocarbyl group, such as a C1-C12 substituted hydrocarbyl group, such as a C1-C10 substituted hydrocarbyl group, such as a C1-C8 substituted hydrocarbyl group.

When Cp^{A} of formula (I) is substituted with a substituent other than hydrogen, suitable substituents on Cp^{A} of formula (I) may include a C1-C10 alkyl, C1-C10 alkenyl, or C1-C10 aryl group, Cl, CF₃, a methyl group, an ethyl group, a propyl group, an isopropyl group, a butyl group, an isobutyl group, a pentyl group, a hexyl group, a heptyl group, an octyl group, a nonyl group, a decyl group, an ethenyl group, a propenyl group, a butenyl group, a pentenyl group, a hexenyl group, a heptenyl group, an octenyl group, a nonenyl group, a decenyl group, a phenyl group, a tolyl group, a benzyl group, a naphthyl group, a trimethylsilyl group, a triisopropylsilyl group, a triphenylsilyl group, or an allyldimethylsilyl group.

Cp^{A} of formula (I) may be represented by formula (IV), formula (V), or formula (VI):

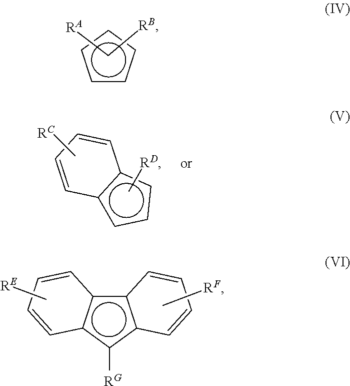

In formula (IV), R^{A} and R^{B} are substituents on the 1, 2, 3, 4, and 5 positions of the cyclopentadienyl group wherein R^{A} and R^{B} are on different carbon atoms. In formula (V), R^{D} is a substituent on the 1, 2, and 3 positions of the indenyl group and R^{C} is a substituent on the 4, 5, 6, and 7 positions of the indenyl group. In formula (VI), R^{E} is a substituent on the 1, 2, 3, and 4 positions of the fluorenyl group, R^{F} is a substituent on the 5, 6, 7, and 8 positions of the fluorenyl group, and R^{G} is a substituent on the 9 position of the fluorenyl group.

Each of R^{A}, R^{B}, R^{C}, R^{D}, R^{E}, R^{F}, and R^{G} of formulas (IV)-(VI) may be, independently, hydrogen, a C1-C18 unsubstituted hydrocarbyl, a C1-C18 substituted hydrocarbyl, halogen (such as F, Cl, Br, or I), or a functional group comprising at least one element from Group 13-16 of the periodic table of the elements, such as hydrogen or C1-C18 unsubstituted hydrocarbyl (for example, a C1-C12 unsubstituted hydrocarbyl, such as a C1-C8 unsubstituted hydrocarbyl, such as a C1-C6 unsubstituted hydrocarbyl, such as n-butyl or t-butyl). Each of R^{A}, R^{B}, R^{C}, R^{D}, R^{E}, R^{F}, and R^{G} of formulas (IV)-(VI) may be substituted with a substituent other than hydrogen. Each of R^{A}, R^{B}, R^{C}, R^{D}, R^{E}, R^{F}, and R^{G} of formulas (IV)-(VI) may be, independently, a C1-C10 alkyl, C1-C10 alkenyl, or C1-C10 aryl group, Cl, CF₃, a methyl group, an ethyl group, a propyl group, an isopropyl group, a butyl group, an isobutyl group, a pentyl group, a hexyl group, a heptyl group, an octyl group, a nonyl group, a decyl group, an ethenyl group, a propenyl group, a butenyl group, a pentenyl group, a hexenyl group, a heptenyl group, an octenyl group, a nonenyl group, a decenyl group, a phenyl group, a tolyl group, a benzyl group, a naphthyl group, a trimethylsilyl group, a triisopropylsilyl group, a triphenylsilyl group, or an allyldimethylsilyl group. Each of R^{A}, R^{B}, R^{C}, R^{D}, R^{E}, R^{F}, and R^{G} of formulas (IV)-(VI) may be, independently, hydrogen or a C1-C10 unsubstituted hydrocarbyl, such as a C1-C10 alkyl, a C1-C10 alkenyl, or a C6-C10 aryl, such as methyl, ethyl, propyl, isopropyl, butyl, pentyl, hexyl, heptyl, octyl, nonyl, decyl, 2-propen-1-yl, 3-buten-1-yl, 4-penten-1-yl, 5-hexen-1-yl, 6-hepten-1-yl, 7-octen-1-yl, 8-nonen-1-yl, 9-decen-lyl, phenyl, benzyl, naphthyl, or an isomer thereof. Each of R^{A}, R^{B}, R^{C}, R^{D}, R^{E}, R^{F}, and R^{G} of formulas (IV)-(VI) may be, independently, hydrogen, methyl, ethyl, propyl, isopropyl, n-butyl, i-butyl, t-butyl, n-pentyl, i-pentyl, neo-pentyl, n-hexyl, CH₂═CHCH₂—, CH₂═CH(CH₂)₂—, phenyl, or Ph(CH₂)—, or an isomer thereof.

Each substituent on Cp^{A} of formula (I) may be the same or different substituent group. Each substituent on Cp^{A} of formula (I) may be at any suitable position on the respective cyclopentadienyl, indenyl, or fluorenyl ring structure that conforms with the rules of chemical valence.

In some aspects, which may be combined with other aspects, Cp^{A} of formula (I) may be an unsubstituted cyclopentadienyl group, an unsubstituted indenyl group, an unsubstituted fluorenyl group, a monosubstituted cyclopentadienyl group, a monosubstituted indenyl group, a monosubstituted fluorenyl group, a disubstituted cyclopentadienyl group, a disubstituted indenyl group, or a disubstituted fluorenyl group.

Referring back to formula (I), each X of formula (I) may be, independently, a monoanionic ligand, such as halogen (such as F, Cl, Br, or I), H (hydride), unsubstituted hydrocarbyl, substituted hydrocarbyl, or a functional group comprising at least one element from Group 13-16 of the periodic table of the elements.

Suitable monoanionic ligands (X) of formula (I) may include, but are not limited to, H (hydride), halide (for example, F, Cl, Br, or I), BH₄, a C1-C36 unsubstituted hydrocarbyl group, a C1-C36 halogenated hydrocarbyl group, a C1-C36 hydrocarboxy group, a C1-C36 hydrocarbylaminyl group, a C1-C36 hydrocarbylsilyl group, a C1-C36 hydrocarbylaminylsilyl group, amine (—NR*₂), amide, alkoxide (—OR*), or —OSO₂R*, wherein R* may be hydrogen or a C1-C36 unsubstituted hydrocarbyl group such as a C1-C36 unsubstituted hydrocarbyl group described herein. Each X of formula (I) may be the same or different monoanionic ligand.

Hydrocarbyl groups of X of formula (I) may include alkyl, alkenyl, aryl, and aralkyl groups, amongst other groups. The hydrocarbyl group, halogenated hydrocarbyl group, hydrocarboxy group, hydrocarbylaminyl group, hydrocarbylsilyl group, and hydrocarbylaminylsilyl group of X of formula (I) may be a C1-C18, C1-C12, C1-C10, or C1-C8 hydrocarbyl group, a C1-C18, C1-C12, C1-C10, or C1-C8 halogenated hydrocarbyl group, a C1-C18, C1-C12, C1-C10, or C1-C8 hydrocarboxy group, a C1-C18, C1-C12, C1-C10, or C1-C8 hydrocarbylaminyl group, a C1-C18, C1-C12, C1-C10, or C1-C8 hydrocarbylsilyl group, or a C1-C18, C1-C12, C1-C10, or C1-C8 hydrocarbylaminylsilyl group, respectively.

Each X of formula (I) may be, independently, H, halide (such as F, Cl, Br, or I), BH₄, alkyl (e.g., methyl, ethyl, propyl, etc.), alkenyl, aryl (e.g., phenyl, benzyl, etc.), amine (—NH₂ or —NR*₂ wherein R* may be hydrogen or a C1-C36 unsubstituted hydrocarbyl group such as a C1-C36 unsubstituted hydrocarbyl group described herein), an alkoxy (e.g., methoxy, ethoxy, propoxy, etc.), an aryloxy (—OPh, —OBn, etc.), alkylaminyl, a dialkylaminyl, phosphide, a trihydrocarbylsilyl, a hydrocarbylaminylsilyl.

Referring back to operation 110, the metal salt may have the formula MX₄, wherein M of the metal salt is a Group 4 metal and each X of the metal salt may be, independently, any suitable monoanionic ligand described herein. Any suitable metal salt of the formula MX₄ may be utilized and may include, but not limited to, a halide salt of a Group 4 metal, an amine salt of a Group 4 metal, an alkoxide salt of a Group 4 metal, or combinations thereof, among other metal salts. Halide salts of Group 4 metals may include ZrCl₄, HfCl₄, ZrBr₄, or HfBr₄. Amine salts and alkoxide salts of Group 4 metals may include Zr(NR*₂)₄, Zr(OR*)₄, Hf(NR*₂)₄, and Hf(OR*)₄, wherein, for example, R* of the amine or alkoxide salt is H or hydrocarbyl, such as alkyl. Combinations of metal salts may be utilized.

Solvents useful for operation 110 may include, but are not limited to, non-coordinating solvents such as aromatic solvents and hydrocarbon solvents. Additionally, or alternatively, solvents useful for operation 110 may include those having a boiling point in a range from about 80° C. to about 180° C., such as from about 80° C. to about 150° C. Illustrative, but non-limiting, examples of solvents suitable for operation 110 may include heptane, octane, nonane, decane, benzene, toluene, ethylbenzene, o-xylene, m-xylene, or p-xylene. Combinations of solvents may be utilized.

Any suitable amounts of the metal salt and the bis-Cp metallocene compound represented by formula (I) may be present in the first mixture that is reacted at operation 110. For example, a molar ratio of the metal salt to the bis-Cp metallocene compound represented by formula (I) in the first mixture may be in a range from about 0.7:1 to about 1.5:1, such as from about 0.8:1 to about 1.4:1, such as from about 0.9:1 to about 1.3:1, such as from about 1.1:1 to about 1:1 (metal salt:bis-Cp metallocene compound represented by formula (I)).

Any suitable reactor or vessel, such as a continuous stirred tank reactor, may be utilized for reacting the first mixture comprising the bis-Cp metallocene compound represented by formula (I), the metal salt, and the solvent at operation 110.

The reacting the first mixture comprising the bis-Cp metallocene compound represented by formula (I), the metal salt, and the solvent to form the reaction product mixture at operation 110 may be performed under first reaction conditions. First reaction conditions are effective to react the bis-Cp metallocene compound represented by formula (I) with the metal salt. First reaction conditions may be performed while the bis-Cp metallocene compound represented by formula (I) contacts the metal salt. Through contact of the metal salt in the first mixture with the bis-Cp metallocene compound represented by formula (I) in the first mixture at operation 110, the metallocene compound represented by formula (III) is formed.

First reaction conditions of operation 110 may include operating the reactor at any suitable mixing speed such as in a range from about 100 revolutions per minute (rpm) to about 1,000 rpm, such as from about 500 rpm to about 1,000 rpm.

First reaction conditions of operation 110 may include any suitable reaction temperature. The reaction temperature utilized at operation 110 may be in a range from about 60° C. to about 140° C., such as from about 70° C. to about 130° C., such as from about 80° C. to about 120° C., such as from about 90° C. to about 110° C., such as from about 95° C. to about 105° C., such as from about 100° C. to 105° C., or from about 100° C. to about 110° C. The reaction temperature utilized at operation 110 in the reactor may be monitored by a thermocouple.

Heating or cooling the reactor to achieve or maintain the desired reaction temperature at operation 110 may be accomplished by any suitable temperature-controlling apparatus coupled to the reactor. For example, the temperature-controlling apparatus may include a fluidized temperature bath or a tube furnace, among other temperature-controlling apparatus, to heat, cool, or maintain the temperature of chemicals present inside the reactor. Alternatively, the reactor may be a jacketed reactor (also known as a double-walled reactor) in which an outer shell of the reactor is designed to control the temperature of the chemicals inside the reactor by circulating a heating fluid or cooling fluid. A tempered water system may be utilized to maintain or heat chemicals inside the reactor in a cost-effective manner.

First reaction conditions of operation 110 may include any suitable reaction period. For example, the reaction period of operation 110 may be in a range from about 5 minutes to about 48 hours, such as from about 1 hour to about 48 hours, such as from about 3 hours to about 36 hours, such as from about 5 hours to about 20 hours.

As described herein, operation 110 forms a reaction product mixture comprising a liquid component and an optional solid component. That is, the reaction product mixture formed at operation 110 may be free of (or substantially free of) a solid component. The reaction product mixture may be free of (or substantially free of) a solid component, for example, when a molar ratio of the metal salt to the bis-Cp metallocene compound represented by formula (I) in the first mixture is less than 1:1 (metal salt:bis-Cp metallocene compound represented by formula (I)).

The liquid component of the reaction product mixture formed at operation 110 includes a metallocene compound represented by formula (III):

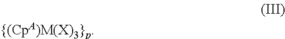

In formula (III), Cp^{A} is bonded to M and each X is bonded to M. M of formula (III) is the Group 4 metal described herein with respect to formula (I), such as Ti, Zr, or Hf, such as Zr or Hf, such as Zr. Each X of formula (III) may be, independently, a monoanionic ligand, such as any suitable monoanionic ligand described herein, for example, those monoanionic ligands (X) described herein with respect to formula (I).

Cp^{A} of formula (III) is the unsubstituted cyclopentadienyl group, the substituted cyclopentadienyl group, the unsubstituted indenyl group, the substituted indenyl group, the unsubstituted fluorenyl group, or the substituted fluorenyl group described with respect to formula (I). Suitable Cp^{A} groups of formula (III) include those described herein for formula (I).

In formula (III), p may be 1 or more, such as 1, 2, 3, 4, 5, etc., such as 1, 2, 3, or 4. The metallocene compound represented by formula (III) may be in the form of a monomer:

{(Cp^{A})M(X)₃}ₚ, wherein p is 1.

Oligomers represented by formula (III) may optionally be present in the liquid component of the reaction product mixture formed at operation 110. Oligomers of formula (III) may be represented by:

{(Cp^{A})M(X)₃}ₚ, wherein p is 2 or more.

The liquid component of the reaction product mixture further includes the solvent used in the first mixture. The metallocene compound represented by formula (III) is soluble in the solvent present in the liquid component. The metallocene compound represented by formula (III) may be soluble in the solvent at any suitable temperature. Typically, increasing the temperature of the liquid component may increase the solubility of the metallocene compound represented by formula (III) in the solvent. As the liquid component of the reaction product mixture includes the metallocene compound represented by formula (III) solubilized in the solvent, the liquid component of the reaction product mixture may be directly used for further processing (for example, directly used for operation 120 of FIG. 1A).

Referring back to FIG. 1A, the method 100 may further include reacting a second mixture comprising the liquid component of the reaction product mixture and a donor molecule to form a mono-Cp metallocene compound represented by formula (II) at operation 120. For example, when the reaction product mixture formed at operation 110 is free (or substantially free) of solid component, the donor molecule may be added directly to the reaction product mixture formed at operation 110. Additionally, or alternatively, when the reaction product mixture formed at operation 110 includes (or is not free of or is not substantially free of) solid component, the reaction product mixture may be subjected to a solid-liquid separation. Solid-liquid separations are described herein with respect to method 150 of FIG. 1B.

Scheme D shows a general reaction diagram for operation 120 according to at least one aspect of the present disclosure. As shown in Scheme D, a metallocene compound represented by formula (III) is converted to the mono-Cp metallocene compound represented by formula (II) as a donor adduct.

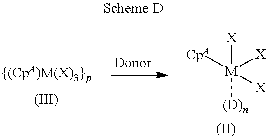

The donor molecule used for operation 120 is a Lewis base. By reacting (or coordinating) with the metallocene compound represented by formula (III), the donor molecule becomes a donor ligand (D) in the mono-Cp metallocene compound represented by formula (II). That is, the donor molecule may coordinate to the metal (M) of suitable metallocenes described herein (e.g., the mono-Cp metallocene compound represented by formula (II)) to form the donor ligand (D). A donor ligand is a molecule that donates electrons to a metal center to form, for example, a coordinate covalent bond, acting as a Lewis base. The donor ligand may be monodentate or bidentate. For example, D may include one or more different monodentate donor ligands. As another example, two heteroatoms on the donor ligand may be linked to form a bidentate donor ligand.

Suitable donor molecules for operation 120 may include at least one heteroatom or heteroatom-containing group. Heteroatoms are atoms from Group 13-16 of the periodic table of the elements, excluding carbon. A heteroatom-containing group may contain carbon, but in such instances, the heteroatom-containing group also contains a non-carbon atom from Group 13-16 of the periodic table of the elements.

Any suitable donor molecule may be utilized at operation 120, such as a donor molecule represented by one or more of formulas (D-1)-(D-20):

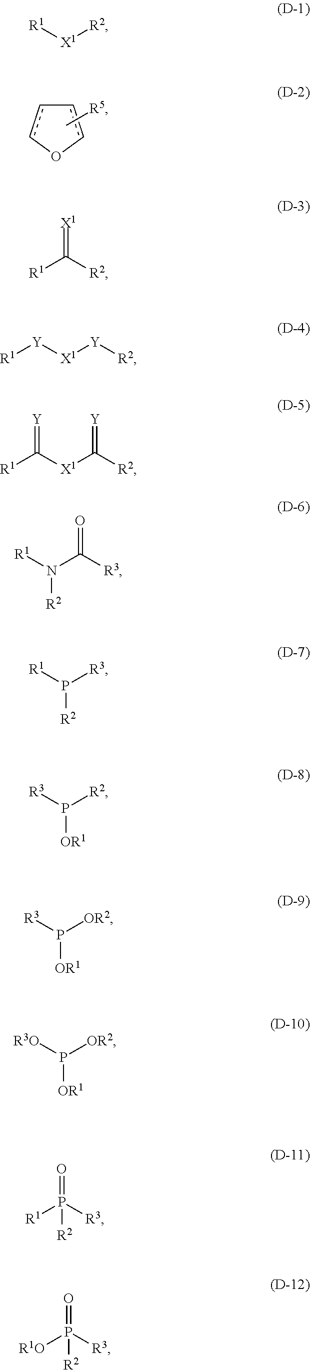

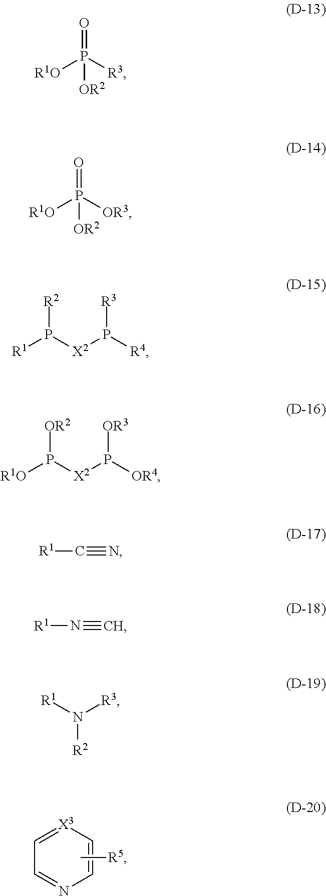

or combinations thereof.

With respect to the furan represented by formula (D-2), the dashed line indicates optional C═C double bonds. The furan represented by formula (D-2) may be fully unsaturated, partially unsaturated, or fully saturated.

When present in the donor molecule, each of R¹, R², R³, R⁴, and R⁵ of formulas (D-1)-(D-20) may be, independently, hydrogen, a C1-C18 unsubstituted hydrocarbyl, such as a C1-C12 unsubstituted hydrocarbyl, such as a C1-C10 unsubstituted hydrocarbyl, such as a C1-C10 alkyl, alkenyl, or aryl, such as methyl, ethyl, propyl, butyl, pentyl, hexyl, heptyl, octyl, nonyl, decyl, 2-propen-1-yl, 3-buten-1-yl, 4-penten-1-yl, 5-hexen-1-yl, 6-hepten-1-yl, 7-octen-1-yl, 8-nonen-1-yl, 9-decen-lyl, phenyl, benzyl, naphthyl, or an isomer thereof, or two or more of R¹, R², R³, R⁴, or R⁵ may join together to form a monocyclic or polycyclic ring structure. Cyclic donors may be more effective at coordinating with a metal center than acyclic donors.

When present in the donor molecule of formulas (D-1)-(D-20): each X¹ of formulas (D-1)-(D-20) may be, independently, O, S, (CH₂)ₙ, or Si; each X² may be, independently, (CH₂)ₙ or phenylene; each X³ may be, independently, C or N; each Y may be, independently, O or S; and each n may be, independently, from 1 to 4.

The donor molecule may include an alkylether, an arylether, a cyclic ether, a ketone, a glyme, or combinations thereof.

Any suitable alkylether may be utilized as a donor molecule. For example, an alkylether useful as a donor molecule may include dimethyl ether, diethyl ether, methyl ethyl ether, methyl propyl ether, ethyl propyl ether, di-n-propyl ether, methyl butyl ether, ethyl butyl ether, di-n-butyl ether, methyl isopropyl ether, isomers thereof, or combinations thereof.

Any suitable arylether may be utilized as a donor molecule. For example, an arylether useful as a donor molecule may include anisole (methoxybenzene), phenyl ethyl ether, phenyl propyl ether, diphenyl ether, phenyl isopropyl ether, phenyl butyl ether, phenyl tert-butyl ether, phenyl pentyl ether, phenyl hexyl ether, phenyl heptyl ether, isomers thereof, or combinations thereof.

Any suitable cyclic ether may be utilized as a donor molecule. For example, a cyclic ether useful as a donor molecule may include tetrahydrofuran, dioxane, tetrahydropyran, 1,3-dioxane, 1,4-dioxane, furan, 2,5-dihydrofuran, pyran, 2H-pyran, 3,4-dihydro-2H-pyran, isomers thereof, or combinations thereof.

Any suitable ketone may be utilized as a donor molecule. For example, a ketone useful as a donor molecule may include acetone, methyl ethyl ketone, diethyl ketone, methyl isobutyl ketone, methyl n-propyl ketone, diisobutyl ketone, cyclohexanone, 2-pentanone, 3-pentanone, 2-hexanone, 3-hexanone, 4-methyl-2-pentanone, 2-heptanone, 3-heptanone, 4-heptanone, isomers thereof, or combinations thereof.

Any suitable glyme may be utilized as a donor molecule. For example, a glyme useful as a donor molecule may include 1,3-dimethoxypropane, 1-(2-methoxyethoxy) butane, 1,3-diethoxypropane, 1,2-dimethoxyethane, dimethoxymethane, 1-ethoxy-2-methoxyethane, 4,7-dioxadecane, 1-butoxy-2-ethoxyethane, ethylene glycol diethyl ether, glycol dibutyl ether, 1,1-dimethoxyethane, diethoxymethane, 2,2-dimethoxypropane, 1,2,3-trimethoxypropane, diglyme, trimethyl orthoformate, 2-(2-methoxyethoxy)-2-methylpropane, isomers thereof, or combinations thereof.

Other suitable donor molecules may include Me₂S, Et₂S, R₃P (wherein R″ may be, for example, Me, Et, nPr, iPr, nBu, iBu), R₃N (wherein R″ may be, for example, Me, Et, nPr, iPr, nBu, iBu).

In some aspects, which may be combined with other aspects, the donor molecule may include dimethyl ether (Me₂O), diethyl ether (Et₂O), acetone, diethyl ketone, tetrahydrofuran, 1,2-dimethoxyethane, 1,3-dimethoxypropane, or combinations thereof.

Combinations of different donor molecules may be utilized in any suitable proportion.

As described herein, the donor molecule forms a donor-adduct with the metallocene represented by formula (III), thereby providing the mono-Cp metallocene compound represented by formula (II) that includes the donor molecule coordinating with the metal center as the donor ligand. Accordingly, the donor molecule and the donor ligand have the same chemical formula.

When incorporated into the mono-Cp metallocene compound of formula (II) as a donor adduct, the donor molecule (or donor ligand) may stabilize, or may be configured to stabilize, the mono-Cp metallocene compound represented by formula (II). Additionally, or alternatively, the donor molecule (or donor ligand) may mitigate, or may be configured to mitigate, formation of oligomers of formula (III): {(Cp^{A})(X)₃M}ₚ, wherein p is 2 or more, such as 2, 3, 4, 5, etc. Additionally, or alternatively, the donor molecule (or donor ligand) may mitigate, or may be configured to mitigate, decomposition of the mono-Cp metallocene compound represented by formula (II) to the metallocene compound represented by formula (III). Here, use of the donor molecule enables conversion of the metallocene compound represented by formula (III) to the mono-Cp metallocene compound represented by formula (II) as a donor adduct thereby mitigating decomposition. Without the donor molecule, the metallocene compound represented by formula (III) may decompose to form the metal salt and the bis-Cp metallocene represented by formula (I) or form higher order oligomers (p increases). Additionally, or alternatively, the donor molecule and/or the donor ligand facilitates, or is configured to facilitate, isolation, purification, or both, of the mono-Cp metallocene compound represented by formula (II).

Although the liquid component of the reaction product mixture used during operation 120 includes the solvent utilized at operation 110, additional amounts of the same solvent or an amount of a different solvent may be added to the second mixture. The same or different solvent may optionally include the donor molecule or the donor molecule may be added separately from the donor molecule. If utilized, the same or different solvent may include those solvents described herein with respect to operation 110.

Any suitable amount of the donor molecule may be used in the second mixture of operation 120. The amount of the donor molecule may be based on an amount of the bis-Cp metallocene compound represented by formula (I) in the first mixture. In some aspects, which may be combined with other aspects, a molar ratio of a monodentate donor molecule in the second mixture to the bis-Cp metallocene compound represented by formula (I) in the first mixture may be about 4:1 or more. In some aspects, which may be combined with other aspects, a molar ratio of the bidentate donor molecule in the second mixture to the bis-Cp metallocene compound represented by formula (I) in the first mixture may be about 2:1 or more. Higher amounts of donor relative to the bis-Cp metallocene compound represented by formula (I) helps facilitate and drive the reaction at operation 120 (e.g., a Lewis acid-base reaction) to form the mono-Cp metallocene compound represented by formula (II).

For monodentate donor molecules, a molar ratio of the monodentate donor molecule in the second mixture to the bis-Cp metallocene compound represented by formula (I) in the first mixture may be about 4:1 or more, such as in a range from about 4:1 to about 200:1, such as from about 4.5:1 to about 15:1, such as from about 5:1 to about 10:1, such as from about 5.5:1 to about 8:1, such as from about 5.7:1 to about 6.5:1 (monodentate donor molecule:bis-Cp metallocene compound represented by formula (I)). For bidentate donor molecules, a molar ratio of the bidentate donor molecule in the second mixture to the bis-Cp metallocene compound represented by formula (I) in the first mixture may be about 2:1 or more, such as in a range from about 2:1 to about 100:1, such as from about 2.3:1 to about 10:1, such as from about 2.5:1 to about 6.5:1, such as from about 2.8:1 to about 5:1 (bidentate donor molecule:bis-Cp metallocene compound represented by formula (I)).

Additionally, or alternatively, a molar ratio of the donor molecule (either monodentate or bidentate) to the bis-Cp metallocene compound represented by formula (I) may be from about 1:1 to about 10:1, such as from about 2:1 to about 8:1, such as from about 2.5:1 to about 7:1, such as from about 2.8:1 to about 6:1, or from about 1:1 to about 20:1, such as from about 2:1 to about 20:1, such as from about 2.3:1 to about 10:1, such as from about 2.5:1 to about 6.5:1 (donor molecule:bis-Cp metallocene compound represented by formula (I)).

Any suitable reactor or vessel, such as a continuous stirred tank reactor, may be utilized for reacting the second mixture comprising the liquid component of the reaction product mixture and the donor molecule at operation 120. The reactor used at operation 120 may be the same reactor or a different reactor than the reactor utilized at operation 110.

At operation 120, the reacting the second mixture comprising the liquid component of the reaction product mixture and the donor molecule forms a second reaction product mixture comprising the mono-Cp metallocene compound represented by formula (II). Operation 120 may be performed under second reaction conditions. Second reaction conditions are effective to convert one or more components present in the liquid component of the reaction product mixture (such as a metallocene compound represented by formula (III)) to the mono-Cp metallocene compound represented by formula (II). Second reaction conditions may be performed while one or more components present in the liquid component of the reaction product mixture contacts the donor molecule. Through contact of the donor molecule in the second mixture with, for example, a metallocene compound represented by formula (III) in the second mixture at operation 120, the mono-Cp metallocene compound represented by formula (II) is formed.

Second reaction conditions of operation 120 may include operating the reactor at any suitable mixing speed such as in a range from about 100 rpm to about 1,000 rpm, such as from about 500 rpm to about 1,000 rpm. Second reaction conditions of operation 120 may include any suitable reaction temperature. For example, the reaction temperature utilized at operation 120 may be in a range from about −20° C. to about 100° C., such as from about 0° C. to about 70° C., such as from about 10° C. to about 50° C., such as from about 15° C. to about 40° C., such as from about 20° C. to about 30° C. On large scales a lower temperature may be desired as the reaction at operation 120 is exothermic. Heating or cooling the reactor to achieve or maintain the desired reaction temperature at operation 120 may be accomplished as described herein with respect to operation 110. The reaction temperature utilized at operation 120 in the reactor may be monitored by a thermocouple.

Second reaction conditions at operation 120 may include a reaction period. Any suitable reaction period may be utilized at operation 120. For example, the reaction period at operation 120 may be in a range from about 1 minute to about 24 hours, such as from about 5 minutes to about 16 hours, such as from about 1 hour to about 10 hours, such as from about 2 hours to about 5 hours.

As described herein, operation 120 forms a second reaction product mixture comprising a mono-Cp metallocene compound represented by formula (II):

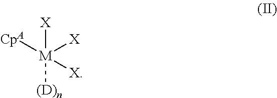

The mono-Cp metallocene compound represented by formula (II) is also referred to as a donor adduct. In formula (II), Cp^{A} is bonded to M, each X is bonded to M, and D is bonded to M. M of formula (II) is the Group 4 metal described herein with respect to formula (I). Each X of formula (II) may be, independently, a monoanionic ligand described herein, such as those monoanionic ligands described herein with respect to formula (I). Cp^{A} is the unsubstituted cyclopentadienyl group, the substituted cyclopentadienyl group, the unsubstituted indenyl group, the substituted indenyl group, the unsubstituted fluorenyl group, or the substituted fluorenyl group described herein with respect to formula (I).

D of formula (II) is a donor ligand. The donor ligand is the donor molecule complexed to M. Upon reaction at operation 120, the donor molecule coordinates with the metal center as the donor ligand. Each D of formula (II) may be a monodentate donor ligand, or two D are joined together to form a bidentate donor ligand. Additionally, or alternatively, two heteroatoms on the donor ligand may be linked to form a bidentate donor ligand. For example, a bidentate donor ligand such as 1,2-dimethoxyethane (DME) includes two heteroatoms (two oxygen atoms) that are joined to form a bidentate donor ligand. The donor ligand may include more than less than two heteroatoms (e.g., acetonitrile), or more than two heteroatoms. In formula (II), n is greater than 0, such as 1 or 2. When D is a bidentate donor ligand, n of formula (II) may be 1. When D is a monodentate donor ligand, n of formula (II) may be greater than 0 such as 1 or 2, including non-integers. Additionally, or alternatively, when D is a monodentate donor ligand, n of formula (II) may be a number less than 1 or a number between 1 and 2 (such as from about 0.5 to about 1.8) due to, for example, the lability of the monodentate donor ligand. The value of n may depend on the reaction conditions, drying conditions, or combinations thereof. For example, with respect to drying conditions, a higher temperature with vacuum may result in a smaller value for n.

D of formula (II) may be neutral, monoanionic or dianionic, such as neutral. X, D, and n of formula (II) may be chosen such that the mono-Cp metallocene compound represented by formula (II) may be, overall, neutral.

When D is a monodentate donor ligand, each D may be the same or different D, such as the same D. For example, the mono-Cp metallocene compound represented by formula (II) may include two different monodentate donor ligands (D): for example, dimethyl ether and diethyl ether. Alternatively, the mono-Cp metallocene compound represented by formula (II) may include two of the same monodentate donor ligands: for example, two diethyl ether donor ligands.

D and X of formula (II) are different. As described herein, each monoanionic ligand (X) of a respective mono-Cp metallocene compound represented by formula (II) is different from donor ligand (D) of that mono-Cp metallocene compound represented by formula (II).

Any suitable mono-Cp metallocene compound represented by formula (II) may be formed at operation 120. For example, Cp^{A} of formula (II) may be represented by any one of formula (IV), formula (V), or formula (VI) described herein. As another example, the mono-Cp metallocene compound represented by formula (II) may include a mono-Cp metallocene compound represented by one or more of formulas (II-A)-(II-C):

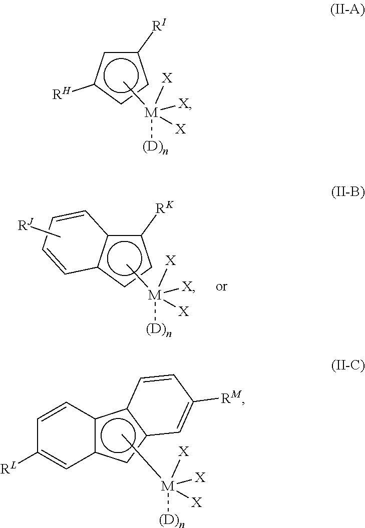

Each of R^{H}, R^{I}, R^{J}, R^{K}, R^{L}, and R^{M} of formulas (II-A)-(II-C) may be any suitable substituent, such as any substituent of Cp^{A} described herein, such as hydrogen, a C1-C36 unsubstituted hydrocarbyl, a C1-C36 substituted hydrocarbyl, a halogen (such as F, Cl, Br, or I), or a functional group comprising at least one element from Group 13-16 of the periodic table of the elements. Suitable substituents on Cp^{A} are described herein.

Suitable C1-C36 unsubstituted hydrocarbyl groups as substituents (R^{H}, R^{I}, R^{J}, R^{K}, R^{L}, and R^{M} of formulas (II-A)-(II-C)) on Cp^{A} may include a C1-C18 unsubstituted hydrocarbyl group, such as a C1-C12 unsubstituted hydrocarbyl group, such as a C1-C10 unsubstituted hydrocarbyl group, such as a C1-C8 unsubstituted hydrocarbyl group. Suitable C1-C36 substituted hydrocarbyl groups as substituents (R^{H}, R^{I}, R^{J}, R^{K}, R^{L}, and R^{M} of formulas (II-A)-(II-C)) on Cp^{A} may include a C1-C18 substituted hydrocarbyl group, such as a C1-C12 substituted hydrocarbyl group, such as a C1-C10 substituted hydrocarbyl group, such as a C1-C8 substituted hydrocarbyl group.

Each of R^{H}, R^{I}, R^{J}, R^{K}, R^{L}, and R^{M} of formulas (IV)-(VI) may be substituted with a substituent other than hydrogen. Each of R^{H}, R^{I}, R^{J}, R^{K}, R^{L}, and R^{M} of formulas (IV)-(VI) may be, independently, a C1-C10 alkyl, C1-C10 alkenyl, or C1-C10 aryl group, Cl, CF₃, a methyl group, an ethyl group, a propyl group, a butyl group, a pentyl group, a hexyl group, a heptyl group, an octyl group, a nonyl group, a decyl group, an ethenyl group (vinyl group), a propenyl group (allyl group), a butenyl group, a pentenyl group, a hexenyl group, a heptenyl group, an octenyl group, a nonenyl group, a decenyl group, a phenyl group, a tolyl group, a benzyl group, a naphthyl group, a trimethylsilyl group, a triisopropylsilyl group, a triphenylsilyl group, or an allyldimethylsilyl group.

Each of R^{H}, R^{I}, R^{J}, R^{K}, R^{L}, and R^{M} of formulas (II-A)-(II-C) may be, independently, hydrogen or a C1-C10 unsubstituted hydrocarbyl, such as a C1-C10 alkyl, a C1-C10 alkenyl, or a C6-C10 aryl, such as methyl, ethyl, propyl, isopropyl, butyl, isobutyl, sec-butyl, tertiary butyl, pentyl, hexyl, heptyl, octyl, nonyl, decyl, 2-propen-1-yl, 3-buten-1-yl, 4-penten-1-yl, 5-hexen-1-yl, 6-hepten-1-yl, 7-octen-1-yl, 8-nonen-1-yl, 9-decen-1yl, phenyl, benzyl, naphthyl, or an isomer thereof. Each of R^{H}, R^{I}, R^{J}, R^{K}, R^{L}, and R^{M} of formulas (II-A)-(II-C) may be, independently, hydrogen, methyl, ethyl, propyl, isopropyl, n-butyl, i-butyl, s-butyl, t-butyl, n-pentyl, i-pentyl, neo-pentyl, n-hexyl, CH₂═CHCH₂—, CH₂═CH(CH₂)₂″, phenyl, or Ph(CH₂)—, or an isomer thereof.

Each X of formulas (II-A)-(II-C) may be any suitable monoanionic ligand, such as those monoanionic ligands described herein with respect to formula (I), such as a halide, such as F, Cl, Br, or I, such as Cl.

Each D of formulas (II-A)-(II-C) may be any suitable donor ligand such as those described herein with respect to formula (II). D and X of formulas (II-A)-(II-C) are different.

In formulas (II-A)-(II-C), n may be any suitable number such as those described herein with respect to formula (II).

Illustrative, but non-limiting examples of mono-Cp metallocene compounds represented by formula (II) may include one or more of mono-Cp metallocene compounds (II-1)-(II-44) (wherein “Ph” refers to phenyl, and “t-Bu” refers to tert-butyl):

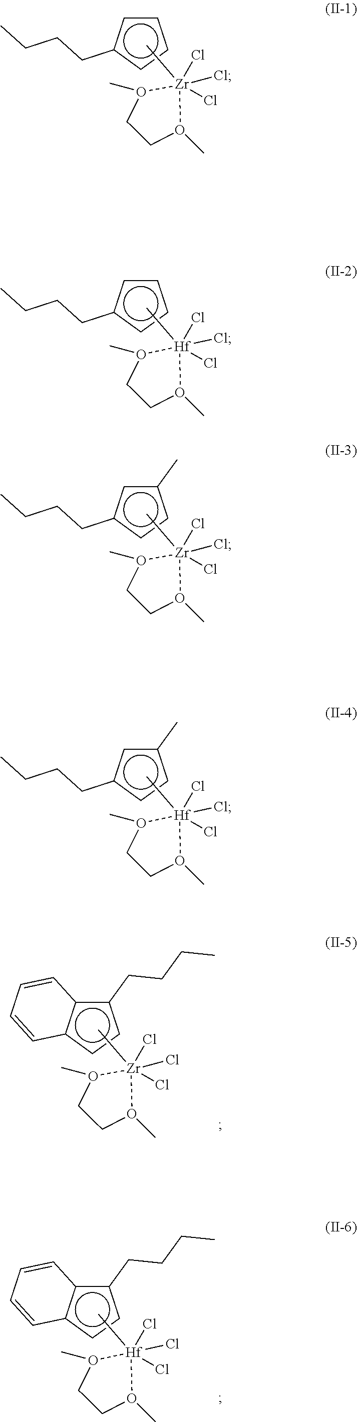

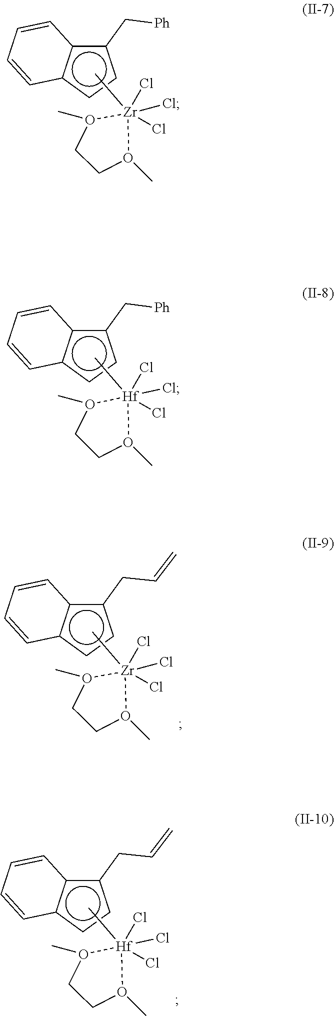

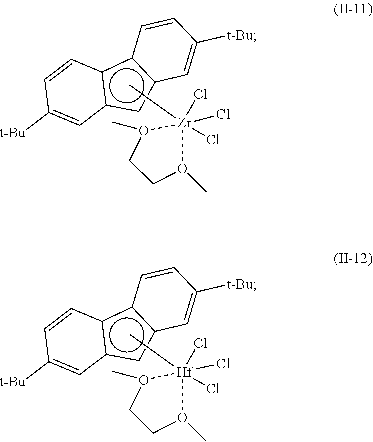

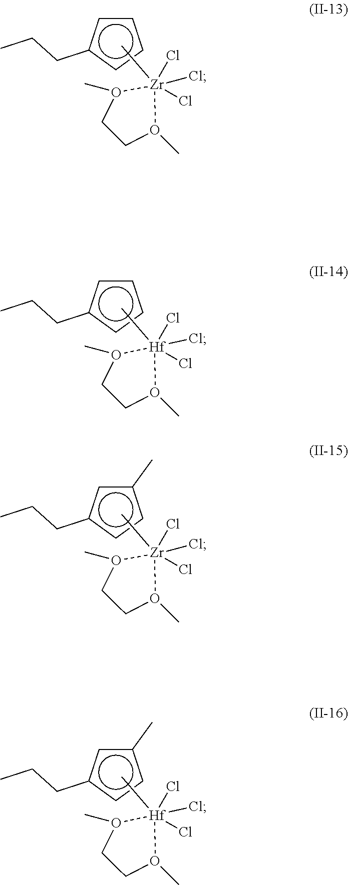

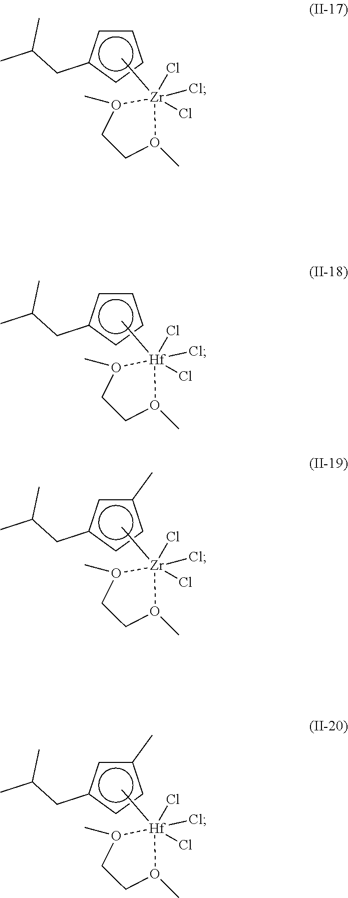

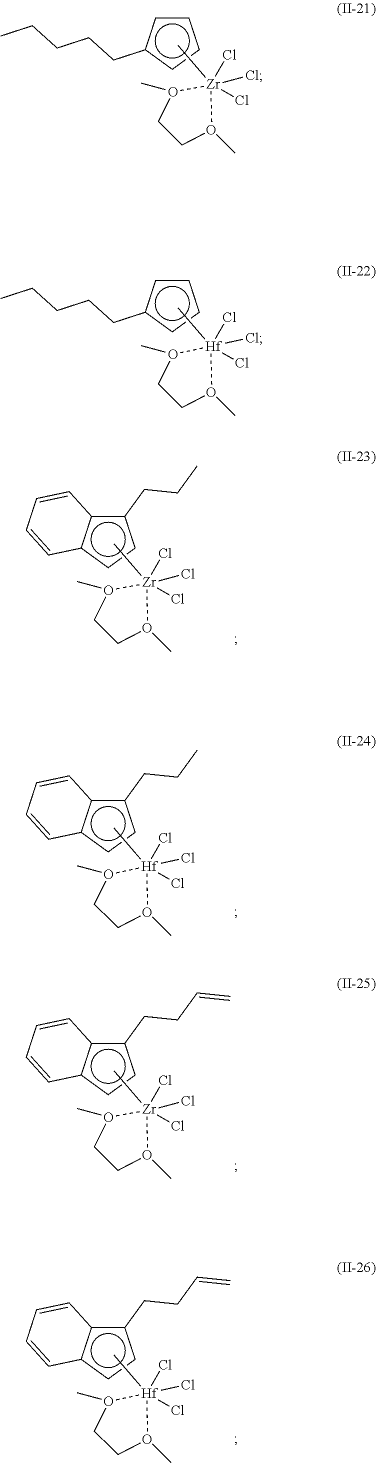

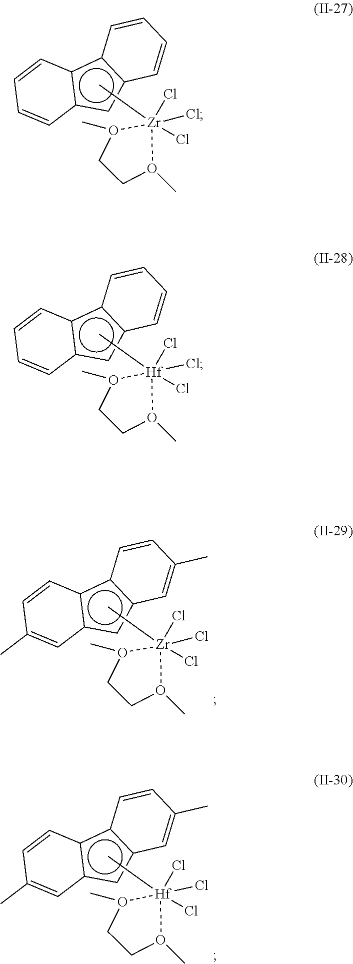

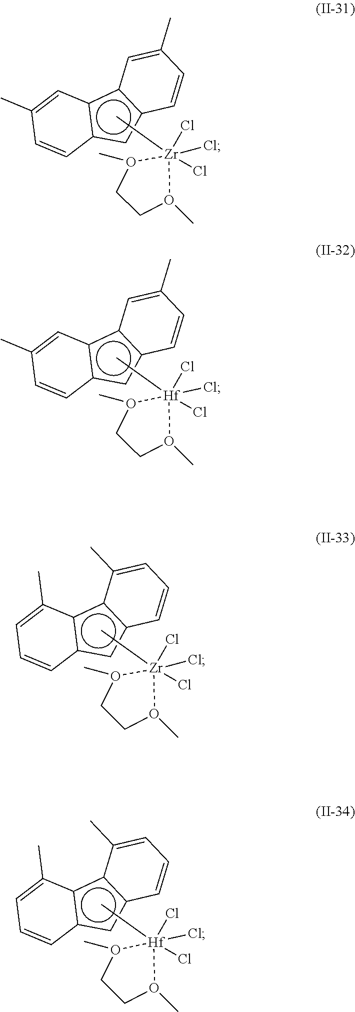

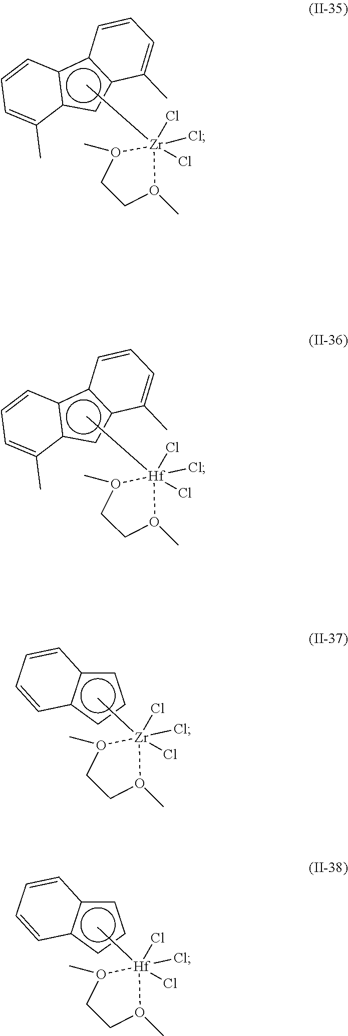

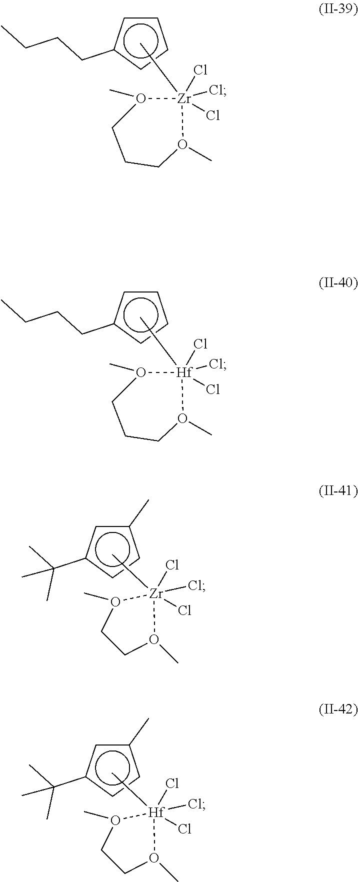

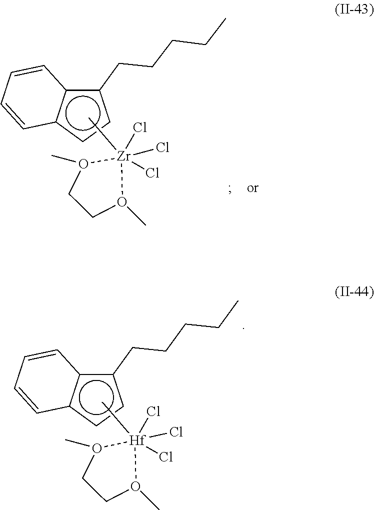

Reaction of the components present in the second mixture at operation 120 may produce a second reaction product mixture that includes the mono-Cp metallocene compound represented by formula (II) and one or more optional components. Such one or more optional components may include, for example, solvent, donor molecule, or combinations thereof, among other components.

Method 100 may optionally include isolating the mono-Cp metallocene compound represented by formula (II) from the second reaction product mixture. Any suitable isolation technique may be utilized. For example, isolating the mono-Cp metallocene compound represented by formula (II) from the second reaction product mixture may include removing solvent from the second reaction product mixture, and then washing with a suitable solvent. As another example, isolating the mono-Cp metallocene compound represented by formula (II) from the second reaction product mixture may include removing solvent from the second reaction product mixture, and then precipitating the mono-Cp metallocene compound represented by formula (II). Precipitating may involve adding solvent to selectively dissolve impurities present with the mono-Cp metallocene compound represented by formula (II), removing the dissolved impurities by any suitable solid-liquid separation (such as filtration), and washing the purified mono-Cp metallocene compound represented by formula (II). For example, the mono-Cp metallocene compound represented by formula (II) may be suspended in a solvent that dissolves impurities but not the mono-Cp metallocene compound represented by formula (II), such as pentane. The dissolved impurities may be removed by filtering the resulting suspension and then washing the mono-Cp metallocene compound represented by formula (II) that is present as a retentate.

FIG. 1B is a flow diagram showing selected operations of a method 150 of synthesizing a mono-Cp metallocene compound according to at least one aspect of the present disclosure. Method 150 may be utilized when, for example, the reaction product mixture formed during operation 110 includes a solid component. Aspects and implementations of method 150 may be combined with other aspects and implementations described herein, such as aspects and implementations described with respect to method 100 of FIG. 1A. In general, method 150 enables conversion of bis-Cp metallocene compounds to mono-Cp metallocene compounds.

The method 150 may begin with reacting a first mixture comprising a bis-Cp metallocene compound represented by formula (I), a metal salt, and a solvent to form a reaction product mixture at operation 110. The reaction product mixture may include a liquid component and a solid component. The liquid component of the reaction product mixture comprises solvent and the metallocene compound represented by formula (III). The metallocene represented by formula (III) is soluble in the solvent. The solid component may include, for example, the metal salt used to form the first mixture. As described herein, the reaction product mixture may include the solid component when, for example, a molar ratio of the metal salt in the first mixture to the bis-Cp metallocene compound represented by formula (I) in the first mixture is greater than 1:1 (metal salt:bis-Cp metallocene compound represented by formula (I)). Implementations of operation 110 of method 150 are described herein with respect to operation 110 of method 100 (FIG. 1A).

The method 150 may further include separating the liquid component of the reaction product mixture from the solid component of the reaction product mixture at operation 115. The separation process of operation 115 may be performed using any suitable technique such as solid-liquid separation techniques. Illustrative, but non-limiting, solid-liquid separation techniques useful for operation 115 may include filtration, vacuum filtration, centrifugation, decantation, decanting centrifugation, or combinations thereof, among other techniques.

As the liquid component obtained from the solid-liquid separation of operation 115 includes the metallocene compound represented by formula (III) solubilized in the solvent, the liquid component obtained from the solid-liquid separation of operation 115 may be directly used for further processing. Additional amounts of the same solvent or an amount of a different solvent may be utilized to facilitate separation of the solid and liquid components of the reaction product mixture during the solid-liquid separation. Such solvents used to facilitate separation may include those solvents described herein with respect to operation 110.

The method 150 may further include reacting a second mixture comprising the liquid component and a donor molecule to form a mono-Cp metallocene compound represented by formula (II) at operation 120. Addition of the donor molecule to the reaction product mixture readily forms the mono-Cp metallocene compound represented by formula (II), which is an adduct of the donor molecule with the metallocene compound represented by formula (III). Implementations of operation 120 of method 150 are described herein with respect to operation 120 of method 100 (FIG. 1A).

Reaction of the components present in the second mixture at operation 120 may produce a second reaction product mixture that includes the mono-Cp metallocene compound represented by formula (II) and one or more optional components. Such one or more optional components may include, for example, solvent, donor molecule, or combinations thereof, among other components. Method 150 may optionally include isolating the mono-Cp metallocene compound represented by formula (II) from the second reaction product mixture. Any suitable isolation technique may be utilized such as the isolation described herein with respect to method 100.

As described herein and shown in Scheme B, the mono-Cp metallocene compound (or donor adduct) represented by formula (II) and formed by method 100 or method 150 may be utilized in the synthesis of bis-Cp metallocene compounds such as unbridged asymmetric metallocene compounds. “Unbridged asymmetric metallocene compound” is interchangeably referred to herein as “mixed unbridged metallocene compound”. Unbridged asymmetric metallocene compounds are represented by formula (VII):

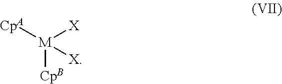

In formula (VII), Cp^{A}, Cp^{B}, and each X are bonded to M. Cp^{A} and Cp^{B} are different. M of formula (VII) is the Group 4 metal described herein with respect to formula (I). Each X of formula (VII) may be, independently, a monoanionic ligand described herein, such as those monoanionic ligands described herein with respect to formula (I), for example, H (hydride), halogen (such as F, Cl, Br, or I), unsubstituted hydrocarbyl, substituted hydrocarbyl, or a functional group comprising at least one element from Group 13-16 of the periodic table of the elements. Each X of formula (VII) is different from D of formula (II).

Cp^{A} of formula (VII) is the unsubstituted cyclopentadienyl group, the substituted cyclopentadienyl group, the unsubstituted indenyl group, the substituted indenyl group, the unsubstituted fluorenyl group, or the substituted fluorenyl group, for example, those Cp^{A} described herein.

Cp^{B} of formula (VII) is an unsubstituted cyclopentadienyl group, a substituted cyclopentadienyl group, an unsubstituted indenyl group, a substituted indenyl group, an unsubstituted fluorenyl group, or a substituted fluorenyl group. Cp^{B} may be any suitable group such as those Cp^{A} described herein, for example, those described herein with respect to formula (I).

Because Cp^{A} and Cp^{B} of formula (VII) are different, unbridged asymmetric metallocene compounds represented by formula (VII) may include metallocene compounds with two different cyclopentadienyl moieties, metallocene compounds with two different indenyl moieties, metallocene compounds with two different fluorenyl moieties, or metallocene compounds with two types of coordination moieties, such as cyclopentadienyl/indenyl, cyclopentadienyl/fluorenyl, and indenyl/fluorenyl.

Accordingly, methods described herein, for example method 100 and method 150, may further include converting the mono-Cp metallocene compound represented by formula (II) to an unbridged asymmetric metallocene compound represented by formula (VII). Alternatively, the conversion of mono-Cp metallocene compound represented by formula (II) to an unbridged asymmetric metallocene compound represented by formula (VII) may be performed in a separate method and/or facility.

Conversion of the mono-Cp metallocene compound represented by formula (II) to the unbridged asymmetric metallocene compound represented by formula (VII) may include contacting the mono-Cp metallocene compound represented by formula (II) with a complex of a Cp^{B} ligand. The contacting operation may include conversion conditions effective to convert the mono-Cp metallocene compound represented by formula (II) to the unbridged asymmetric metallocene compound represented by formula (VII). The complex of the Cp^{B} ligand may be an alkali metal-organic compound, such as a lithiated Cp^{B} or a lithium salt of Cp^{B}, or an alkali earth metal-organic compound, such as Cp^{B}MgX (X=Cl or Br). Under suitable conversion conditions, the complex of the Cp^{B} ligand may react with the mono-Cp metallocene represented by formula (II). Suitable conversion conditions may include: any suitable temperature, such as in a range from about −78° C. to about 30° C., such as from about −45° C. to about 30° C., such as from about −35° C. to about 25° C.; a suitable reaction period, such as in a range from about five minutes to about 24 hours, such as from about 30 minutes to about 20 hours, such as from about 1 hour to about 10 hours; and/or in the presence of any suitable solvent such as ether or tetrahydrofuran. Through reaction or contact of the complex of the Cp^{B} ligand with the mono-Cp metallocene compound represented by formula (II), the unbridged asymmetric metallocene compound represented by formula (VII) is formed.

Illustrative, but non-limiting examples of unbridged asymmetric metallocene compounds represented by formula (VII) may include one or more of unbridged asymmetric metallocene compounds (VII-1)-(VII-192) (“Ph” refers to phenyl, and “t-Bu” refers to tert-butyl):

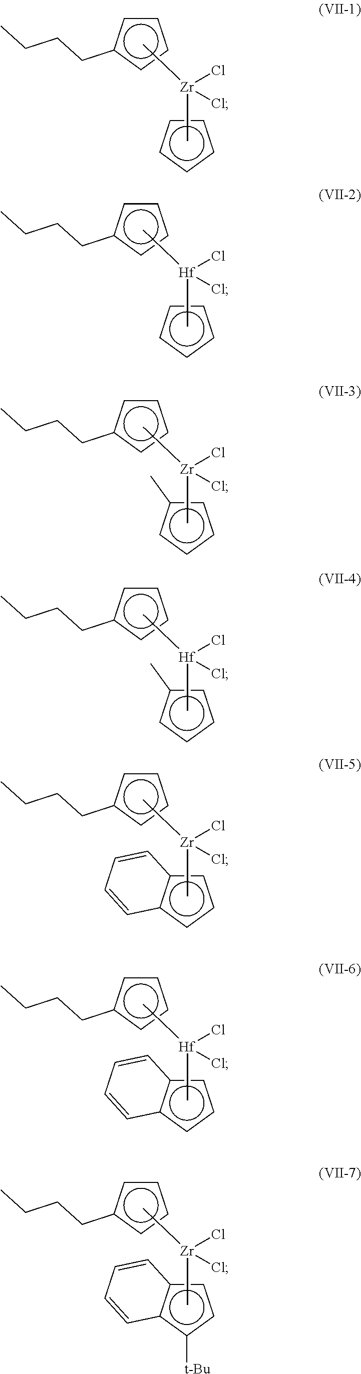

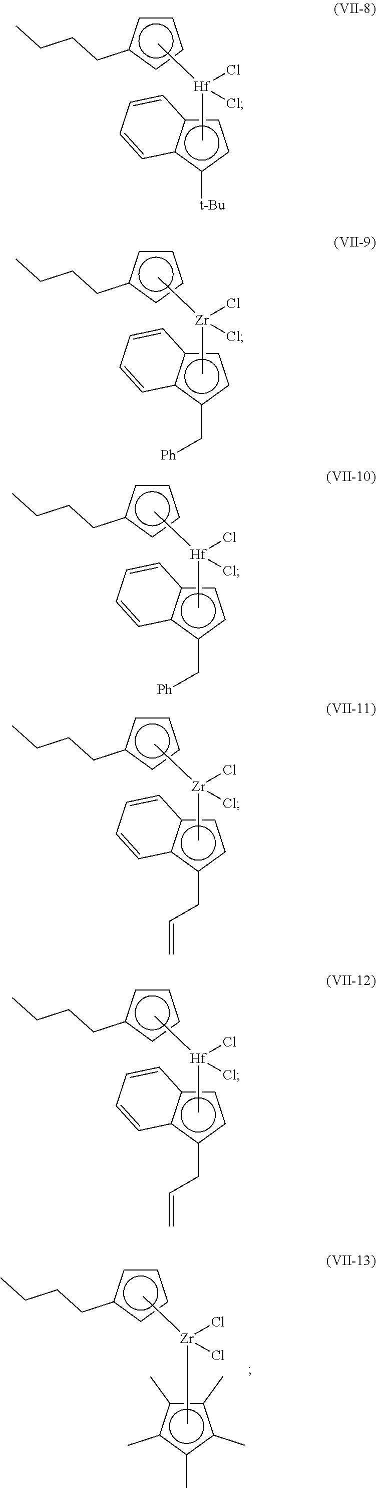

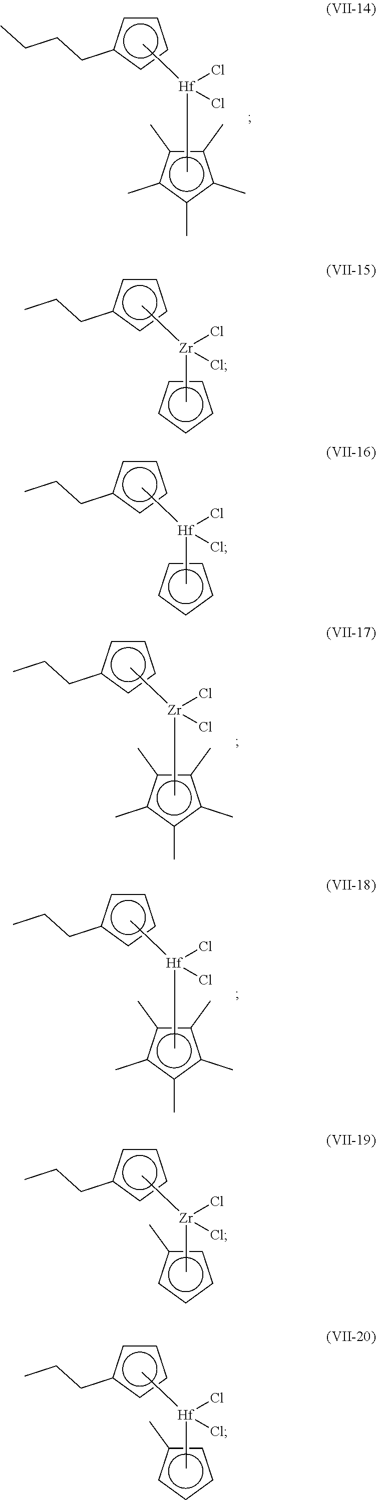

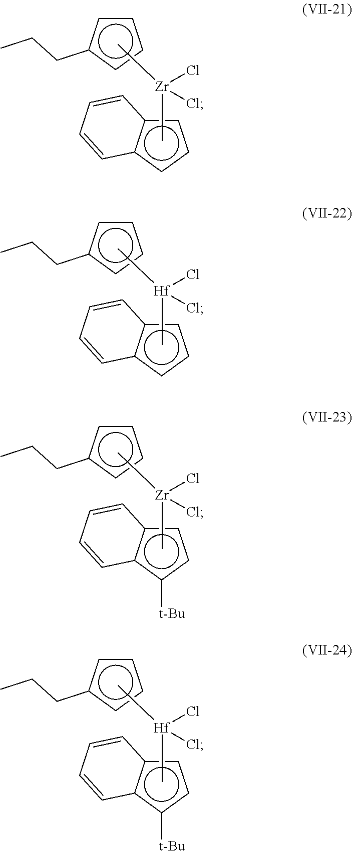

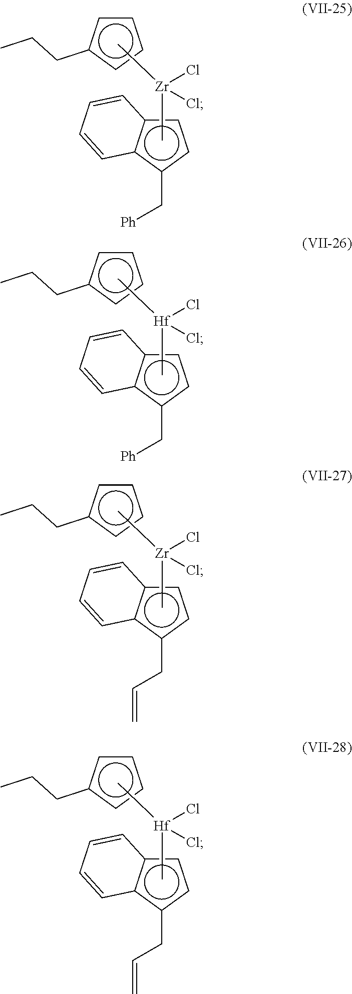

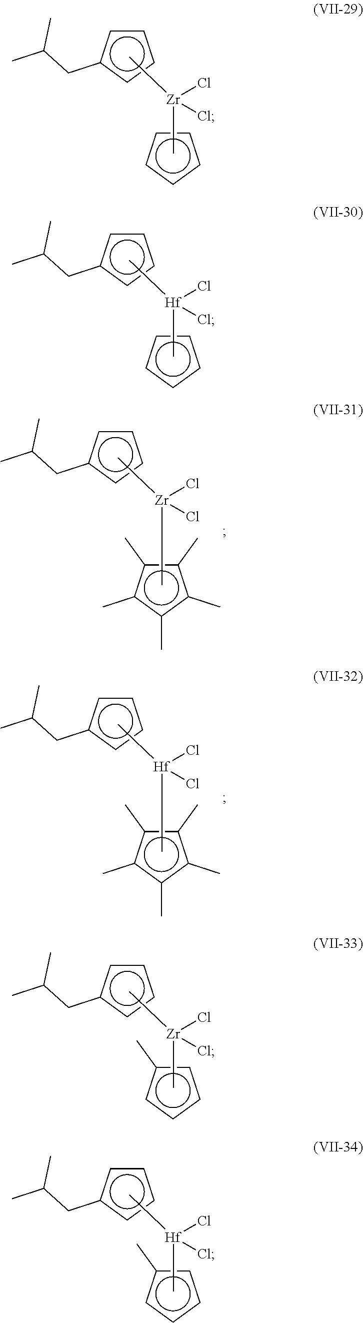

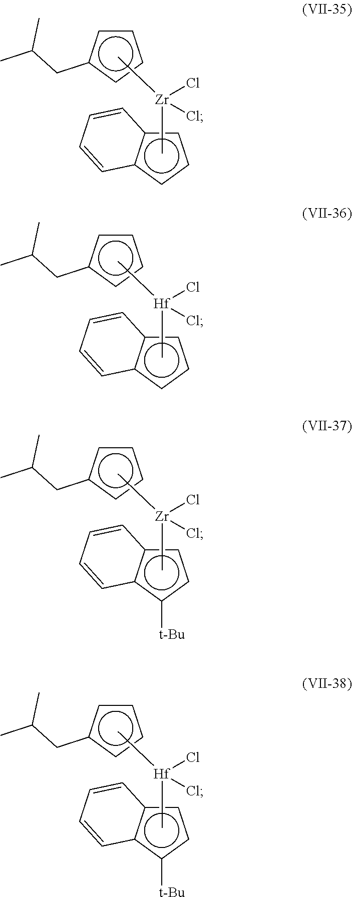

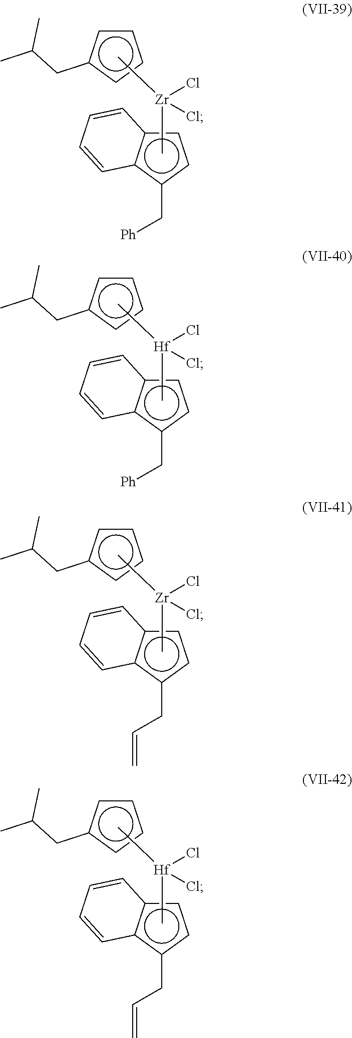

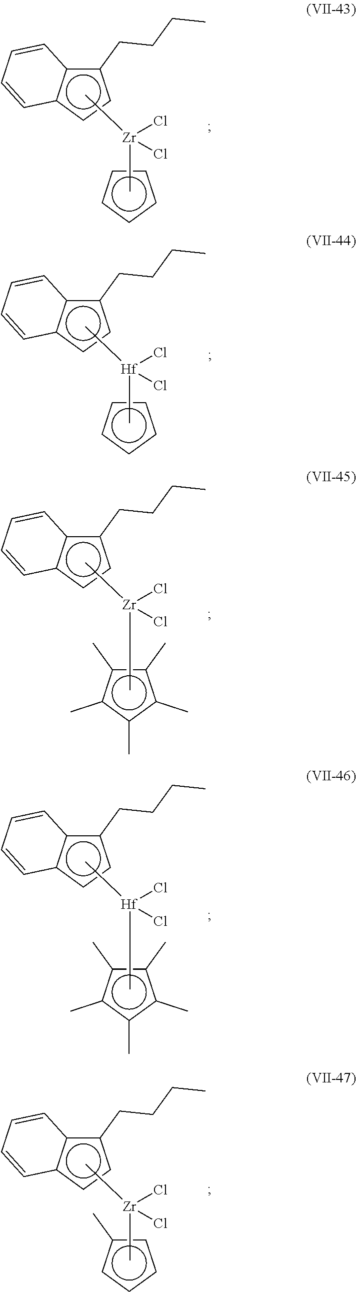

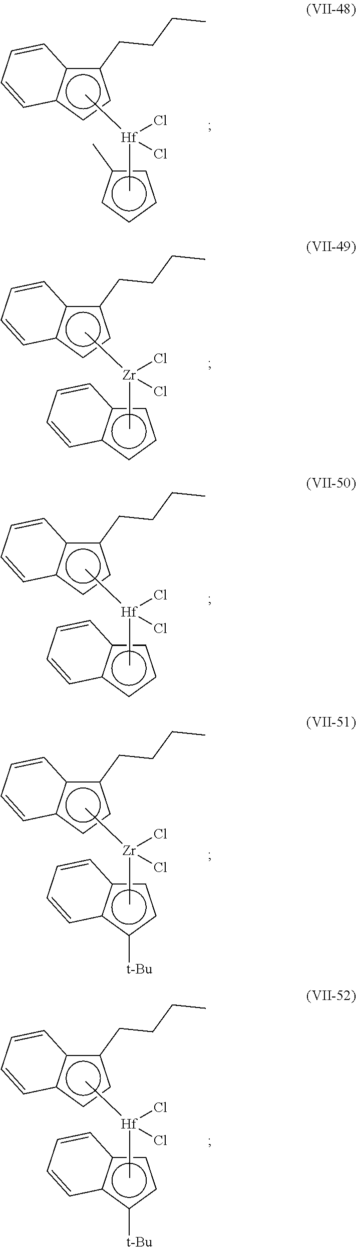

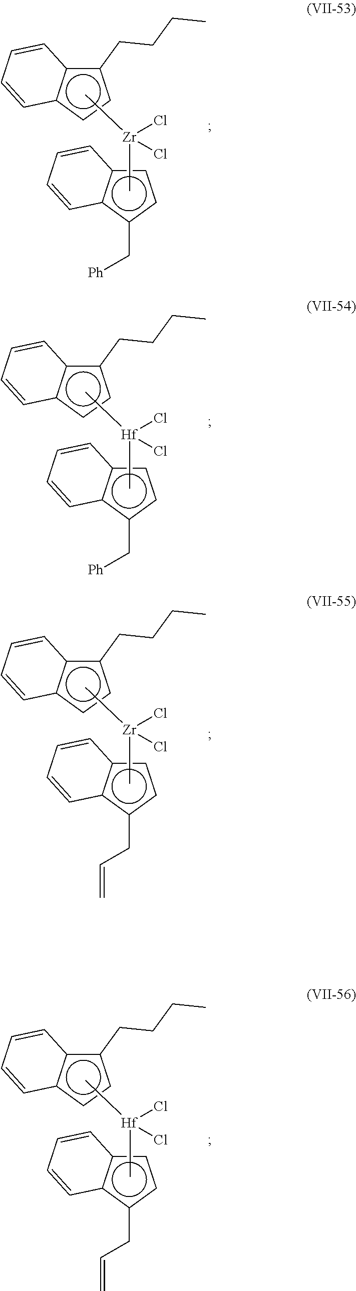

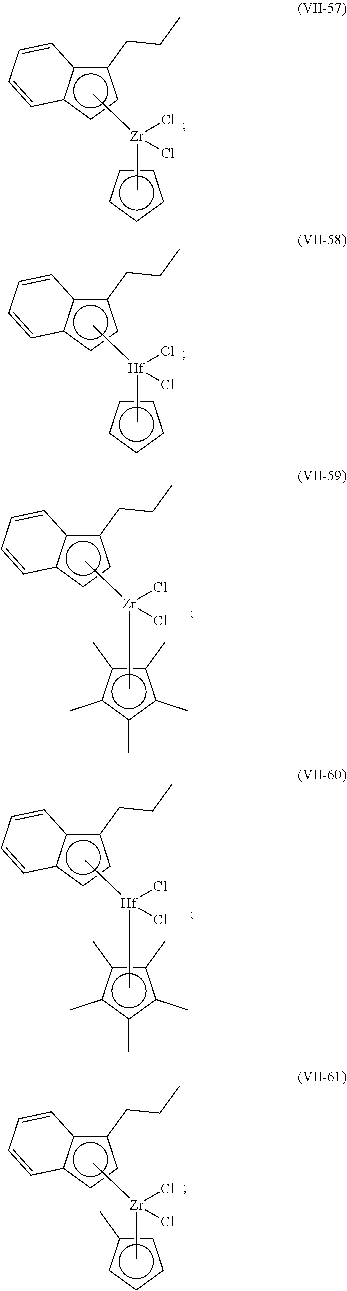

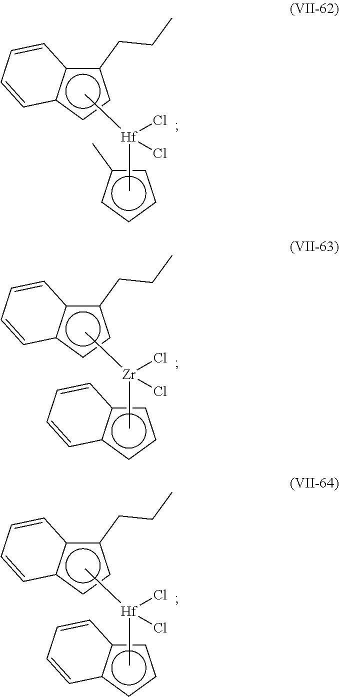

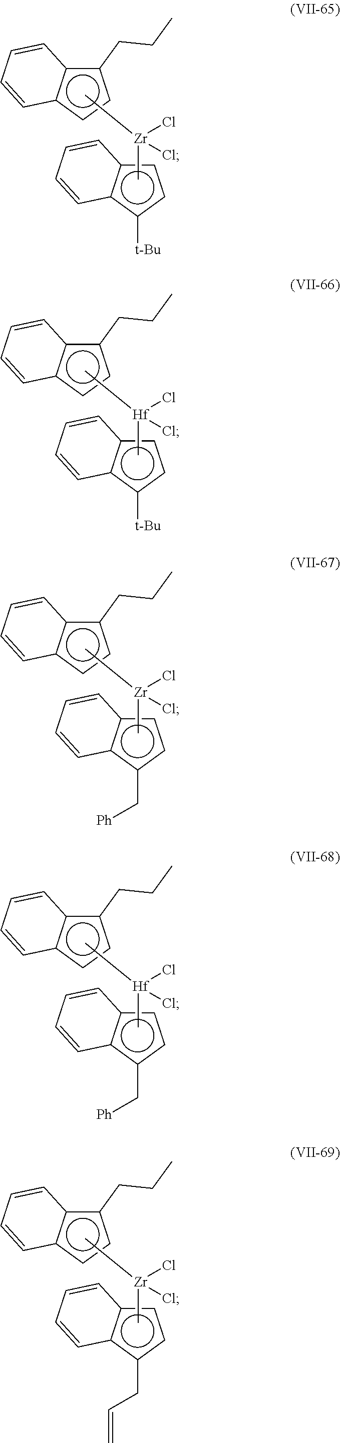

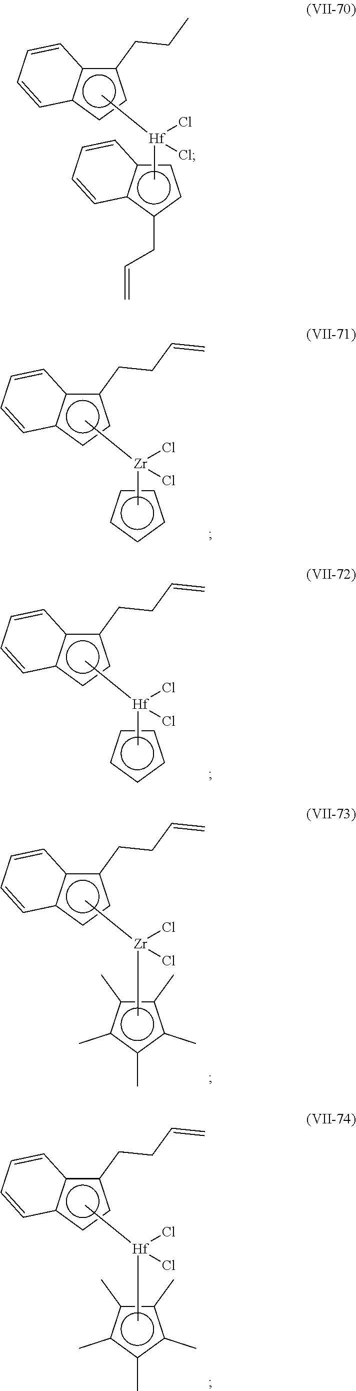

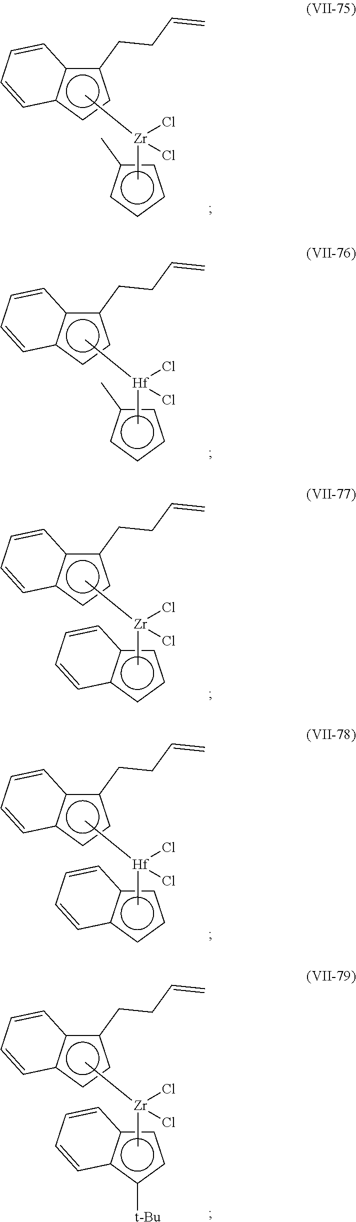

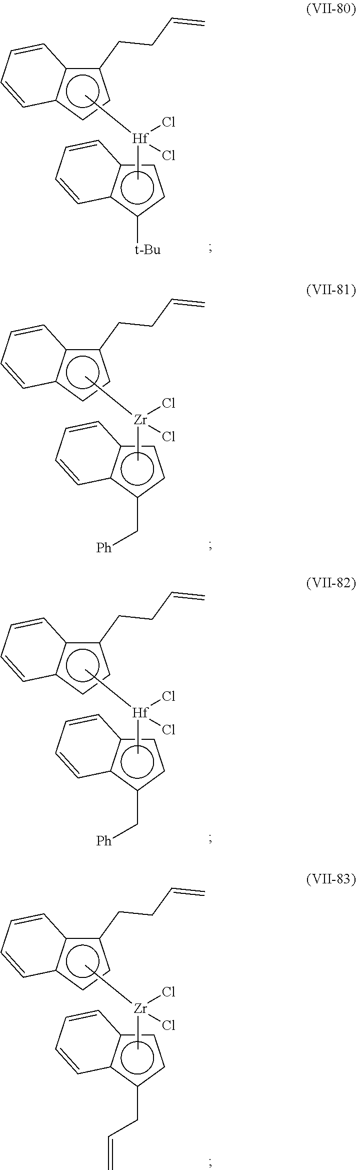

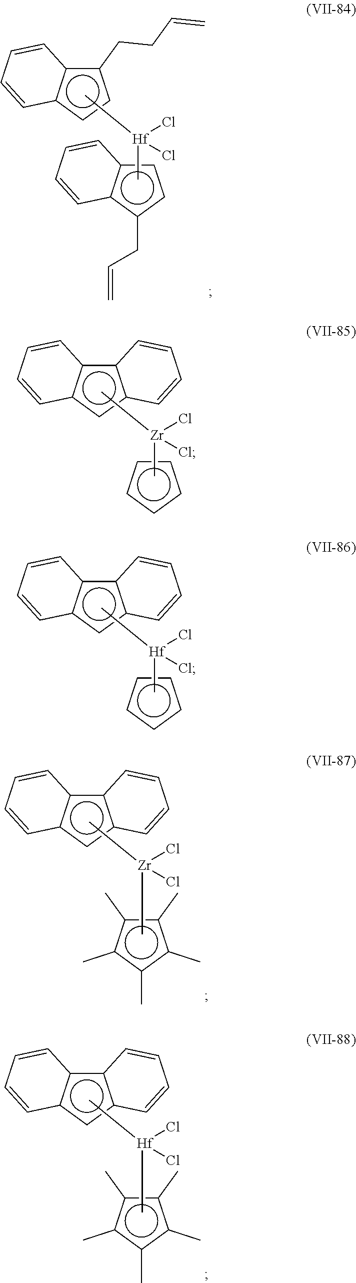

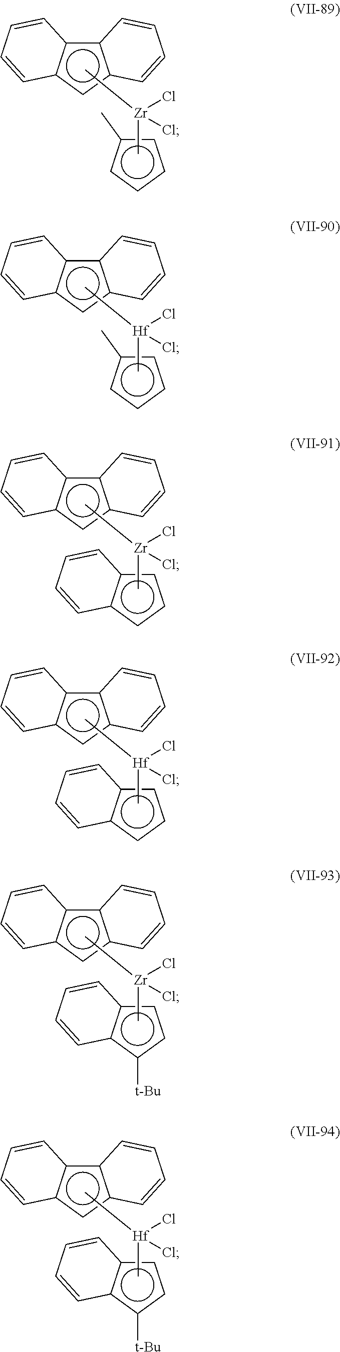

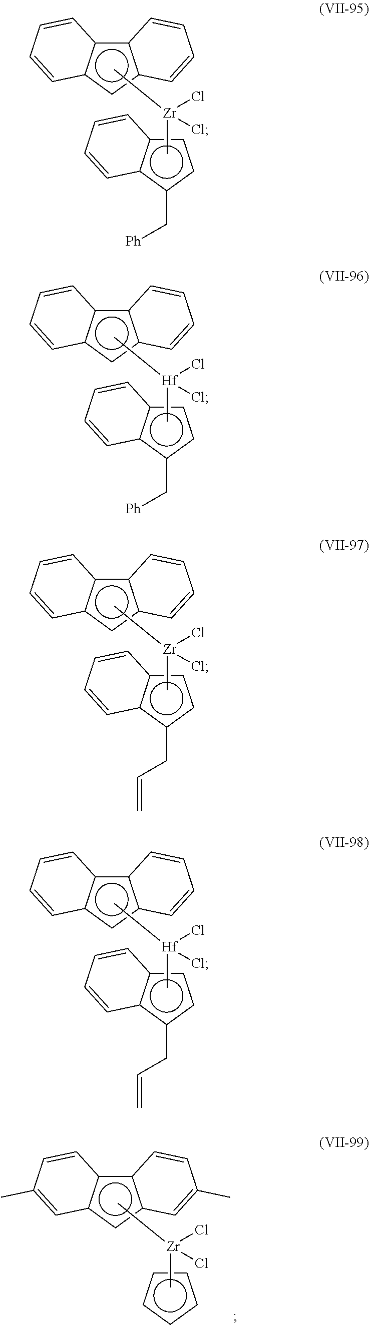

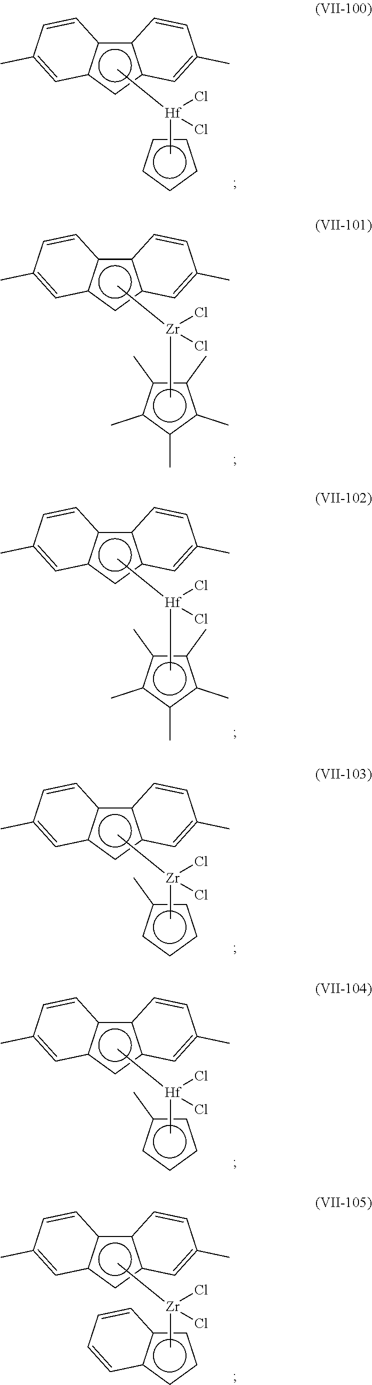

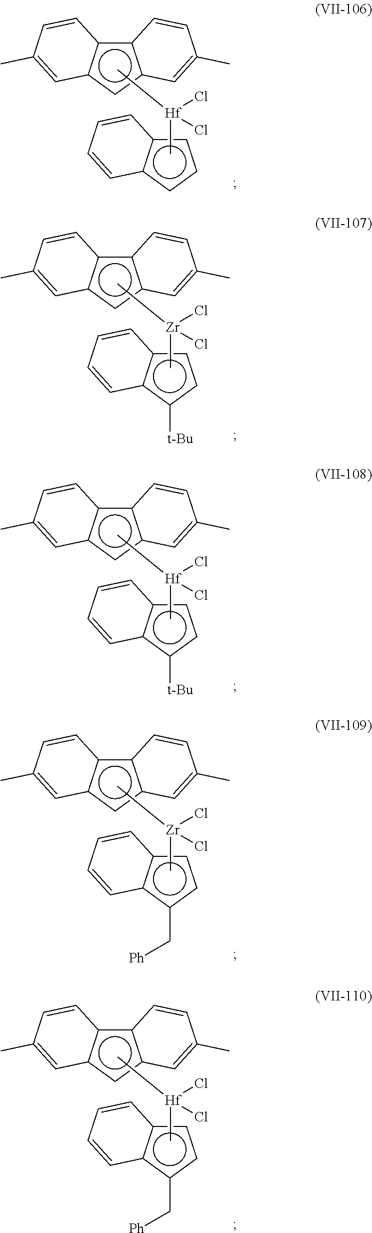

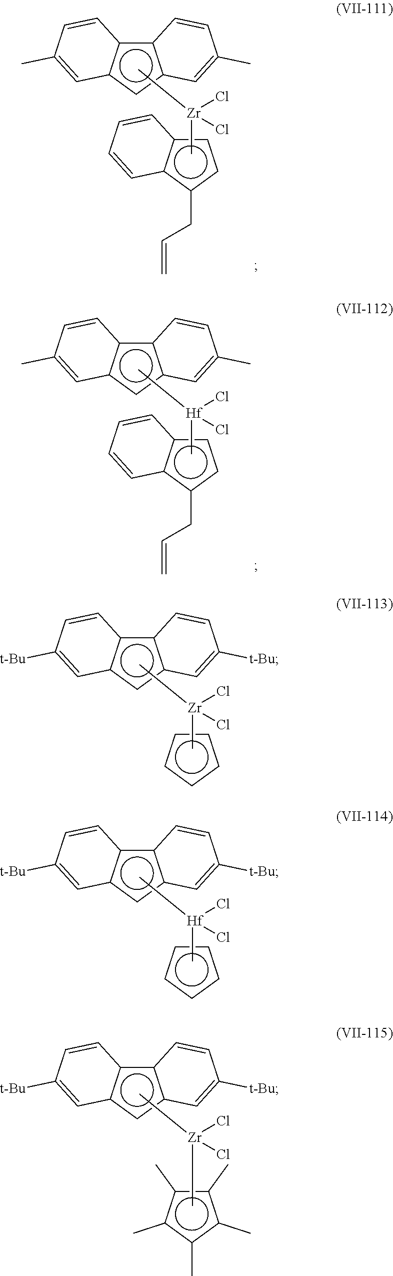

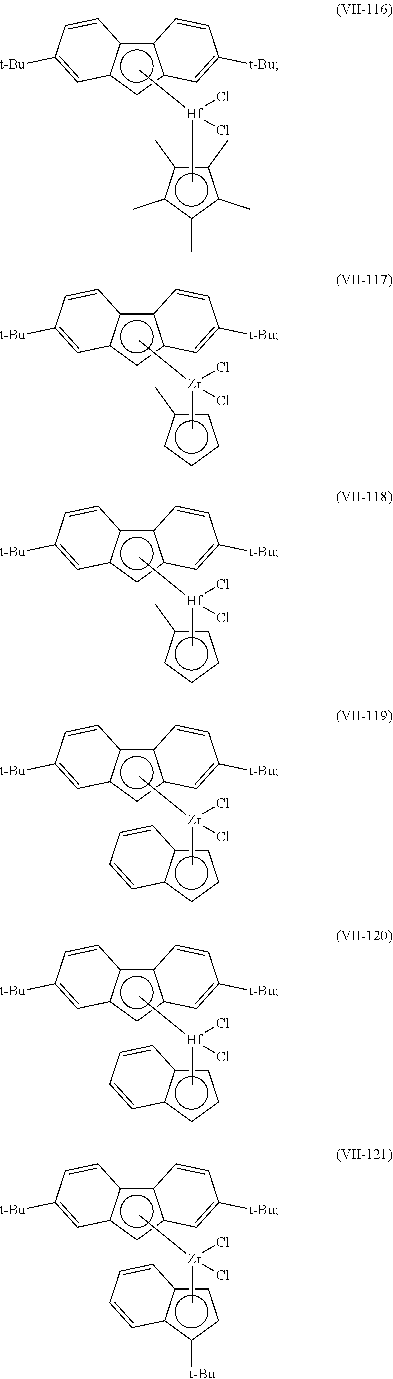

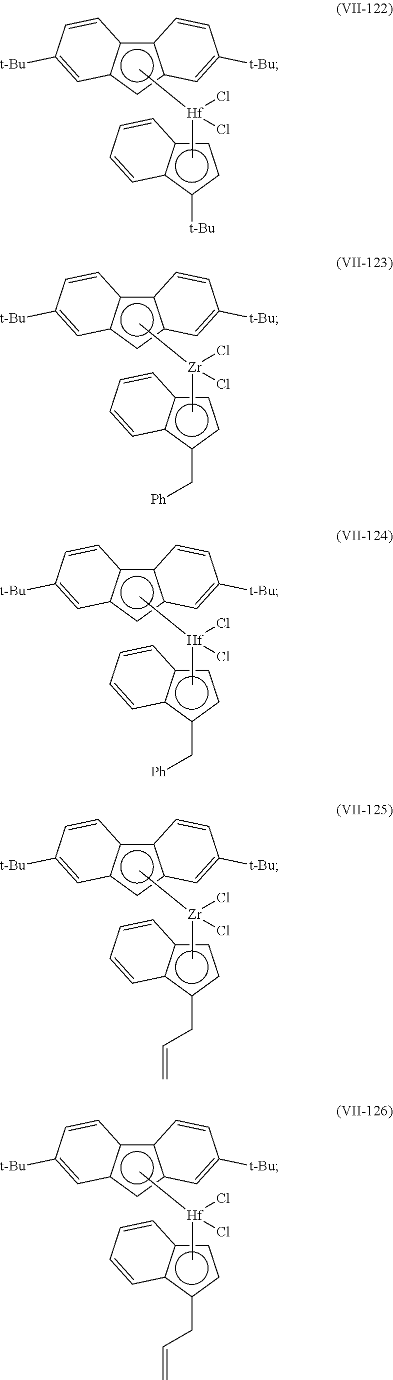

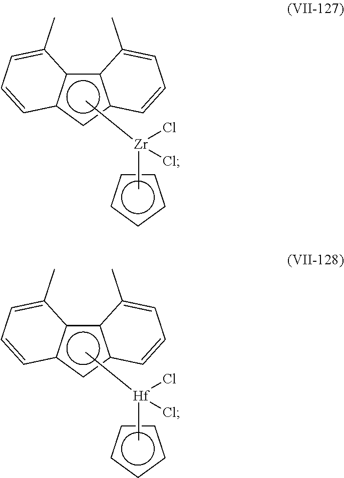

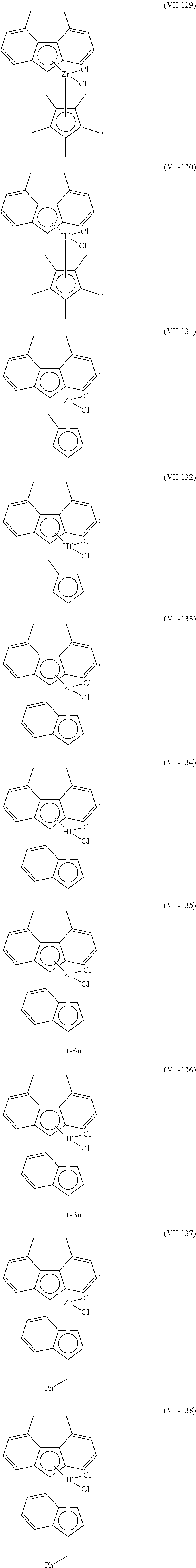

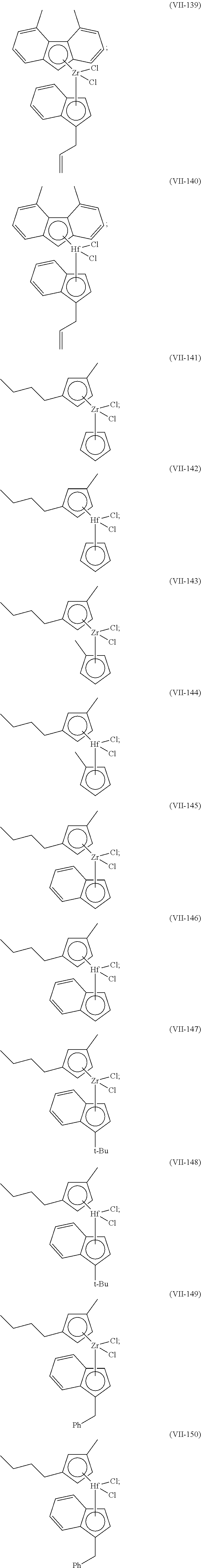

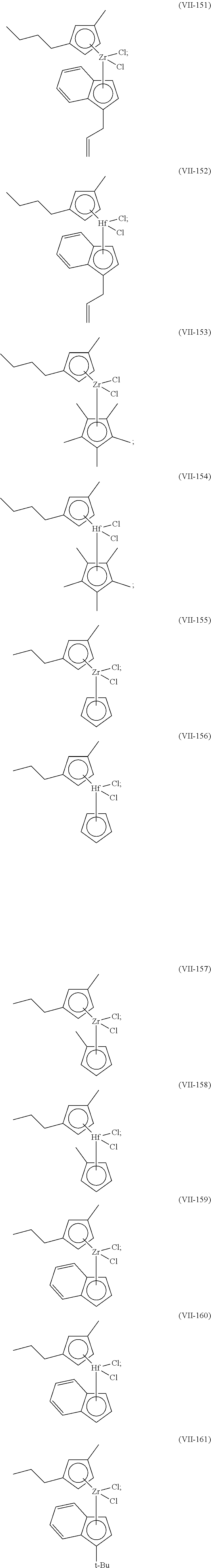

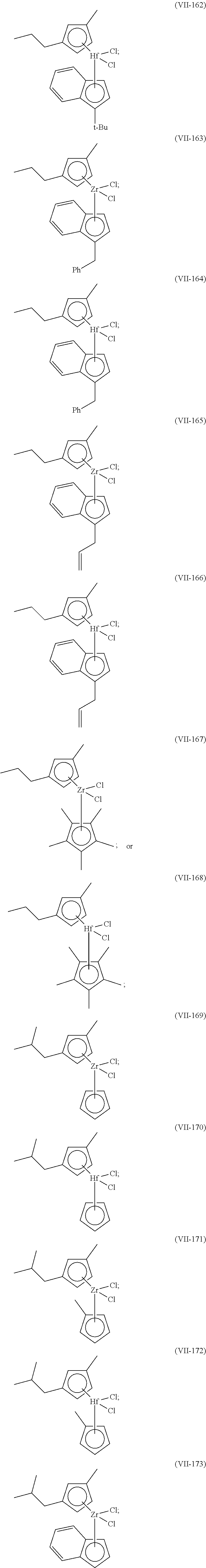

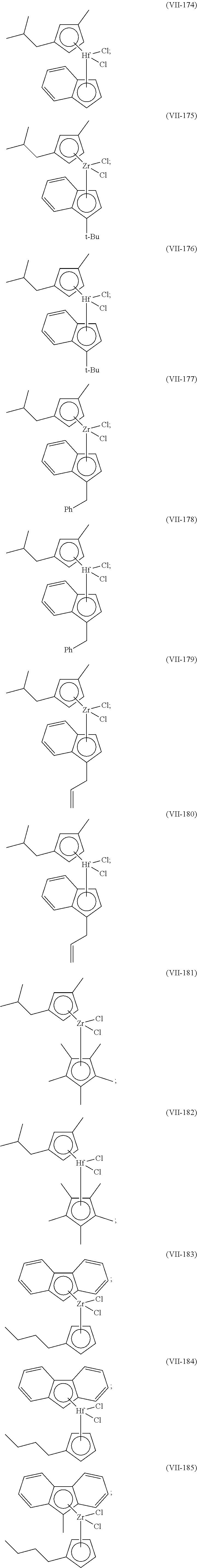

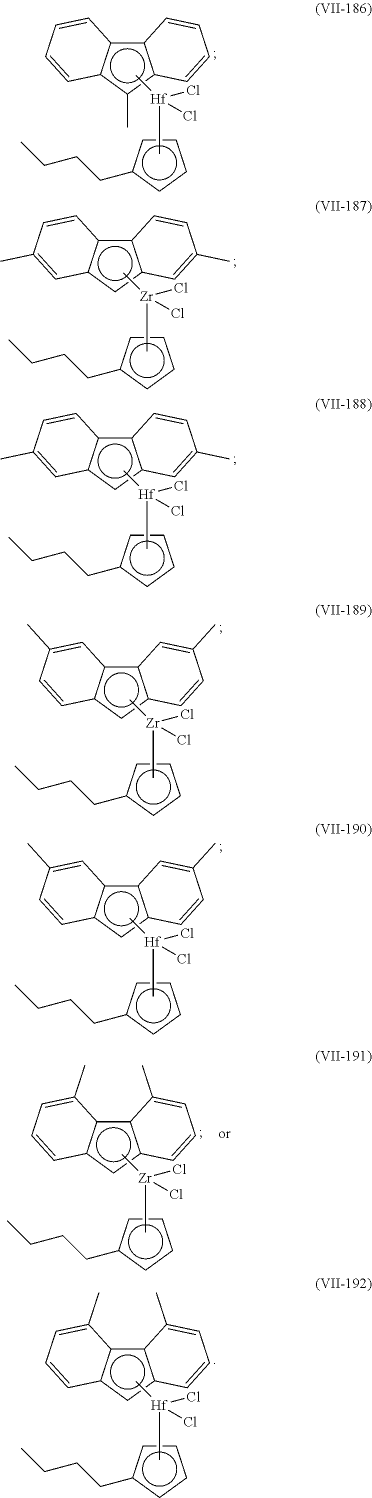

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

Examples of methods of synthesizing the metallocene compounds described herein were performed. All proton (¹H) nuclear magnetic resonance (NMR) experiments were performed using an appropriate deuterated solvent such as deuterated benzene (C₆D₆) solvent or deuterated chloroform (CDCl₃) solvent.

### Materials

Bis-Cp metallocene compounds represented by formula (I) presented in the examples include bis(n-butylcyclopentadienyl) zirconium dichloride ((nBuCp)₂ZrCl₂), bis(indenyl) zirconium dichloride ((Indenyl)₂ZrCl₂), bis(indenyl) hafnium dichloride ((Indenyl)₂HfCl₂), bis(propylcyclopentadienyl) zirconium dichloride ((PrCp)₂ZrCl₂), bis(propylcyclopentadienyl) hafnium dichloride ((PrCp)₂HfCl₂), bis(1-n-butyl-3-methylcyclopentadienyl) zirconium dichloride ((1-nBu-3-MeCp)₂ZrCl₂), bis(fluorenyl) zirconium dichloride ((Fluorenyl)₂ZrCl₂), and bis(fluorenyl) hafnium dichloride ((Fluorenyl)₂HfCl₂).

Metal salts of formula MX₄ presented in the examples include zirconium tetrachloride (ZrCl₄) and hafnium tetrachloride (HfCl₄).

Donor molecules presented in the examples include 1,2-dimethoxyethane (DME), diethyl ether, tetrahydrofuran (THF), acetone, acetonitrile, N,N-dimethylformamide, 2,2-dimethoxypropane, and 1,3-dimethoxypropane.

Example 1 is a synthesis of {(nBuCp)ZrCl₃}ₚ used as a comparative example. Examples 2-10 are syntheses of compound (II-1). Syntheses of other mono-Cp metallocene compounds described herein are provided.

### Example 1: Synthesis of {(nBuCp)ZrCl₃}ₚ

(nBuCp)₂ZrCl₂ (400 mg, 97% purity, 0.99 mmol, from Sigma-Aldrich), ZrCl₄ (253 mg, 1.09 mmol), and 13 mL of anhydrous toluene were charged into a Schlenk flask. Under nitrogen, the reaction mixture was heated to 100° C. and vigorously stirred for 20 hours, forming a dark, red-brown mixture. The reaction mixture was cooled to room temperature and filtered. The filtrate was evaporated under vacuum to provide the crude product as a red-brown thick oil. The crude product was soluble in toluene and dichloromethane. Multiple attempts to precipitate the product by dissolving the thick oil in dichloromethane and adding pentane into the dichloromethane solution were unsuccessful. The ¹H NMR spectrum of the product in C₆D₆ was complex. The 1H NMR spectrum showed that (nBuCp)₂ZrCl₂ was mostly consumed and suggested that the crude product was a complex mixture of multiple species. ¹H NMR (C₆D₆, 300 MHz): δ 6.70-6.72 (m, 0.64H), 6.57-6.60 (m, 0.21H), 6.54-6.57 (m, 0.71H), 6.37-6.39 (m, 0.21H), 6.29-6.31 (m, 0.89H), 6.25-6.27 (m, 1.10 H), 6.20-6.22 (broad, 1.86H), 6.06 (very broad, 2.70H), 5.94-5.98 (m, 0.38H), 5.69-5.71 (m, 0.12H), 2.71-2.76 (m, 1.07H), 2.49-2.68 (m, 3.75H), 1.20-1.45 (m, 7.56H), 1.05-1.20 (m, 5.49H), 0.70-0.85 (m, 6H).

### Example 2: Synthesis of (nBuCp)ZrCl₃(DME) ((Compound (II-1))

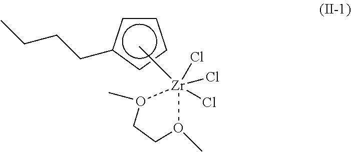

(nBuCp)₂ZrCl₂ (400 mg, 97% purity, 0.99 mmol, from Sigma-Aldrich), ZrCl₄ (223 mg, 0.99 mmol), and 13 mL of anhydrous toluene were charged into a Schlenk flask. Under nitrogen, the reaction mixture was heated to 100° C. and vigorously stirred for 17 hours, forming a dark, brown mixture. The reaction mixture was cooled to room temperature and filtered. 1,2-Dimethoxyethane (DME, about 0.3 mL, 2.89 mmol) was then added to the filtrate. The resulting mixture was evaporated under vacuum to form a green-brown residue. With stirring, 2 mL of pentane was added to the green-brown residue, forming a precipitate. The mixture was then filtered. The solid was washed with pentane (2 mL, 2 times), and dried under vacuum to give the target product as a green-brown powder (yield 89%). The ¹H NMR spectrum of the product in C₆D₆ showed a high purity of (nBuCp)ZrCl₃ (DME) (Compound II-1). ¹H NMR (C₆D₆, 300 MHz): δ 6.36 (broad, 2H), 6.32 (broad, 2H), 3.17 (very broad, 10H), 3.00 (t, J=7.8 Hz, 2H), 1.50-1.59 (m, 2H), 1.20-1.32 (m, 2H), 0.84 (t, J=7.3 Hz, 3H).

### Example 3: Synthesis of (nBuCp)ZrCl₃(DME) ((Compound (II-1))

(nBuCp)₂ZrCl₂ (400 mg, 0.99 mmol, from BSC), ZrCl₄ (253 mg, 1.09 mmol), and 13 mL of anhydrous toluene were charged into a Schlenk flask. Under nitrogen, the reaction mixture was heated to 100° C. and vigorously stirred for 5 hours, forming a dark brown mixture. Aliquots of this brown reaction mixture were treated with DME (about 30 mg); the resulting mixture was evaporated under vacuum and analyzed by ¹H NMR spectroscopy, which showed a molar ratio of (nBuCp)₂ZrCl₂/(nBuCp)ZrCl₃ (DME) of approximately 0.07:1. ¹H NMR (C₆D₆, 300 MHz): δ 6.35-6.36 (m, 2H), 6.29 (broad, 2H), 5.90-5.92 (m, 0.32H), 5.75-5.76 (m, 0.31H), 3.20 (very broad, 10H), 3.00 (t, J=7.7 Hz, 2H), 2.64 (s, J=7.7 Hz, 0.6H), 1.16-1.60 (m, 5.4 H), 0.83-0.87 (m, 4.0H). The bulk reaction mixture was cooled to room temperature and filtered. DME (about 0.3 mL, 2.89 mmol) was added to the filtrate. The resulting solution was evaporated under vacuum to give a green-brown solid, which was washed with pentane (2 mL, 2 times), and dried under vacuum to give the target product (Compound II-1) as a green-brown powder with high purity (yield 91%). ¹H NMR (C₆D₆, 300 MHz): δ 6.35-6.36 (m, 2H), 6.30 (broad, 2H), 3.21 (very broad, 10H), 3.01 (t, J=7.7 Hz, 2H), 1.51-1.59 (m, 2H), 1.19-1.32 (m, 2H), 0.84 (t, J=7.3 Hz, 3H).

Example 3 illustrates that the reaction can be monitored by 1H NMR spectroscopy.

### Example 4: Synthesis of (nBuCp)ZrCl₃(DME) ((Compound (II-1))

(nBuCp)₂ZrCl₂ (400 mg, 0.99 mmol, from BSC), ZrCl₄ (253 mg, 1.09 mmol), and 13 mL of anhydrous toluene were charged into a Schlenk flask. Under nitrogen, the reaction mixture was heated to 100° C. and vigorously stirred for 5 hours, forming a dark brown mixture. The reaction mixture was cooled to room temperature. DME (about 0.3 mL, 2.89 mmol) was added to the reaction mixture. The resulting mixture was stirred at room temperature for 5-10 minutes. The mixture was then filtered. The filtrate was evaporated under vacuum to give a green-brown solid, which was washed with pentane (2 mL, 2-3 times), and dried under vacuum to give the target product (Compound II-1) as a green-brown powder with high purity (yield 92%). ¹H NMR (C₆D₆, 300 MHz): δ 6.35-6.36 (m, 2H), 6.29-6.30 (broad, 2H), 3.19 (very broad, 10H), 2.99 (t, J=7.7 Hz, 2H), 1.49-1.59 (m, 2H), 1.18-1.31 (m, 2H), 0.84 (t, J=7.3 Hz, 3H).

Example 4 illustrates that DME can be added prior to filtration.

### Example 5: Synthesis of (nBuCp)ZrCl₃(DME) ((Compound (II-1))

(nBuCp)₂ZrCl₂ (400 mg, 0.99 mmol, from BSC), ZrCl₄ (253 mg, 1.09 mmol), and 13 mL of anhydrous toluene were charged into a Schlenk flask. Under nitrogen, the reaction mixture was heated to 100° C. and vigorously stirred for 5 hours, forming a dark brown mixture. The reaction mixture was cooled to room temperature and filtered. The filtrate was evaporated under vacuum to give a green-brown product. With stirring, 1 mL of toluene and about 0.3 mL of DME (2.89 mmol) were added into the crude product. The resulting mixture was stirred at room temperature for 5-10 minutes. With stirring, approximately 6 mL of pentane was added to the mixture, forming a dark green-brown precipitate, which was then collected by filtration, washed with pentane (2 mL, 2 times), and dried under vacuum to give the target product (Compound II-1) as a green-brown solid (yield 88%). ¹H NMR (C₆D₆, 300 MHz): δ 6.35-6.36 (m, 2H), 6.30 (broad, 2H), 3.20 (very broad, 10H), 3.00 (t, J=7.8 Hz, 2H), 1.51-1.60 (m, 2H), 1.20-1.33 (m, 2H), 0.84 (t, J=7.3 Hz, 3H).

Example 5 illustrates a slightly different DME addition. Specifically, the metallocene compound represented by formula (III) was isolated (usually an oily or glassy material) first. Then the donor molecule was added to form the mono-Cp metallocene compound represented by formula (II). Addition of another solvent readily precipitated the mono-Cp metallocene compound represented by formula (II).

### Example 6: Synthesis of (nBuCp)ZrCl₃(DME) ((Compound (II-1))

(nBuCp)₂ZrCl₂ (2.02 g, 5.0 mmol, from BSC), ZrCl₄ (1.19 g, 5.10 mmol), and 30 mL of anhydrous toluene were charged into a Schlenk flask. Under nitrogen, the reaction mixture vigorously stirred at 100° C. for 17 hours. The mixture was then cooled to room temperature and filtered. The filtrate was evaporated under vacuum to give a green-brown oil. With vigorous agitation, a mixture of DME (2 mL, about 17 mmol) and pentane (15-20 mL) was added into the green-brown product, forming a brown solution with light-brown solid. The solid was collected by filtration, washed with pentane (10 mL, 2 times), and dried under vacuum to give the target product as an off-white solid (yield 94%). ¹H NMR (C₆D₆, 300 MHz): δ 6.34-6.36 (m, 2H), 6.30-6.32 (m, 2H), 3.20 (very broad, 10H), 3.02 (t, J=7.8 Hz, 2H), 1.50-1.60 (m, 2H), 1.20-1.31 (m, 2H), 0.85 (t, J=7.3 Hz, 3H).

Example 6 illustrates a slightly different DME addition. Specifically, the metallocene compound represented by formula (III) was isolated (usually an oily or glassy material) first. Then a mixture of the donor molecule and another solvent was added to the metallocene compound represented by formula (III) to form the mono-Cp metallocene compound represented formula (II). The product was then readily precipitated and isolated as the mono-Cp metallocene compound represented by formula (II).

### Example 7: Synthesis of (nBuCp)ZrCl₃(DME) ((Compound (II-1))

(nBuCp)₂ZrCl₂ (400 mg, 0.99 mmol), ZrCl₄ (223 mg, 0.99 mmol), DME (about 0.11 mL, 1.0 mmol), and 13 mL of anhydrous toluene were charged into a Schlenk flask. Under nitrogen, the reaction mixture was heated to 100° C. and vigorously stirred. After 5 hours at 100° C., the reaction mixture did not show any visual changes. Aliquots of the reaction mixture were evaporated under vacuum and analyzed by 1H NMR spectroscopy, which showed an approximate 1:1 mixture of (nBuCp)₂ZrCl₂ and (DME)ZrCl₄, without the formation of the target product.

### Examples 8, 9, and 10: Synthesis of (nBuCp)ZrCl₃(DME) (Compound (II-1))

A metal salt by itself may be insoluble in a non-coordinating solvent. A donor molecule (e.g., tetrahydrofuran (THF), acetonitrile, diethyl ether, etc.) could be used to coordinate to the metal salt and increase its solubility in the non-coordinating solvent. Examples 8 and 9 were performed to investigate whether use of a coordinating molecule/coordinating solvent as a partial solvent (and at low molar ratios) may speed up the reaction. Under the conditions tested, it was found that adding a coordinating molecule/coordinating solvent slowed down the reaction under the conditions tested. Therefore, the reaction still proceeds to the desired mono-Cp product with addition of a coordinating molecule/coordinating solvent as a partial solvent (and at low molar ratios), but is slower.

Example 8: Synthesis of (nBuCp)ZrCl₃ (DME) ((Compound (II-1)). (nBuCp)₂ZrCl₂ (400 mg, 0.99 mmol, from BSC), ZrCl₄ (253 mg, 1.09 mmol), Et₂O (about 150 mg, 2.02 mmol), and 13 mL of anhydrous toluene were charged into a Schlenk flask. Under nitrogen, the reaction mixture was heated to 100° C. and vigorously stirred for 5 hours, forming a dark green mixture. Aliquots of this dark green mixture were treated with DME (about 30 mg). The resulting mixture was evaporated under vacuum and analyzed by 1H NMR spectroscopy, which showed a molar ratio of (nBuCp)₂ZrCl₂/(nBuCp)₂ZrCl₃(DME) of approximately 0.23:1. Compared to Example 3, Example 8 showed a lower conversion of (nBuCp)₂ZrCl₂ for the same reaction period. Thus, the presence of Et₂O in the reaction mixture slows down the reaction under the conditions tested. The bulk reaction mixture was allowed to react at 100° C. for 17 hours, the dark green reaction mixture was cooled to room temperature and filtered; the filtrate was evaporated under vacuum to give the crude product as a dark green thick oil. 1H NMR spectroscopy showed the presence of multiple products with unreacted (nBuCp)₂ZrCl₂. To the dark green product were added anhydrous toluene (about 1 mL) and DME (about 0.3 mL). The mixture was stirred at room temperature for 5 minutes. With stirring, about 6 mL of pentane was added to the mixture, forming a dark green-brown precipitate, which was collected by filtration, washed with pentane (about 2 mL, 2 times), and dried under vacuum to give the target product (Compound II-1) as a green-brown solid. Overall, this example illustrates that using a coordinating solvent (e.g., Et₂O, at a low molar ratio) can slow down the synthesis reaction. However, the desired product (compound (II-1)) can still be obtained.

Example 9: Synthesis of (nBuCp)ZrCl₃ (DME) ((Compound (II-1)). (nBuCp)₂ZrCl₂ (400 mg, 0.99 mmol, from BSC), ZrCl₄ (253 mg, 1.09 mmol), THF (about 30 mg, 0.40 mmol), and 13 mL of anhydrous toluene were charged into a Schlenk flask. Under nitrogen, the reaction mixture was heated to 100° C. and vigorously stirred for 5 hours, forming a brown mixture. Aliquots of this brown mixture were treated with DME (about 30 mg). The resulting mixture was evaporated under vacuum and analyzed by 1H NMR spectroscopy, which showed a molar ratio of (nBuCp)₂ZrCl₂/(nBuCp)ZrCl₃(DME) of approximately 0.26:1. Compared to Example 3, Example 9 showed a lower conversion of (nBuCp)₂ZrCl₂ for the same reaction period. Thus, the presence of THE in the reaction mixture can slow down the reaction under the conditions tested.

Example 10: Synthesis of (nBuCp)ZrCl₃(DME) ((Compound (II-1)). (nBuCp)₂ZrCl₂ (400 mg, 0.99 mmol, from BSC), ZrC₄ (253 mg, 1.09 mmol), acetonitrile (about 25 mg, 0.61 mmol), and 13 mL of anhydrous toluene were charged into a Schlenk flask. Under nitrogen, the reaction mixture was heated to 100° C. and vigorously stirred for 5 hours, forming a brown mixture. Aliquots of this brown mixture were treated with DME (about 30 mg). The resulting mixture was evaporated under vacuum and analyzed by ¹H NMR spectroscopy, which showed a molar ratio of (nBuCp)₂ZrCl₂/(nBuCp)ZrCl₃(DME) of approximately 0.32:1. Compared to Example 3, Example 10 showed a lower conversion of (nBuCp)₂ZrCl₂ for the same reaction period. Thus, the presence of acetonitrile in the reaction mixture can slow down the reaction under the conditions tested.

### Example 11: Synthesis of (Indenyl)ZrCl₃(DME) ((Compound (II-31))

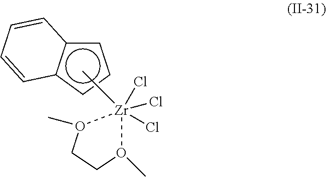

(Indenyl)₂ZrCl₂ (1.00 g, 2.55 mmol), ZrCl₄ (653 mg, 2.80 mmol) and about 30 mL of anhydrous toluene were charged into a Schlenk flask. Under nitrogen, the reaction mixture was vigorously stirred for 16 hours at 100° C. The reaction mixture was then cooled to room temperature and filtered. DME (about 0.6 mL, 5.8 mmol) was added to the filtrate. The resulting mixture was evaporated to give a residue, which was collected by filtration, washed with a mixture of toluene/pentane, and dried under vacuum to give the target product as a yellow solid (yield 73%). ¹H NMR (C₆D₆, 300 MHz): δ 7.56-7.61 (m, 2H), 7.07-7.13 (m, 2H), 6.63 (t, J=6.6 Hz, 1H), 6.56 (d, J=6.6 Hz, 2H), 3.05-3.18 (broad, m, 10H).

### Example 12: Synthesis of (PrCp)ZrCl₃(DME) ((Compound (II-11))

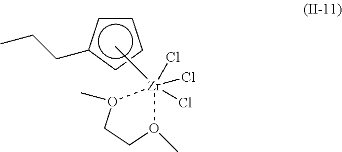

(PrCp)₂ZrCl₂ (750 mg, 1.99 mmol), ZrCl₄ (492 mg, 2.11 mmol), and 25 mL of anhydrous toluene were charged into a Schlenk flask. Under nitrogen, the reaction mixture was heated to 100° C. and vigorously stirred for 16 hours, forming a dark brown mixture. The reaction mixture was cooled to room temperature and filtered. DME (about 0.5 mL, 4.82 mmol) was added to the reaction mixture. The resulting mixture was evaporated under vacuum to form a dark brown residue, which was collected by filtration, washed with pentane (2 mL, 2 times), and dried under vacuum to give the target product (Compound II-11) as a light brown powder (yield 87%). ¹H NMR (C₆D₆, 300 MHz): δ 6.31-6.35 (m, 2H), 6.27-6.29 (m, 2H), 3.21 (very broad, 10H), 2.97 (t, J=7.7 Hz, 2H), 1.51-1.61 (m, 2H), 0.85 (t, J=7.3 Hz, 3H).

### Example 13: Synthesis of (PrCp)HfCl₃(DME) ((Compound (II-12))

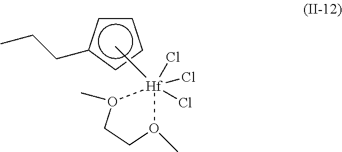

(PrCp)₂HfCl₂ (835 mg, 1.80 mmol), HfCl₄ (577 mg, 1.80 mmol), and 20 mL of anhydrous toluene were charged into a Schlenk flask. Under nitrogen, the reaction mixture was heated to 100° C. and vigorously stirred for 16 hours, forming a dark brown mixture. The reaction mixture was cooled to room temperature and filtered. DME (about 0.5 mL, 4.82 mmol) was added to the reaction mixture. The resulting mixture was evaporated under vacuum; the residue was washed with pentane and dried under vacuum to give the target product (Compound II-12) as an off-white solid (yield 95%). ¹H NMR (C₆D₆, 300 MHz): δ 6.16-6.18 (m, 2H), 6.11-6.14 (m, 2H), 3.16-3.28 (very broad, 10H), 2.96 (t, J=7.7 Hz, 2H), 1.51-1.60 (m, 2H), 0.84 (t, J=7.4 Hz, 3H).

### Example 14. Synthesis of (nBuCp)ZrCl₃(OEt)ₙ (n is Between 0 and 2)

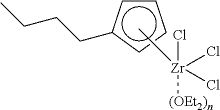

(nBuCp)₂ZrCl₂ (405 mg, 1.0 mmol), ZrCl₄ (256 mg, 1.1 mmol), and ~15 mL of anhydrous toluene were charged into a Schlenk flask. Under nitrogen, the reaction mixture was vigorously stirred for 16 hours at 100° C. The mixture was then cooled to room temperature and filtered. Anhydrous diethyl ether (about 0.5 mL, 4.8 mmol) was added to the filtrate. The resulting mixture was evaporated; the residue was washed with a mixture of toluene/pentane and dried under vacuum to give a light brown solid (yield 62%). The value of n in this example is about 0.62. Drying under a higher temperature and a longer period may decrease n. ¹H NMR (C₆D₆, 300 MHz): δ 6.35 (s, broad, 2H), 6.18 (s, broad, 2H), 3.40 (q, J=7.1 Hz, 2.5H), 2.76 (t, J=7.7 Hz, 2H), 1.28-1.38 (m, 2H), 1.12-1.21 (m, 2H), 0.97 (t, J=7.1 Hz, 3.8H), 0.81 (t, J=7.3 Hz, 3H).

### Example 15. Synthesis of (nBuCp)ZrCl₃(THF)ₙ (n is Between 0 and 2)

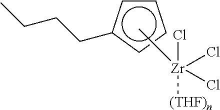

(nBuCp)₂ZrCl₂ (405 mg, 1.0 mmol), ZrCl₄ (256 mg, 1.1 mmol), and ~15 mL of anhydrous toluene were charged into a Schlenk flask. Under nitrogen, the reaction mixture was vigorously stirred for 7 hours at 100° C. The mixture was then cooled to room temperature and filtered. Anhydrous THF (about 0.5 mL, 6.2 mmol) was added to the filtrate. The resulting mixture was evaporated; the residue was washed with a mixture of toluene/pentane and dried under vacuum to give a light brown solid (yield 67%). The value of n in this example is about 1.7. ¹H NMR (C₆D₆, 300 MHz): δ 6.32-6.38 (m, broad, 4H), 3.66 (very broad, 6.8H), 3.03 (t, J=7.5 Hz, 2H), 1.51-1.60 (m, 2H), 1.37 (very broad, 6.8H) 1.24-1.36 (m, 2H), 0.87 (t, J=7.3 Hz, 3H).

### Example 16. Synthesis of (nBuCp)ZrCl₃(acetone)ₙ (n is Between 0 and 2)

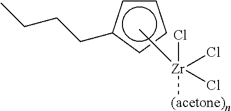

(nBuCp)₂ZrCl₂ (405 mg, 1.0 mmol), ZrCl₄ (256 mg, 1.1 mmol), and ~15 mL of anhydrous toluene were charged into a Schlenk flask. Under nitrogen, the reaction mixture was vigorously stirred for 16 hours at 100° C. The mixture was then cooled to room temperature and filtered. Anhydrous acetone (about 0.5 mL, 6.8 mmol) was added to the filtrate. The resulting mixture was evaporated; the residue was washed with a mixture of toluene/pentane and dried under vacuum to give a light brown solid (yield 57%). The value of n in this example is about 1.5. ¹H NMR (C₆D₆, 300 MHz): δ 6.68 (s, broad, 2H), 6.47 (broad, 2H), 2.92 (t, J=7.6 Hz, 2H), 1.52-1.64 (s, broad, 11H), 1.20-1.29 (m, 2H), 0.86 (t, J=7.4 Hz, 3H).

### Example 17. Synthesis of (nBuCp)ZrCl₃(N,N-dimethylformamide)₂

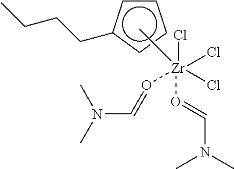

(nBuCp)₂ZrCl₂ (405 mg, 1.0 mmol), ZrCl₄ (256 mg, 1.1 mmol), and ~15 mL of anhydrous toluene were charged into a Schlenk flask. Under nitrogen, the reaction mixture was vigorously stirred for 16 hours at 100° C. The mixture was then cooled to room temperature and filtered. Anhydrous N,N-dimethylformamide (~0.5 mL, 6.5 mmol) was added to the filtrate. The resulting mixture was evaporated; the residue was washed with a mixture of toluene/pentane and dried under vacuum to give a white solid (yield 64%). ¹H NMR (C₆D₆, 300 MHz): δ 7.82-8.07 (m, broad, 2H), 6.94 (t, J=2.7 Hz, 2H), 6.66 (t, J=2.7 Hz, 2H), 3.10 (t, J=7.7 Hz, 2H), 2.38 (s, broad, 6H), 1.94 (s, broad, 6H), 1.62-1.72 (m, 2H), 1.31-1.41 (m, 2H), 0.87 (t, J=7.4 Hz, 3H).

### Example 18. Synthesis of (nBuCp)ZrCl₃(acetonitrile)ₙ (n is Between 0 and 2)

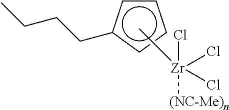

(nBuCp)₂ZrCl₂ (405 mg, 1.0 mmol), ZrCl₄ (256 mg, 1.1 mmol), and ~15 mL of anhydrous toluene were charged into a Schlenk flask. Under nitrogen, the reaction mixture was vigorously stirred for 16 hours at 100° C. The mixture was then cooled to room temperature and filtered. Anhydrous acetonitrile (about 0.5 mL, 9.6 mmol) was added to the filtrate. The resulting mixture was evaporated; the residue was washed with a mixture of toluene/pentane and dried under vacuum to give an off-white solid (yield 63%). The value of n in this example is about 1.7. ¹H NMR (C₆D₆, 300 MHz): δ 6.68-6.70 (m, 2H), 6.44-6.50 (m, 2H), 3.04 (t, J=7.8 Hz, 2H), 1.52-1.64 (m, 2H), 1.17-1.32 (m, 2H), 0.84 (t, J=7.4 Hz, 3H), 0.73 (s, broad, 5H).

### Example 19: Synthesis of (nBuCp)ZrCl₃(2,2-dimethoxypropane)

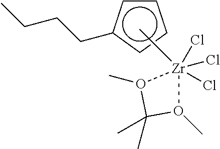

(nBuCp)₂ZrCl₂ (405 mg, 1.0 mmol), ZrCl₄ (256 mg, 1.1 mmol), and ~15 mL of anhydrous toluene were charged into a Schlenk flask. Under nitrogen, the reaction mixture was vigorously stirred for 16 hours at 100° C. The mixture was then cooled to room temperature and filtered. 2,2-Dimethoxypropane (about 0.3 mL, 2.8 mmol) was added to the filtrate. The resulting mixture was evaporated; the residue was washed with a mixture of toluene/pentane and dried under vacuum to give a red-brown solid (yield 55%). ¹H NMR (C₆D₆, 300 MHz): δ 6.46 (t, J=5.4 Hz, 2H), 6.33 (t, J=5.4 Hz, 2H), 3.04-3.25 (very broad, 6H), 2.90 (t, J=7.7 Hz, 2H), 1.48-1.56 (m, 2H), 1.22-1.27 (m, 8H), 0.84 (t, J=7.4 Hz, 3H).

### Example 20: Synthesis of (3-butenylCp)ZrCl₃(DME)

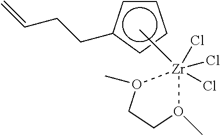

(3-Butenyl-Cp)₂ZrCl₂ (403 mg, 1.0 mmol), ZrCl₄ (256 mg, 1.1 mmol), and ~15 mL of anhydrous toluene were charged into a Schlenk flask. Under nitrogen, the reaction mixture was vigorously stirred for 16 hours at 100° C. The mixture was then cooled to room temperature and filtered. DME (about 0.3 mL, 2.89 mmol) was added to the filtrate. The resulting mixture was evaporated; the residue was washed with a mixture of toluene/pentane and dried under vacuum to give the target product as a light-brown solid (yield 78%). ¹H NMR (C₆D₆, 300 MHz): δ 6.32-6.36 (m, 2H), 6.29 (broad, 2H), 5.62 (m, 1H), 4.86-5.01 (m, 2H), 3.21 (very broad, 10H), 2.97 (m, 2H), 2.13 (m, 2H).

### Example 21: Synthesis of (1-nBu-3-Me-Cp)ZrCl₃(DME)

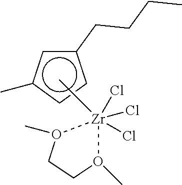

(1-nBu-3-Me-Cp)₂ZrCl₂ (200 mg, 0.45 mmol), ZrCl₄ (104 mg, 0.45 mmol), and ~5 mL of anhydrous toluene were charged into a Schlenk flask. Under nitrogen, the reaction mixture was vigorously stirred for 16 hours at 100° C. The mixture was then cooled to room temperature and filtered. DME (~0.3 mL, 2.89 mmol) was added to the filtrate. The resulting mixture was evaporated; the residue was washed with a mixture of toluene/pentane and dried under vacuum to give the target product as an off-white solid (yield 51%). ¹H NMR (C₆D₆, 300 MHz): δ 5.88-6.11 (m, 3H), 3.21 (very broad, 10H), 2.90-2.95 (m, 2H), 2.47 (s, 3H), 1.48-1.55 (m, 2H), 1.24-1.32 (m, 2H), 0.86 (t, J=7.4 Hz, 3H).

### Example 22: Synthesis of (Indenyl)HfCl₃(DME)

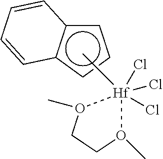

(Indenyl)₂HfCl₂ (480 mg, 1.0 mmol), HfCl₄ (352 mg, 1.1 mmol), and ~15 mL of anhydrous toluene were charged into a Schlenk flask. Under nitrogen, the reaction mixture was vigorously stirred for 16 hours at 100° C. The mixture was then cooled to room temperature and filtered. DME (~0.3 mL, 2.89 mmol) was added to the filtrate. The resulting mixture was evaporated; the residue was washed with a mixture of toluene/pentane and dried under vacuum to give the target product as a light-yellow solid (yield 64%). ¹H NMR (C₆D₆, 300 MHz): δ 7.57-7.61 (m, 2H), 7.08-7.11 (m, 2H), 6.62-6.65 (m, 1H), 6.52-6.56 (m, 2H), 3.12-3.55 (m, 10H).

### Example 23: Synthesis of (nBuCp)(1-allyl-indenyl)ZrCl₂ (Compound (VII-12))

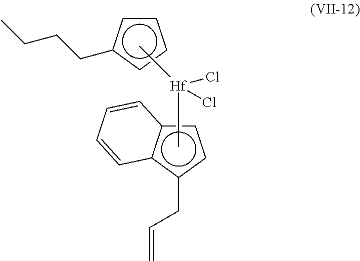

1-Allyl-indenyl-lithium (86 mg, 0.53 mmol, in ~5 mL of anhydrous THF) was added dropwise into a (nBuCp)ZrCl₃(DME) (204 mg, 0.50 mmol) solution in anhydrous THF at room temperature. After stirring for 16 hours, the mixture was held under vacuum to give a yellow residue, which was then extracted using dichloromethane. After filtration, the filtrate was evaporated to almost dryness; the residue was then washed with a mixture of pentane and toluene and dried under high vacuum to give a light-yellow solid (67% yield). ¹H NMR (C₆D₆, 300 MHz): δ 7.44-7.48 (m, 1H), 7.13-7.15 (1H), 6.86-6.89 (m, 2H), 6.43 (d, J=3.3 Hz, 1H), 5.89-5.97 (m, 1H), 5.83-5.85 (m, 2H), 5.65 (q, J=2.9 Hz, 1H), 5.51 (q, J=2.4 Hz, 1H), 5.40 (q, J=2.4 Hz, 1H), 4.95-5.03 (m, 2H), 3.65-3.85 (m, 2H), 2.54 (triplet of doubles, J₁=8.1 Hz, J₂=2.1 Hz, 2H), 1.32-1.39 (m, 2H), 1.13-1.21 (m, 2H), 0.80 (t, J=7.2 Hz, 3H).

### Example 24. Synthesis of (PrCp)(1-allyl-indenyl)ZrCl₂ (Compound (VII-27))

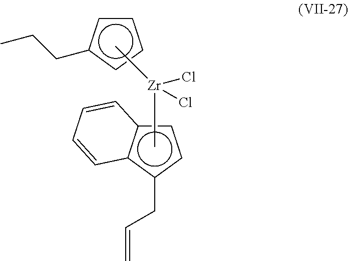

1-Allyl-indenyl-lithium (300 mg, 1.85 mmol, in ~5 mL of anhydrous THF) was added dropwise into a (PrCp)ZrCl₃(DME) (710 mg, 1.74 mmol) solution in THF at room temperature. After stirring for 16 hours, the mixture was held under vacuum to give a brown residue, which was then extracted using dichloromethane. After filtration, the filtrate was evaporated to almost dryness; the residue was then washed with a mixture of pentane and toluene, and dried under high vacuum to give a yellow solid (82% yield). ¹H NMR (C₆D₆, 300 MHz): δ 7.42-7.47 (m, 1H), 7.13-7.15 (1H), 6.86-6.89 (m, 2H), 6.43 (d, J=3.2 Hz, 1H), 5.86-6.02 (m, 1H), 5.81-5.83 (m, 2H), 5.63 (q, J=2.9 Hz, 1H), 5.49 (q, J=2.4 Hz, 1H), 5.39 (q, J=2.5 Hz, 1H), 4.96-5.03 (m, 2H), 3.66-3.74 (m, 2H), 2.47-2.52 (m, 2H), 1.34-1.39 (m, 2H), 0.76 (t, J=7.3 Hz, 3H).

### Example 25. Synthesis of (PrCp)(1-allyl-indenyl)HfCl₂ (Compound (VII-28))

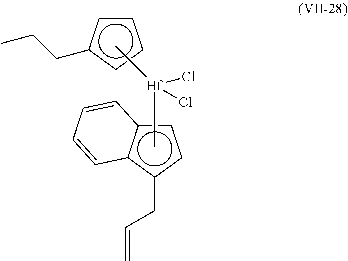

1-Allyl-indenyl-lithium (0.43 mg, 2.65 mmol, in ~10 mL of anhydrous THF) was added dropwise into a (PrCp)HfCl₃(DME) (1.21 g, 2.50 mmol) solution in THF at room temperature. After stirring for 16 hours, the mixture was held under vacuum to give a yellow residue, which was then extracted using dichloromethane. After filtration, the filtrate was evaporated to almost dryness; the residue was then washed with a mixture of pentane and toluene, and dried under high vacuum to give a yellow solid (74% yield). ¹H NMR (C₆D₆, 300 MHz): δ 7.40-7.43 (m, 1H), 7.15-7.17 (m, 1H), 6.84-6.88 (m, 2H), 6.41 (d, J=3.2 Hz, 1H), 5.88-5.99 (m, 1H), 5.71-5.73 (m, 2H), 5.54 (q, J=2.9 Hz, 1H), 5.39 (q, J=2.4 Hz, 1H), 5.31 (q, J=2.4 Hz, 1H), 4.96-5.02 (m, 2H), 3.70-3.73 (m, 2H), 2.52-2.57 (m, 2H), 1.34-1.42 (m, 2H), 0.77 (t, J=7.3 Hz, 3H).

### Example 26: Synthesis of (nBuCp)(fluorenyl)ZrCl₂ (Compound (VII-183))

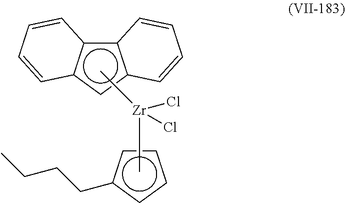

n-Butyllithium (nBuLi, 294 μL, 0.735 mmol, 2.5 M in hexanes) was added into a solution of fluorene (0.122 g, 0.734 mmol) in 6 mL of Et₂O. The resulting orange solution was stirred for 10 minutes and then added into a solution of (nBuCp)ZrCl₃(DME) (0.298 g, 0.729 mmol) in 10 mL of Et₂O. After stirring for 1 hour, all volatiles were removed in vacuo. The resulting residue was extracted with 10-20 mL of toluene and filtered; the filtrate was evaporated to give the target product as a yellow solid (67%). ¹H NMR (CDCl₃, 700 MHz): δ 8.13 (d, J=7.0 Hz, 2H), 7.57 (d, J=7.0 Hz, 2H), 7.41 (m, 4H), 6.50 (s, 1H), 5.92 (t, J=2.8 Hz, 2H), 5.79 (t, J=2.8 Hz, 2H), 2.40 (t, J=7.0 Hz, 2H), 1.41 (m, 2H), 1.26 (m, 2H), 0.85 (t, J=7.0 Hz, 3H).

### Example 27: Synthesis of (nBuCp)(9-Me-fluorenyl)ZrCl₂ (Compound (VII-185))

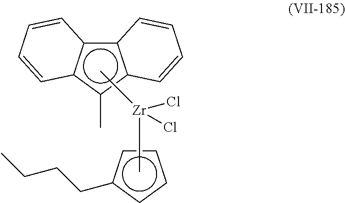

nBuLi (215 μL, 0.538 mmol, 2.5 M in hexanes) was added into a solution of 9-Me-fluorene (97 mg, 0.538 mmol) in 3 mL of Et₂O. The resulting orange solution was stirred for 10 minutes and then added into a solution of (nBuCp)ZrCl₃(DME) (0.220 g, 0.538 mmol) in 10 mL of Et₂O. After stirring for 1 hour, all volatiles were removed in vacuo. The resulting residue was extracted with 10 mL of toluene and filtered; the filtrate was evaporated to give the target product as a yellow solid (53%). ¹H NMR (CDCl₃, 700 MHz): δ 8.11 (d, J=7.0 Hz, 2H), 7.67 (d, J=7.0 Hz, 2H), 7.45 (m, 2H), 7.31 (m, 2H), 5.71 (t, J=2.8 Hz, 2H), 5.38 (t, J=2.8 Hz, 2H), 2.67 (s, 3H), 2.32 (t, J=7.0 Hz, 2H), 1.35 (m, 2H), 1.22 (m, 2H), 0.83 (t, J=7.0 Hz, 3H).

### Example 28: Synthesis of (nBuCp)(2,7-Me₂-fluorenyl)ZrCl₂ (Compound (VII-187))

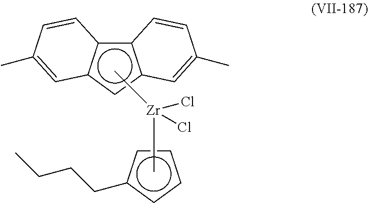

nBuLi (173 μL, 0.433 mmol, 2.5 M in hexanes) was added into a solution of 2,7-Me₂-fluorene (84 mg, 0.428 mmol) in 3 mL of Et₂O. The resulting orange solution was stirred for 10 minutes and then added into a solution of (nBuCp)ZrCl₃(DME) (0.175 g, 0.428 mmol) in 10 mL of Et₂O. After stirring for 1 hour, all volatiles were removed in vacuo. The resulting residue was extracted with 10 mL of toluene and filtered; the filtrate was evaporated to give the target product as a yellow solid (56%). ¹H NMR (CDCl₃, 700 MHz): δ 7.97 (d, J=7.0 Hz, 2H), 7.24-7.29 (m, 4H), 6.30 (s, 1H), 5.92 (t, J=2.8 Hz, 2H), 5.77 (t, J=2.8 Hz, 2H), 2.47 (s, 6H), 2.38 (t, J=7.0 Hz, 2H), 1.41 (m, 2H), 1.26 (m, 2H), 0.86 (t, J=7.0 Hz, 3H).

### Example 29: Synthesis of (nBuCp)(3,6-Me₂-fluorenyl)ZrCl₂ (Compound (VII-189))

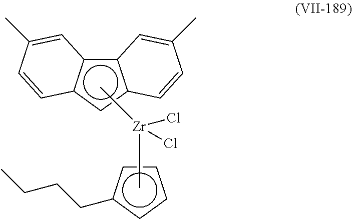

nBuLi (156 μL, 0.390 mmol, 2.5 M in hexanes) was added into a solution of 3,6-Me₂-fluorene (76 mg, 0.391 mmol) in 3 mL of Et₂O. The resulting orange solution was stirred for 10 minutes and then added into a solution of (nBuCp)ZrCl₃(DME) (0.159 g, 0.391 mmol) in 10 mL of Et₂O. After stirring for 1 hour, all volatiles were removed in vacuo. The resulting residue was extracted with 10 mL of toluene and filtered; the filtrate was evaporated to give the target product as a yellow solid (60%). ¹H NMR (CDCl₃, 700 MHz): δ 7.85 (s, 1H), 7.43 (d, J=7.0 Hz, 2H), 7.22 (d, J=7.0 Hz, 2H), 6.38 (s, 1H), 5.91 (t, J=2.8 Hz, 2H), 5.80 (t, J=2.8 Hz, 2H), 2.54 (s, 6H), 2.39 (t, J=7.0 Hz, 2H), 1.41 (m, 2H), 1.26 (m, 2H), 0.86 (t, J=7.0 Hz, 3H).

### Example 30: Synthesis of (nBuCp)(4,5-Me₂-fluorenyl)ZrCl₂ (Compound (VII-191))

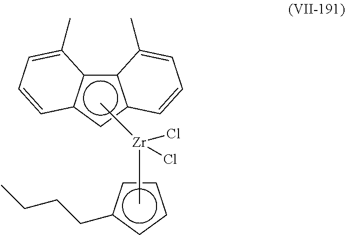

nBuLi (103 μL, 0.258 mmol, 2.5 M in hexanes) was added into a solution of 4,5-Me₂-fluorene (50 mg, 0.260 mmol) in 3 mL of Et₂O. The resulting orange solution was stirred for 10 minutes and then added into a solution of (nBuCp)ZrCl₃(DME) (0.105 g, 0.257 mmol) in 10 mL of Et₂O. After stirring for 1 hour, all volatiles were removed in vacuo. The resulting residue was extracted with 15 mL of toluene and filtered; the filtrate was evaporated to give the target product as an orange solid (30%). ¹H NMR (CDCl₃, 700 MHz): δ 7.41 (d, J=7.0 Hz, 2H), 7.23-7.25 (m, 4H), 6.56 (s, 1H), 5.91 (t, J=2.8 Hz, 2H), 5.86 (t, J=2.8 Hz, 2H), 2.98 (s, 6H), 2.42 (t, J=7.0 Hz, 2H), 1.42 (m, 2H), 1.27 (m, 2H), 0.86 (t, J=7.0 Hz, 3H).

### Example 31: Synthesis of (nBuCp)ZrCl₃(1,3-dimethoxypropane) ((Compound (II-33)) (Prophetic)

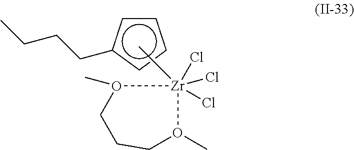

(nBuCp)₂ZrCl₂ (405 mg, 1.0 mmol), ZrCl₄ (256 mg, 1.1 mmol), and about 15 mL of anhydrous toluene are charged into a Schlenk flask. Under nitrogen, the reaction mixture is vigorously stirred for 16 hours at 100° C. The reaction mixture is then cooled to room temperature and filtered. 1,3-Dimethoxypropane (about 0.3 mL, 2.8 mmol) is added to the filtrate. The resulting mixture is evaporated. The residue is washed with a mixture of toluene/pentane and dried under vacuum to give the target product (nBuCp)ZrCl₃(1,3-dimethoxypropane) (Compound (II-33)) (expected yield 70-95%).

### Example 32: Synthesis of (1-nPentyl-indenyl)ZrCl₃(DME) ((Compound (II-37)) (Prophetic)

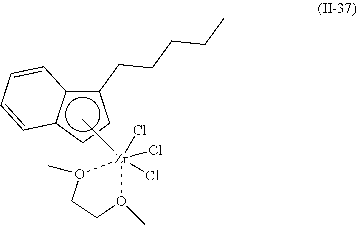

(1-nPentyl-indenyl)₂ZrCl₂ (537 mg, 1.0 mmol), ZrCl₄ (256 mg, 1.1 mmol), and about 15 mL of anhydrous toluene are charged into a Schlenk flask. Under nitrogen, the reaction mixture is vigorously stirred for 16 hours at 100° C. The reaction mixture is then cooled to room temperature and filtered. DME (about 0.3 mL, 2.89 mmol) is added to the filtrate. The resulting mixture is evaporated. The residue is washed with a mixture of toluene/pentane and dried under vacuum to give the target product (1-nPentyl-indenyl)ZrCl₃(DME) (Compound (II-37)) (expected yield 70-95%).

### Example 33: Synthesis of (fluorenyl)ZrCl₃(DME) ((Compound (II-21)) (Prophetic)

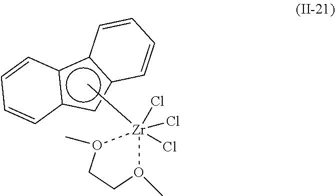

(Fluorenyl)₂ZrCl₂ (493 mg, 1.0 mmol), ZrCl₄ (256 mg, 1.1 mmol), and about 15 mL of anhydrous toluene are charged into a Schlenk flask. Under nitrogen, the reaction mixture is vigorously stirred for 16 hours at 100° C. The reaction mixture is then cooled to room temperature and filtered. DME (about 0.3 mL, 2.89 mmol) is added to the filtrate. The resulting mixture is evaporated. The residue is washed with a mixture of toluene/pentane and dried under vacuum to give the target product (fluorenyl)ZrCl₃(DME) (Compound (II-21)) (expected yield 70-95%).

### Example 34: Synthesis of (fluorenyl)ZrCl₃(DME) ((Compound (II-22)) (Prophetic)

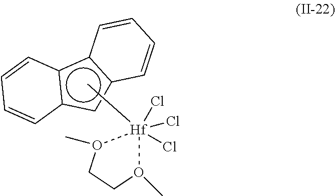

(Fluorenyl)₂HfCl₂ (580 mg, 1.0 mmol), HfCl₄ (352 mg, 1.1 mmol), and about 15 mL of anhydrous toluene are charged into a Schlenk flask. Under nitrogen, the reaction mixture is vigorously stirred for 16 hours at 100° C. The reaction mixture is then cooled to room temperature and filtered. DME (about 0.3 mL, 2.89 mmol) is added to the filtrate. The resulting mixture is evaporated. The residue is washed with a mixture of toluene/pentane and dried under vacuum to give the target product (fluorenyl) HfCl₃(DME) (Compound (II-22)) (expected yield 70-95%).

Aspects of the present disclosure generally relate to new methods of synthesizing monocyclopentadienyl, monoindenyl, and monofluorenyl metallocene compounds. Overall the examples indicate that aspects described herein may be utilized to form such mono-Cp metallocene compounds represented by formula (II). Advantageously, relative to conventional technologies such as sublimation, methods of the present disclosure are solution-based methods that allow for scale-up to industrial production levels with uncomplicated protocols. In addition, the examples indicate that aspects described herein are more selective than conventional methods using alkali metal compounds. Further, use of the donor molecule may mitigate, or may be configured to mitigate, the formation of oligomers and byproducts from decomposition typically observed with conventional methods. In addition the donor molecule converts oligomers of formula (III) into the mono-Cp metallocene compound represented by formula (II). Compared to conventional processes, the improved methods described herein are, for example, more efficient and easier to implement, and give the target product (mono-Cp metallocene compound) in high yield and purity. These mono-Cp metallocene compounds may be utilized, for example, in the synthesis of unbridged asymmetric metallocene compounds as described herein.

### Aspects of the Disclosure

The present disclosure provides, among others, the following aspects, each of which may be considered as optionally including any alternate aspects:

Aspect 1. A method of synthesizing a metallocene compound, the method comprising:
reacting a first mixture comprising a bis-Cp metallocene compound represented by formula (I), a metal salt, and a solvent to form a reaction product mixture comprising a liquid component and an optional solid component, the bis-Cp metallocene compound represented by formula (I) is:

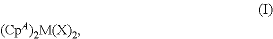

wherein: M of formula (I) is a Group 4 metal, such as Ti, Zr, or Hf; Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; and each X of formula (I) is, independently, a monoanionic ligand, such as halogen (such as F, Cl, Br, or I), H (hydride), unsubstituted hydrocarbyl, substituted hydrocarbyl, or a functional group comprising at least one element from Group 13-16 of the periodic table of the elements; and
reacting a second mixture comprising the liquid component of the reaction product mixture and a donor molecule to form a mono-Cp metallocene compound represented by formula (II):

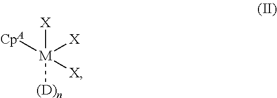

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, a monoanionic ligand, such as halogen (such as F, Cl, Br, or I), H (hydride), unsubstituted hydrocarbyl, substituted hydrocarbyl, or a functional group comprising at least one element from Group 13-16 of the periodic table of the elements; each D of formula (II) is, independently, a monodentate donor ligand or a bidentate donor ligand; D and X of formula (II) are different; and n of formula (II) is a number greater than 0 (including non-integers), such as from greater than 0 to 2 or less, such as 1 or 2, a number less than 1, or a number between 1 and 2.

Aspect 2. The method according to Aspect 1, wherein the reaction product mixture comprises the optional solid component, and the method further comprises: separating the liquid component of the reaction product mixture from the optional solid component of the reaction product mixture prior to the reacting the second mixture.

Aspect 3. The method according to Aspect 2, wherein the separating the liquid component of the reaction product mixture from the optional solid component of the reaction product mixture comprises: performing a solid-liquid separation on the reaction product mixture, the solid-liquid separation comprising any suitable solid liquid separation technique, such as filtration, vacuum filtration, centrifugation, decantation, decanting centrifugation, or combinations thereof.

Aspect 4. The method according to any one of the preceding Aspects, wherein the Group 4 metal (M) is Zr, Hf, or Ti, such as Zr or Hf.

Aspect 5. The method according to any one of the preceding Aspects, wherein Cp^{A} is represented by formula (IV), formula (V), or formula (VI):

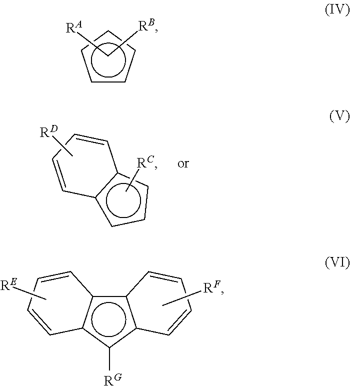

wherein: R^{A} and R^{B} are substituents on the 1, 2, 3, 4, and 5 positions of the cyclopentadienyl group; R^{C} is a substituent on the 1, 2, and 3 positions of the indenyl group; R^{D} is a substituent on the 4, 5, 6, and 7 positions of the indenyl group; R^{E} is a substituent on the 1, 2, 3, and 4 positions of the fluorenyl group; R^{F} is a substituent on the 5, 6, 7, and 8 positions of the fluorenyl group; R^{G} is a substituent on the 9 position of the fluorenyl group; and each of R^{A}, R^{B}, R^{C}, R^{D}, R^{E}, R^{F}, and R^{G} of formulas (IV)-(VI) is, independently, hydrogen, a C1-C18 unsubstituted hydrocarbyl, a C1-C18 substituted hydrocarbyl, halogen (such as F, Cl, Br, or I), or a functional group comprising at least one element from Group 13-16 of the periodic table of the elements, such as hydrogen or C1-C18 unsubstituted hydrocarbyl (for example, a C1-C12 unsubstituted hydrocarbyl, such as a C1-C8 unsubstituted hydrocarbyl, such as a C1-C6 unsubstituted hydrocarbyl, such as n-butyl or t-butyl).

Aspect 6. The method according to any one of the preceding Aspects, wherein: Cp^{A} is an unsubstituted cyclopentadienyl group, an unsubstituted indenyl group, an unsubstituted fluorenyl group, a monosubstituted cyclopentadienyl group, a monosubstituted indenyl group, a monosubstituted fluorenyl group, a disubstituted cyclopentadienyl group, a disubstituted indenyl group, or a disubstituted fluorenyl group.

Aspect 7. The method according to any one of the preceding Aspects, wherein the reacting the first mixture comprising the bis-Cp metallocene compound represented by formula (I), the metal salt, and the solvent to form the reaction product mixture is performed under first reaction conditions, the first reaction conditions comprising: a reaction temperature in a range from about 60° C. to about 140° C., such as from about 70° C. to about 130° C., such as from about 80° C. to about 120° C., such as from about 90° C. to about 110° C., such as from about 95° C. to about 105° C., such as from about 100° C. to 105° C., or from about 100° C. to about 110° C.; a reaction period in a range from about 1 hour to about 48 hours, such as from about 3 hours to about 36 hours, such as from about 5 hours to about 20 hours; or a combination thereof.

Aspect 8. The method according to any one of the preceding Aspects, wherein the metal salt comprises a halide of a Group 4 metal, such as ZrCl₄, HfCl₄, ZrBr₄, HfBr₄, or combinations thereof.

Aspect 9. The method according to any one of the preceding Aspects, wherein a molar ratio of the metal salt to the bis-Cp metallocene compound represented by formula (I) in the first mixture is in a range from about 0.7:1 to about 1.5:1, such as from about 0.8:1 to about 1.4:1, such as from about 0.9:1 to about 1.3:1, such as from about 1.1:1 to about 1:1 (metal salt:bis-Cp metallocene compound represented by formula (I)).

Aspect 10. The method according to any one of the preceding Aspects, wherein: the solvent comprises a non-coordinating solvent with a boiling point in a range from about 80° C. to about 180° C., such as a non-coordinating solvent with a boiling point in a range from about 80° C. to about 150° C.; and/or the solvent comprises heptane, octane, nonane, decane, toluene, ethylbenzene, o-xylene, m-xylene, p-xylene, or combinations thereof.

Aspect 11. The method according to any one of the preceding Aspects, wherein the liquid component of the reaction product mixture comprises a metallocene compound represented by formula (III):

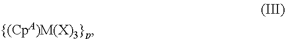

wherein: M of formula (III) is the Group 4 metal; each X of formula (III) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; Cp^{A} of formula (III) is the unsubstituted cyclopentadienyl group, the substituted cyclopentadienyl group, the unsubstituted indenyl group, the substituted indenyl group, the unsubstituted fluorenyl group, or the substituted fluorenyl group; and p of formula (III) is 1 or more, such as 1, 2, 3, 4, 5, etc.

Aspect 12. The method according to Aspect 11, wherein the metallocene compound represented by formula (III) is soluble in the solvent present in the liquid component.

Aspect 13. The method according to any one of the preceding Aspects, wherein the reacting the second mixture comprising the liquid component of the reaction product mixture and the donor molecule to form the mono-Cp metallocene compound represented by formula (II) comprises: contacting the donor molecule with a metallocene compound represented by formula (III): {(Cp^{A})M(X)₃}ₚ (III).

Aspect 14. The method according to any one of the preceding Aspects, wherein the reacting the second mixture comprising the liquid component of the reaction product mixture and the donor molecule to form the mono-Cp metallocene compound represented by formula (II) is performed under second reaction conditions, the second reaction conditions comprising: a reaction temperature in a range from about −20° C. to about 100° C., such as from about 0° C. to about 70° C., such as from about 10° C. to about 50° C., such as from about 15° C. to about 40° C., such as from about 20° C. to about 30° C.; a reaction period in a range from about 1 min to about 24 hours; or a combination thereof.

Aspect 15. The method according to any one of the preceding Aspects, wherein an amount of the donor molecule in the second mixture is based on an amount of the bis-Cp metallocene compound represented by formula (I) in the first mixture, a molar ratio of the donor molecule to the bis-Cp metallocene compound represented by formula (I) is from about 1:1 to about 10:1, such as from about 2:1 to about 8:1, such as from about 2.5:1 to about 7:1, such as from about 2.8:1 to about 6:1, or from about 1:1 to about 20:1, such as from about 2:1 to about 20:1, such as from about 2.3:1 to about 10:1, such as from about 2.5:1 to about 6.5:1 (donor molecule:bis-Cp metallocene compound represented by formula (I)).

Aspect 16. The method according to any one of the preceding Aspects, wherein: (a) the donor molecule coordinates to M of formula (II) as the donor ligand (D); (b) the donor molecule comprises at least one heteroatom or heteroatom-containing group, such as one or more elements from Group 13-16 of the periodic table of the elements; or (c) a combination thereof.

Aspect 17. The method according to any one of the preceding Aspects, wherein the donor molecule comprises a donor molecule represented by one or more of formulas (D-1)-(D-20):

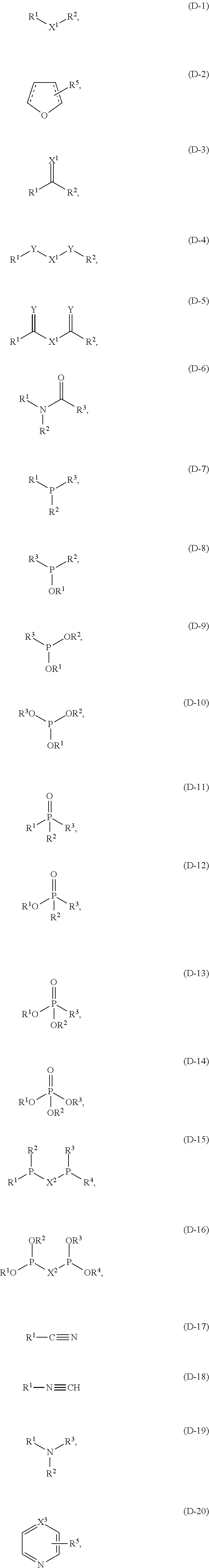

or combinations thereof,
wherein: each of R¹, R², R³, R⁴, and R⁵ of formulas (D-1)-(D-20) is, independently, hydrogen, a C1-C18 unsubstituted hydrocarbyl, such as a C1-C12 unsubstituted hydrocarbyl, such as a C1-C10 unsubstituted hydrocarbyl, such as a C1-C10 alkyl, alkenyl, or aryl, such as methyl, ethyl, propyl, butyl, pentyl, hexyl, heptyl, octyl, nonyl, decyl, 2-propen-1-yl, 3-buten-1-yl, 4-penten-1-yl, 5-hexen-1-yl, 6-hepten-1-yl, 7-octen-1-yl, 8-nonen-1-yl, 9-decen-lyl, phenyl, benzyl, naphthyl, or an isomer thereof, or two or more of R¹, R², R³, R⁴, or R⁵ join together to form a monocyclic or polycyclic ring structure; each X¹ of formulas (D-1)-(D-20) is, independently, O, S, (CH₂)ₙ, or Si; each X² of formulas (D-1)-(D-20) is (CH₂)ₙ or phenylene; each X³ of formulas (D-1)-(D-20) is, independently, C or N; each Y of formulas (D-1)-(D-20) is, independently, O or S; and each n of formulas (D-1)-(D-20) is, independently, from 1 to 4.

Aspect 18. The method according to any one of the preceding Aspects, wherein the donor molecule comprises an alkylether, an arylether, a cyclic ether, a ketone, a glyme, or combinations thereof.

Aspect 19. The method according to Aspect 18, wherein the donor molecule comprises the alkylether, the alkylether comprising dimethyl ether, diethyl ether, methyl ethyl ether, methyl propyl ether, ethyl propyl ether, di-n-propyl ether, methyl butyl ether, ethyl butyl ether, di-n-butyl ether, methyl isopropyl ether, isomers thereof, or combinations thereof.

Aspect 20. The method according to any one of Aspects 18-19, wherein the donor molecule comprises the arylether, the arylether comprising anisole (methoxybenzene), phenyl ethyl ether, phenyl propyl ether, diphenyl ether, phenyl isopropyl ether, phenyl butyl ether, phenyl tert-butyl ether, phenyl pentyl ether, phenyl hexyl ether, phenyl heptyl ether, isomers thereof, or combinations thereof.

Aspect 21. The method according to any one of Aspects 18-20, wherein the donor molecule comprises the cyclic ether, the cyclic ether comprising tetrahydrofuran, dioxane, tetrahydropyran, 1,3-dioxane, 1,4-dioxane, furan, 2,5-dihydrofuran, pyran, 2H-pyran, 3,4-dihydro-2H-pyran, isomers thereof, or combinations thereof.

Aspect 22. The method according to any one of Aspects 18-21, wherein the donor molecule comprises the ketone, the ketone comprising methyl ethyl ketone, diethyl ketone, methyl isobutyl ketone, methyl n-propyl ketone, diisobutyl ketone, cyclohexanone, 2-pentanone, 3-pentanone, 2-hexanone, 3-hexanone, 4-methyl-2-pentanone, 2-heptanone, 3-heptanone, 4-heptanone, isomers thereof, or combinations thereof.

Aspect 23. The method according to any one of Aspects 18-22, wherein the donor molecule comprises the glyme, the glyme comprising 1,3-dimethoxypropane, 1-(2-methoxyethoxy) butane, 1,3-diethoxypropane, 1,2-dimethoxyethane, dimethoxymethane, 1-ethoxy-2-methoxyethane, 4,7-dioxadecane, 1-butoxy-2-ethoxyethane, ethylene glycol diethyl ether, glycol dibutyl ether, 1,1-dimethoxyethane, diethoxymethane, 2,2-dimethoxypropane, 1,2,3-trimethoxypropane, diglyme, trimethyl orthoformate, 2-(2-methoxyethoxy)-2-methylpropane, isomers thereof, or combinations thereof.

Aspect 24. The method according to any one of the preceding Aspects, wherein D of formula (II) is neutral, monoanionic, or dianionic.

Aspect 25. The method according to any one of the preceding Aspects, wherein X, D, and n of formula (II) are chosen such that the mono-Cp metallocene compound represented by formula (II) is, overall, neutral.

Aspect 26. The method according to any one of the preceding Aspects, wherein each D of formula (II) are monodentate donor ligands.

Aspect 27. The method according to Aspect 26, wherein each monodentate donor ligand (D) is the same or different monodentate donor ligand, such as the same monodentate donor ligand.

Aspect 28. The method according to any one of the preceding Aspects, wherein the donor molecule comprises dimethyl ether, diethyl ether, acetone, diethyl ketone, tetrahydrofuran, 1,2-dimethoxyethane, 1,3-dimethoxypropane, or combinations thereof.

Aspect 29. The method according to any one of the preceding Aspects, wherein the mono-Cp metallocene compound represented by formula (II) comprises a mono-Cp metallocene compound represented by one or more of formulas (II-A)-(II-C):

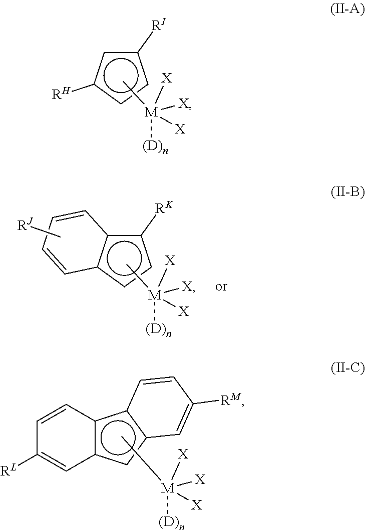

wherein: each of R^{H}, R^{I}, R^{J}, R^{K}, R^{L}, and R^{M} of formulas (II-A)-(II-C) is, independently, hydrogen or C1-C10 unsubstituted hydrocarbyl, such as C1-C10 alkyl, alkenyl, or aryl, such as methyl, ethyl, propyl, butyl, pentyl, hexyl, heptyl, octyl, nonyl, decyl, 2-propen-1-yl, 3-buten-1-yl, 4-penten-1-yl, 5-hexen-1-yl, 6-hepten-1-yl, 7-octen-1-yl, 8-nonen-1-yl, 9-decen-1yl, phenyl, benzyl, naphthyl, or an isomer thereof; each X of formulas (II-A)-(II-C) is, independently, a halide, such as F, Cl, Br, or I; each D of formulas (II-A)-(II-C) is, independently, a monodentate donor ligand or a bidentate donor ligand; D and X of formulas (II-A)-(II-C) are different; and n of formulas (II-A)-(II-C) is a number greater than 0 (including non-integers), such as from greater than 0 to 2 or less, such as 1 or 2, a number less than 1, or a number between 1 and 2.

Aspect 30. The method according to Aspect 28, wherein: each of R^{H}, R^{I}, R^{J}, R^{K}, R^{L}, and R^{M} of formulas (II-A)-(II-C) is, independently, hydrogen, methyl, ethyl, propyl, isopropyl, n-butyl, i-butyl, t-butyl, n-pentyl, i-pentyl, neo-pentyl, n-hexyl, CH₂═CHCH₂—, CH₂═CH(CH₂)₂—, phenyl, or Ph(CH₂)—.

Aspect 31. The method according to any one of the preceding Aspects, wherein the mono-Cp metallocene compound represented by formula (II) comprises one or more of mono-Cp metallocene compounds (II-1)-(II-44).

Aspect 32. The method according to any one of the preceding Aspects, wherein the donor molecule (or donor ligand) is configured to: stabilize the mono-Cp metallocene compound represented by formula (II); mitigate formation of oligomers ({(Cp^{A})(X)₃M}ₚ, P=2, 3, 4, etc.); mitigate decomposition of the mono-Cp metallocene compound represented by formula (II) to the metallocene compound represented by formula (III); mitigate formation of the metal salt and the bis-Cp metallocene compound represented by formula (I); or combinations thereof.

Aspect 33. The method according to any one of the preceding Aspects, wherein the donor molecule (or donor ligand) is configured to facilitate isolation, purification, or both, of the mono-Cp metallocene compound represented by formula (II).

Aspect 34. The method according to any one of the preceding Aspects, further comprising: isolating the mono-Cp metallocene compound represented by formula (II) from a second reaction product mixture formed from the reacting the second mixture, wherein the isolating the mono-Cp metallocene compound represented by formula (II) from the second reaction product mixture comprises: removing solvent from the second reaction product mixture; and then precipitating the mono-Cp metallocene compound represented by formula (II).

Aspect 35. The method according to any one of the preceding Aspects, further comprising:
contacting the mono-Cp metallocene compound represented by formula (II) with a complex of a Cp^{B} ligand to form an unbridged asymmetric metallocene compound represented by formula (VII):

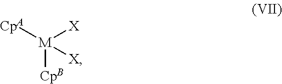

wherein: M of formula (VII) is the Group 4 metal, such as Ti, Zr, or Hf; each of Cp^{A} and Cp^{B} of formula (VII) are, independently, an unsubstituted cyclopentadienyl group, a substituted cyclopentadienyl group, an unsubstituted indenyl group, a substituted indenyl group, an unsubstituted fluorenyl group, or a substituted fluorenyl group; Cp^{A} and Cp^{B} of formula (VII) are different; each X of formula (VII) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; and each X of formula (VII) is different from D of formula (II).

Aspect 36. The method according to Aspect 35, wherein the unbridged asymmetric metallocene compound represented by formula (VII) comprises any suitable unbridged asymmetric metallocene compound described herein, for example, one or more of metallocene compounds (VII-1)-(VII-192).

Aspect 37. A method of synthesizing a metallocene compound, the method comprising:
reacting a first mixture comprising a bis-Cp metallocene compound represented by formula (I), a metal salt, and a solvent to form a reaction product mixture comprising a liquid component and a solid component, the bis-Cp metallocene compound represented by formula (I) is:

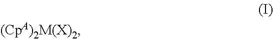

wherein: M of formula (I) is a Group 4 metal, such as Ti, Zr, or Hf; Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; each X of formula (I) is, independently, a monoanionic ligand, such as H (hydride), halogen (such as F, Cl, Br, or I), unsubstituted hydrocarbyl, substituted hydrocarbyl, or a functional group comprising at least one element from Group 13-16 of the periodic table of the elements;
separating the liquid component of the reaction product mixture from the solid component of the reaction product mixture; and
reacting a second mixture comprising the liquid component of the reaction product mixture and a donor molecule to form a mono-Cp metallocene compound represented by formula (II):

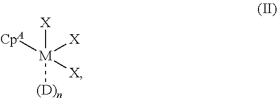

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, a monoanionic ligand, such as H (hydride), halogen (such as F, Cl, Br, or I), unsubstituted hydrocarbyl, substituted hydrocarbyl, or a functional group comprising at least one element from Group 13-16 of the periodic table of the elements; each D of formula (II) is, independently, a monodentate donor ligand or a bidentate donor ligand; D and X of formula (II) are different; and n of formula (II) is a number greater than 0 (including non-integers), such as from greater than 0 to 2 or less, such as 1 or 2, a number less than 1, or a number between 1 and 2.

Aspect 38. The method according to Aspect 37, wherein the separating the liquid component of the reaction product mixture from the solid component of the reaction product mixture comprises: performing a solid-liquid separation on the reaction product mixture, the solid-liquid separation comprising any suitable solid liquid separation technique, such as filtration, vacuum filtration, centrifugation, decantation, decanting centrifugation, or combinations thereof.

Aspect 39. The method according to any one Aspects 37-38, wherein the Group 4 metal (M) is Zr, Hf, or Ti, such as Zr or Hf.

Aspect 40. The method according to any one of Aspects 37-39, wherein Cp^{A} is represented by formula (IV), formula (V), or formula (VI).

Aspect 41. The method according to any one of Aspects 37-40, wherein: Cp^{A} is an unsubstituted cyclopentadienyl group, an unsubstituted indenyl group, an unsubstituted fluorenyl group, a monosubstituted cyclopentadienyl group, a monosubstituted indenyl group, a monosubstituted fluorenyl group, a disubstituted cyclopentadienyl group, a disubstituted indenyl group, or a disubstituted fluorenyl group.

Aspect 42. The method according to any one of Aspects 37-41, wherein the reacting the first mixture comprising the bis-Cp metallocene compound represented by formula (I), the metal salt, and the solvent to form the reaction product mixture is performed under first reaction conditions, the first reaction conditions comprising: a reaction temperature in a range from about 60° C. to about 140° C., such as from about 70° C. to about 130° C., such as from about 80° C. to about 120° C., such as from about 90° C. to about 110° C., such as from about 95° C. to about 105° C., such as from about 100° C. to 105° C., or from about 100° C. to about 110° C.; a reaction period in a range from about 1 hour to about 48 hours, such as from about 3 hours to about 36 hours, such as from about 5 hours to about 20 hours; or a combination thereof.

Aspect 43. The method according to any one of Aspects 37-42, wherein the metal salt comprises a halide of a Group 4 metal, such as ZrCl₄, HfCl₄, ZrBr₄, HfBr₄, or combinations thereof.

Aspect 44. The method according to any one of Aspects 37-43, wherein a molar ratio of the metal salt to the bis-Cp metallocene compound represented by formula (I) in the first mixture is in a range from about 0.7:1 to about 1.5:1, such as from about 0.8:1 to about 1.4:1, such as from about 0.9:1 to about 1.3:1, such as from about 1.1:1 to about 1:1 (metal salt:bis-Cp metallocene compound represented by formula (I)).

Aspect 45. The method according to any one of Aspects 37-44, wherein: the solvent comprises a non-coordinating solvent with a boiling point in a range from about 80° C. to about 180° C., such as a non-coordinating solvent with a boiling point in a range from about 80° C. to about 150° C.; and/or the solvent comprises heptane, octane, nonane, decane, toluene, ethylbenzene, o-xylene, m-xylene, p-xylene, or combinations thereof.

Aspect 46. The method according to any one of Aspects 37-45, wherein the liquid component of the reaction product mixture comprises a metallocene compound represented by formula (III):

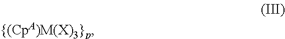

wherein: M of formula (III) is the Group 4 metal; each X of formula (III) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; Cp^{A} of formula (III) is the unsubstituted cyclopentadienyl group, the substituted cyclopentadienyl group, the unsubstituted indenyl group, the substituted indenyl group, the unsubstituted fluorenyl group, or the substituted fluorenyl group; and p of formula (III) is 1 or more, such as 1, 2, 3, 4, 5, etc.

Aspect 47. The method according to Aspect 46, wherein the metallocene compound represented by formula (III) is soluble in the solvent present in the liquid component.

Aspect 48. The method according to any one of Aspects 37-47, wherein the reacting the second mixture comprising the liquid component of the reaction product mixture and the donor molecule to form the mono-Cp metallocene compound represented by formula (II) comprises: contacting the donor molecule with a metallocene compound represented by formula (III): {(Cp^{A})M(X)₃}ₚ (III).

Aspect 49. The method according to any one of Aspects 37-48, wherein the reacting the second mixture comprising the liquid component of the reaction product mixture and the donor molecule to form the mono-Cp metallocene compound represented by formula (II) is performed under second reaction conditions, the second reaction conditions comprising: a reaction temperature in a range from about −20° C. to about 100° C., such as from about 0° C. to about 70° C., such as from about 10° C. to about 50° C., such as from about 15° C. to about 40° C., such as from about 20° C. to about 30° C.; a reaction period in a range from about 1 min to about 24 hours; or a combination thereof.

Aspect 50. The method according to any one of Aspects 37-49, wherein an amount of the donor molecule in the second mixture is based on an amount of the bis-Cp metallocene compound represented by formula (I) in the first mixture, a molar ratio of the donor molecule to the bis-Cp metallocene compound represented by formula (I) is from about 1:1 to about 10:1, such as from about 2:1 to about 8:1, such as from about 2.5:1 to about 7:1, such as from about 2.8:1 to about 6:1, or from about 1:1 to about 20:1, such as from about 2:1 to about 20:1, such as from about 2.3:1 to about 10:1, such as from about 2.5:1 to about 6.5:1 (donor molecule:bis-Cp metallocene compound represented by formula (I)).

Aspect 51. The method according to any one of Aspects 37-50, wherein: (a) the donor molecule coordinates to M of formula (II) as the donor ligand (D); (b) the donor molecule comprises at least one heteroatom or heteroatom-containing group, such as one or more elements from Group 13-16 of the periodic table of the elements, such as a donor molecule represented by one or more of formulas (D-1)-(D-20); or (c) a combination thereof.

Aspect 52. The method according to any one of Aspects 37-51, wherein the donor molecule comprises an alkylether, an arylether, a cyclic ether, a ketone, a glyme, or combinations thereof.

Aspect 53. The method according to Aspect 52, wherein the donor molecule comprises the alkylether, the alkylether comprising dimethyl ether, diethyl ether, methyl ethyl ether, methyl propyl ether, ethyl propyl ether, di-n-propyl ether, methyl butyl ether, ethyl butyl ether, di-n-butyl ether, methyl isopropyl ether, isomers thereof, or combinations thereof.

Aspect 54. The method according to any one of Aspects 52-53, wherein the donor molecule comprises the arylether, the arylether comprising anisole (methoxybenzene), phenyl ethyl ether, phenyl propyl ether, diphenyl ether, phenyl isopropyl ether, phenyl butyl ether, phenyl tert-butyl ether, phenyl pentyl ether, phenyl hexyl ether, phenyl heptyl ether, isomers thereof, or combinations thereof.

Aspect 55. The method according to any one of Aspects 52-54, wherein the donor molecule comprises the cyclic ether, the cyclic ether comprising tetrahydrofuran, dioxane, tetrahydropyran, 1,3-dioxane, 1,4-dioxane, furan, 2,5-dihydrofuran, pyran, 2H-pyran, 3,4-dihydro-2H-pyran, isomers thereof, or combinations thereof.

Aspect 56. The method according to any one of Aspects 52-55, wherein the donor molecule comprises the ketone, the ketone comprising methyl ethyl ketone, diethyl ketone, methyl isobutyl ketone, methyl n-propyl ketone, diisobutyl ketone, cyclohexanone, 2-pentanone, 3-pentanone, 2-hexanone, 3-hexanone, 4-methyl-2-pentanone, 2-heptanone, 3-heptanone, 4-heptanone, isomers thereof, or combinations thereof.

Aspect 57. The method according to any one of Aspects 52-56, wherein the donor molecule comprises the glyme, the glyme comprising 1,3-dimethoxypropane, 1-(2-methoxyethoxy) butane, 1,3-diethoxypropane, 1,2-dimethoxyethane, dimethoxymethane, 1-ethoxy-2-methoxyethane, 4,7-dioxadecane, 1-butoxy-2-ethoxyethane, ethylene glycol diethyl ether, glycol dibutyl ether, 1,1-dimethoxyethane, diethoxymethane, 2,2-dimethoxypropane, 1,2,3-trimethoxypropane, diglyme, trimethyl orthoformate, 2-(2-methoxyethoxy)-2-methylpropane, isomers thereof, or combinations thereof.

Aspect 58. The method according to any one of Aspects 37-57, wherein D of formula (II) is neutral, monoanionic, or dianionic.

Aspect 59. The method according to any one of Aspects 37-58, wherein X, D, and n of formula (II) are chosen such that the mono-Cp metallocene compound represented by formula (II) is, overall, neutral.

Aspect 60. The method according to any one of Aspects 37-59, wherein each D of formula (II) are monodentate donor ligands.

Aspect 61. The method according to Aspect 60, wherein each monodentate donor ligand (D) is the same or different monodentate donor ligand, such as the same monodentate donor ligand.

Aspect 62. The method according to any one of Aspects 37-61, wherein the donor molecule comprises dimethyl ether, diethyl ether, acetone, diethyl ketone, tetrahydrofuran, 1,2-dimethoxyethane, 1,3-dimethoxypropane, or combinations thereof.

Aspect 63. The method according to any one of Aspects 37-62, wherein the mono-Cp metallocene compound represented by formula (II) comprises a metallocene compound represented by one or more of formulas (II-A)-(II-C).

Aspect 64. The method according to any one of Aspects 37-63, wherein the mono-Cp metallocene compound represented by formula (II) comprises one or more of metallocene compounds (II-1)-(II-44).

Aspect 65. The method according to any one of Aspects 37-64, wherein the donor molecule (or donor ligand) is configured to: stabilize the mono-Cp metallocene compound represented by formula (II); mitigate formation of oligomers ({(Cp^{A})(X)₃M}ₚ, p=2, 3, 4, etc.); mitigate decomposition of the mono-Cp metallocene compound represented by formula (II) to the metallocene compound represented by formula (III); mitigate formation of the metal salt and the bis-Cp metallocene compound represented by formula (I); or combinations thereof.

Aspect 66. The method according to any one of Aspects 37-65, wherein the donor molecule (or donor ligand) is configured to facilitate isolation, purification, or both, of the mono-Cp metallocene compound represented by formula (II).

Aspect 67. The method according to any one of Aspects 37-66, further comprising: isolating the mono-Cp metallocene compound represented by formula (II) from a second reaction product mixture formed from the reacting the second mixture, wherein the isolating the mono-Cp metallocene compound represented by formula (II) from the second reaction product mixture comprises: removing solvent from the second reaction product mixture; and then precipitating the mono-Cp metallocene compound represented by formula (II)

Aspect 68. The method according to any one of Aspects 37-67, further comprising:
contacting the mono-Cp metallocene compound represented by formula (II) with a complex of a Cp^{B} ligand to form an unbridged asymmetric metallocene compound represented by formula (VII):

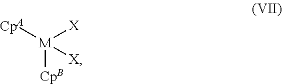

wherein: M of formula (VII) is the Group 4 metal, such as Ti, Zr, or Hf; each of Cp^{A} and Cp^{B} of formula (VII) are, independently, an unsubstituted cyclopentadienyl group, a substituted cyclopentadienyl group, an unsubstituted indenyl group, a substituted indenyl group, an unsubstituted fluorenyl group, or a substituted fluorenyl group; Cp^{A} and Cp^{B} of formula (VII) are different; each X of formula (VII) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; and each X of formula (VII) is different from D of formula (II).

Aspect 69. The method according to Aspect 68, wherein the unbridged asymmetric metallocene compound represented by formula (VII) comprises any suitable unbridged asymmetric metallocene compound described herein, for example, one or more of metallocene compounds (VII-1)-(VII-192).

Aspect 70. A method of synthesizing an unbridged asymmetric metallocene compound, the method comprising:
reacting a first mixture comprising a bis-Cp metallocene compound represented by formula (I), a metal salt, and a solvent to form a reaction product mixture comprising a liquid component and an optional solid component, the bis-metallocene compound represented by formula (I) is:

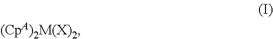

wherein: M of formula (I) is a Group 4 metal, such as Ti, Zr, or Hf, Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; each X of formula (I) is, independently, a monoanionic ligand, such as H (hydride), halogen (such as F, Cl, Br, or I), unsubstituted hydrocarbyl, substituted hydrocarbyl, or a functional group comprising at least one element from Group 13-16 of the periodic table of the elements;
reacting a second mixture comprising the liquid component of the reaction product mixture and a donor molecule to form a mono-Cp metallocene compound represented by formula (II):

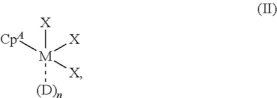

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, a monoanionic ligand, such as H (hydride), halogen (such as F, Cl, Br, or I), unsubstituted hydrocarbyl, substituted hydrocarbyl, or a functional group comprising at least one element from Group 13-16 of the periodic table of the elements; each D of formula (II) is, independently, a monodentate donor ligand or a bidentate donor ligand; D and X of formula (II) are different; and n of formula (II) is a number greater than 0 (including non-integers), such as from greater than 0 to 2 or less, such as 1 or 2, a number less than 1, or a number between 1 and 2; and
contacting the mono-Cp metallocene compound represented by formula (II) with a complex of a Cp^{B} ligand to form an unbridged asymmetric metallocene compound represented by formula (VII):

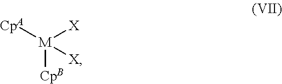

wherein: M of formula (VII) is the Group 4 metal; each of Cp^{A} and Cp^{B} of formula (VII) are, independently, an unsubstituted cyclopentadienyl group, a substituted cyclopentadienyl group, an unsubstituted indenyl group, a substituted indenyl group, an unsubstituted fluorenyl group, or a substituted fluorenyl group; Cp^{A} and Cp^{B} of formula (VII) are different; and each X of formula (VII) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; and each X of formula (VII) is different from D of formula (II).

Aspect 71. The method according to Aspect 70, wherein the reaction product mixture comprises the optional solid component, and the method further comprises: separating the liquid component of the reaction product mixture from the optional solid component of the reaction product mixture prior to the reacting the second mixture.

Aspect 72. The method according to Aspect 71, wherein the separating the liquid component of the reaction product mixture from the optional solid component of the reaction product mixture comprises: performing a solid-liquid separation on the reaction product mixture, the solid-liquid separation comprising any suitable solid liquid separation technique, such as filtration, vacuum filtration, centrifugation, decantation, decanting centrifugation, or combinations thereof.

Aspect 73. The method according to any one of Aspects 70-72, wherein the Group 4 metal (M) is Zr, Hf, or Ti, such as Zr or Hf.

Aspect 74. The method according to any one of Aspects 70-73, wherein Cp^{A} is represented by formula (IV), formula (V), or formula (VI).

Aspect 75. The method according to any one of Aspects 70-74, wherein: Cp^{A} is an unsubstituted cyclopentadienyl group, an unsubstituted indenyl group, an unsubstituted fluorenyl group, a monosubstituted cyclopentadienyl group, a monosubstituted indenyl group, a monosubstituted fluorenyl group, a disubstituted cyclopentadienyl group, a disubstituted indenyl group, or a disubstituted fluorenyl group.

Aspect 76. The method according to any one of Aspects 70-75, wherein the reacting the first mixture comprising the bis-Cp metallocene compound represented by formula (I), the metal salt, and the solvent to form the reaction product mixture is performed under first reaction conditions, the first reaction conditions comprising: a reaction temperature in a range from about 60° C. to about 140° C., such as from about 70° C. to about 130° C., such as from about 80° C. to about 120° C., such as from about 90° C. to about 110° C., such as from about 95° C. to about 105° C., such as from about 100° C. to 105° C., or from about 100° C. to about 110° C.; a reaction period in a range from about 1 hour to about 48 hours, such as from about 3 hours to about 36 hours, such as from about 5 hours to about 20 hours; or a combination thereof.

Aspect 77. The method according to any one of Aspects 70-76, wherein the metal salt comprises a halide of a Group 4 metal, such as ZrCl₄, HfCl₄, ZrBr₄, HfBr₄, or combinations thereof.

Aspect 78. The method according to any one of the preceding Aspects, wherein a molar ratio of the metal salt to the bis-Cp metallocene compound represented by formula (I) in the first mixture is in a range from about 0.7:1 to about 1.5:1, such as from about 0.8:1 to about 1.4:1, such as from about 0.9:1 to about 1.3:1, such as from about 1.1:1 to about 1:1 (metal salt:bis-Cp metallocene compound represented by formula (I)).

Aspect 79. The method according to any one of Aspects 70-78, wherein: the solvent comprises a non-coordinating solvent with a boiling point in a range from about 80° C. to about 180° C., such as a non-coordinating solvent with a boiling point in a range from about 80° C. to about 150° C.; and/or the solvent comprises heptane, octane, nonane, decane, toluene, ethylbenzene, o-xylene, m-xylene, p-xylene, or combinations thereof.

Aspect 80. The method according to any one of Aspects 70-79, wherein the liquid component of the reaction product mixture comprises a metallocene compound represented by formula (III):

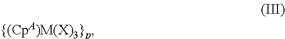

wherein: M of formula (III) is the Group 4 metal; each X of formula (III) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; Cp^{A} of formula (III) is the unsubstituted cyclopentadienyl group, the substituted cyclopentadienyl group, the unsubstituted indenyl group, the substituted indenyl group, the unsubstituted fluorenyl group, or the substituted fluorenyl group; and p of formula (III) is 1 or more, such as 1, 2, 3, 4, 5, etc.

Aspect 81. The method according to Aspect 80, wherein the metallocene compound represented by formula (III) is soluble in the solvent present in the liquid component of the reaction product mixture.

Aspect 82. The method according to any one of Aspects 70-81, wherein the reacting the second mixture comprising the liquid component of the reaction product mixture and the donor molecule to form the mono-Cp metallocene compound represented by formula (II) comprises: contacting the donor molecule with a metallocene compound represented by formula (III): {(Cp^{A})M(X)₃}ₚ (III).

Aspect 83. The method according to any one of Aspects 70-82, wherein the reacting the second mixture comprising the liquid component of the reaction product mixture and the donor molecule to form the mono-Cp metallocene compound represented by formula (II) is performed under second reaction conditions, the second reaction conditions comprising: a reaction temperature in a range from about −20° C. to about 100° C., such as from about 0° C. to about 70° C., such as from about 10° C. to about 50° C., such as from about 15° C. to about 40° C., such as from about 20° C. to about 30° C.; a reaction period in a range from about 1 min to about 24 hours; or a combination thereof.

Aspect 84. The method according to any one of Aspects 70-83, wherein an amount of the donor molecule in the second mixture is based on an amount of the bis-Cp metallocene compound represented by formula (I) in the first mixture, a molar ratio of the donor molecule to the bis-Cp metallocene compound represented by formula (I) is from about 1:1 to about 10:1, such as from about 2:1 to about 8:1, such as from about 2.5:1 to about 7:1, such as from about 2.8:1 to about 6:1, or from about 1:1 to about 20:1, such as from about 2:1 to about 20:1, such as from about 2.3:1 to about 10:1, such as from about 2.5:1 to about 6.5:1 (donor molecule:bis-Cp metallocene compound represented by formula (I)).

Aspect 85. The method according to any one of Aspects 70-84, wherein: (a) the donor molecule coordinates to M of formula (II) as the donor ligand (D); (b) the donor molecule comprises at least one heteroatom or heteroatom-containing group, such as one or more elements from Group 13-16 of the periodic table of the elements; or (c) a combination thereof.

Aspect 86. The method according to any one of Aspects 70-85, wherein the donor molecule comprises a donor molecule represented by one or more of formulas (D-1)-(D-20).

Aspect 87. The method according to any one of Aspects 70-86, wherein the donor molecule comprises an alkylether, an arylether, a cyclic ether, a ketone, a glyme, or combinations thereof, such as those alkylethers, arylethers, cyclic ethers, ketones, or glymes described herein with respect to the donor molecule.

Aspect 88. The method according to any one of Aspects 70-87, wherein D of formula (II) is neutral, monoanionic, or dianionic.

Aspect 89. The method according to any one of Aspects 70-88, wherein X, D, and n of formula (II) are chosen such that the mono-Cp metallocene compound represented by formula (II) is, overall, neutral.

Aspect 90. The method according to any one of Aspects 70-89, wherein each D of formula (II) are monodentate donor ligands.

Aspect 91. The method according to Aspect 90, wherein each monodentate donor ligand (D) is the same or different monodentate donor ligand, such as the same monodentate donor ligand.

Aspect 92. The method according to any one of Aspects 70-91, wherein the donor molecule comprises dimethyl ether, diethyl ether, acetone, diethyl ketone, tetrahydrofuran, 1,2-dimethoxyethane, 1,3-dimethoxypropane, or combinations thereof.

Aspect 93. The method according to any one of Aspects 70-92, wherein the mono-Cp metallocene compound represented by formula (II) comprises a metallocene compound represented by one or more of formulas (II-A)-(II-C).

Aspect 94. The method according to any one of Aspects 70-93, wherein the mono-Cp metallocene compound represented by formula (II) comprises one or more of metallocene compounds (II-1)-(II-44).

Aspect 95. The method according to any one of Aspects 70-93, further comprising: isolating the mono-Cp metallocene compound represented by formula (II) from a second reaction product mixture formed from the reacting the second mixture, wherein the isolating the mono-Cp metallocene compound represented by formula (II) from the second reaction product mixture comprises: removing solvent from the second reaction product mixture; and then precipitating the mono-Cp metallocene compound represented by formula (II).

Aspect 96. The method according to any one of Aspects 70-94, wherein the unbridged asymmetric metallocene compound represented by formula (VII) comprises any suitable unbridged asymmetric metallocene compound described herein, for example, one or more of metallocene compounds (VII-1)-(VII-192).

Aspect 97. A method of synthesizing a mono-Cp metallocene compound, the method comprising:
(a) reacting a first mixture comprising a bis-Cp metallocene compound represented by formula (I), a metal salt, and a first solvent to form a reaction product mixture comprising a liquid component and an optional solid component, the liquid component comprising the metallocene compound represented by formula (III), the bis-Cp metallocene compound represented by formula (I) is:

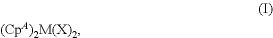

wherein: M of formula (I) is a Group 4 metal, such as Ti, Zr, or Hf; Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; and each X of formula (I) is, independently, a monoanionic ligand, such as halogen (such as F, Cl, Br, or I), H (hydride), unsubstituted hydrocarbyl, substituted hydrocarbyl, or a functional group comprising at least one element from Group 13-16 of the periodic table of the elements;
(b) isolating the metallocene compound represented by formula (III) from the reaction product mixture (for example, by filtration of the optional solid component followed by evaporation of volatiles such as the first solvent);
(c) reacting a second mixture comprising the metallocene compound represented by formula (III) and a donor molecule to form a reaction product mixture comprising a mono-Cp metallocene compound represented by formula (II):

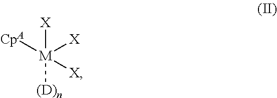

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, a monoanionic ligand, such as halogen (such as F, Cl, Br, or I), H (hydride), unsubstituted hydrocarbyl, substituted hydrocarbyl, or a functional group comprising at least one element from Group 13-16 of the periodic table of the elements; each D of formula (II) is, independently, a monodentate donor ligand or a bidentate donor ligand; D and X of formula (II) are different; and n of formula (II) is a number greater than 0 (including non-integers), such as from greater than 0 to 2 or less, such as 1 or 2, a number less than 1, or a number between 1 and 2; and
(d) precipitating the mono-Cp metallocene compound represented by formula (II) from the reaction product mixture formed at (c) by adding a second solvent to the reaction product mixture formed at (c), the first solvent and the second solvent being the same or different.

Aspect 98. The method according to Aspect 97, wherein the reaction product mixture comprises the optional solid component, and the method further comprises: separating the liquid component of the reaction product mixture from the optional solid component of the reaction product mixture prior to the reacting the second mixture.

Aspect 99. The method according to Aspect 98, wherein the separating the liquid component of the reaction product mixture from the optional solid component of the reaction product mixture comprises: performing a solid-liquid separation on the reaction product mixture, the solid-liquid separation comprising any suitable solid liquid separation technique, such as filtration, vacuum filtration, centrifugation, decantation, decanting centrifugation, or combinations thereof.

Aspect 100. The method according to any one of Aspects 97-99, wherein the Group 4 metal (M) is Zr, Hf, or Ti, such as Zr or Hf.

Aspect 101. The method according to any one of Aspects 97-100, wherein Cp^{A} is represented by formula (IV), formula (V), or formula (VI):

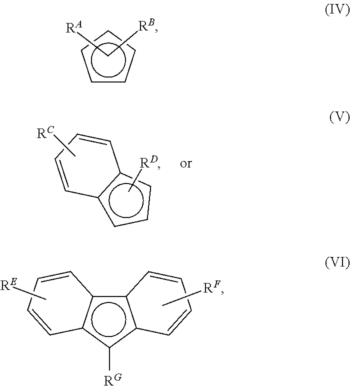

wherein: R^{A} and R^{B} are substituents on the 1, 2, 3, 4, and 5 positions of the cyclopentadienyl group; R^{C} is a substituent on the 1, 2, and 3 positions of the indenyl group; R^{D} is a substituent on the 4, 5, 6, and 7 positions of the indenyl group; R^{E} is a substituent on the 1, 2, 3, and 4 positions of the fluorenyl group; R^{F} is a substituent on the 5, 6, 7, and 8 positions of the fluorenyl group; R^{G} is a substituent on the 9 position of the fluorenyl group; and each of R^{A}, R^{B}, R^{C}, R^{D}, R^{E}, R^{F}, and R^{G} of formulas (IV)-(VI) is, independently, hydrogen, a C1-C18 unsubstituted hydrocarbyl, a C1-C18 substituted hydrocarbyl, halogen (such as F, Cl, Br, or I), or a functional group comprising at least one element from Group 13-16 of the periodic table of the elements, such as hydrogen or C1-C18 unsubstituted hydrocarbyl (for example, a C1-C12 unsubstituted hydrocarbyl, such as a C1-C8 unsubstituted hydrocarbyl, such as a C1-C6 unsubstituted hydrocarbyl, such as n-butyl or t-butyl).

Aspect 102. The method according to any one of Aspects 97-101, wherein: Cp^{A} is an unsubstituted cyclopentadienyl group, an unsubstituted indenyl group, an unsubstituted fluorenyl group, a monosubstituted cyclopentadienyl group, a monosubstituted indenyl group, a monosubstituted fluorenyl group, a disubstituted cyclopentadienyl group, a disubstituted indenyl group, or a disubstituted fluorenyl group.

Aspect 103. The method according to any one of Aspects 97-102, wherein the reacting the first mixture comprising the bis-Cp metallocene compound represented by formula (I), the metal salt, and the solvent to form the reaction product mixture is performed under first reaction conditions, the first reaction conditions comprising: a reaction temperature in a range from about 60° C. to about 140° C., such as from about 70° C. to about 130° C., such as from about 80° C. to about 120° C., such as from about 90° C. to about 110° C., such as from about 95° C. to about 105° C., such as from about 100° C. to 105° C., or from about 100° C. to about 110° C.; a reaction period in a range from about 1 hour to about 48 hours, such as from about 3 hours to about 36 hours, such as from about 5 hours to about 20 hours; or a combination thereof.

Aspect 104. The method according to any one of Aspects 97-103, wherein the metal salt comprises a halide of a Group 4 metal, such as ZrCl₄, HfCl₄, ZrBr₄, HfBr₄, or combinations thereof.

Aspect 105. The method according to any one of Aspects 97-104, wherein a molar ratio of the metal salt to the bis-Cp metallocene compound represented by formula (I) in the first mixture is in a range from about 0.7:1 to about 1.5:1, such as from about 0.8:1 to about 1.4:1, such as from about 0.9:1 to about 1.3:1, such as from about 1.1:1 to about 1:1 (metal salt:bis-Cp metallocene compound represented by formula (I)).

Aspect 106. The method according to any one of Aspects 97-105, wherein: the solvent comprises a non-coordinating solvent with a boiling point in a range from about 80° C. to about 180° C., such as a non-coordinating solvent with a boiling point in a range from about 80° C. to about 150° C.; and/or the solvent comprises heptane, octane, nonane, decane, toluene, ethylbenzene, o-xylene, m-xylene, p-xylene, or combinations thereof.

Aspect 107. The method according to any one of Aspects 97-106, wherein the liquid component of the reaction product mixture comprises a metallocene compound represented by formula (III):

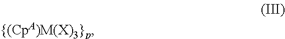

wherein: M of formula (III) is the Group 4 metal; each X of formula (III) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; Cp^{A} of formula (III) is the unsubstituted cyclopentadienyl group, the substituted cyclopentadienyl group, the unsubstituted indenyl group, the substituted indenyl group, the unsubstituted fluorenyl group, or the substituted fluorenyl group; and p of formula (III) is 1 or more, such as 1, 2, 3, 4, 5, etc.

Aspect 108. The method according to Aspect 107, wherein the metallocene compound represented by formula (III) is soluble in the solvent present in the liquid component.

Aspect 109. The method according to any one of Aspects 97-108, wherein the reacting the second mixture comprising the liquid component of the reaction product mixture and the donor molecule to form the mono-Cp metallocene compound represented by formula (II) comprises: contacting the donor molecule with a metallocene compound represented by formula (III): {(Cp^{A})M(X)₃}ₚ (III).

Aspect 110. The method according to any one of Aspects 97-109, wherein the reacting the second mixture comprising the liquid component of the reaction product mixture and the donor molecule to form the mono-Cp metallocene compound represented by formula (II) is performed under second reaction conditions, the second reaction conditions comprising: a reaction temperature in a range from about −20° C. to about 100° C., such as from about 0° C. to about 70° C., such as from about 10° C. to about 50° C., such as from about 15° C. to about 40° C., such as from about 20° C. to about 30° C.; a reaction period in a range from about 1 min to about 24 hours; or a combination thereof.

Aspect 111. The method according to any one of Aspects 97-110, wherein an amount of the donor molecule in the second mixture is based on an amount of the bis-Cp metallocene compound represented by formula (I) in the first mixture, a molar ratio of the donor molecule to the bis-Cp metallocene compound represented by formula (I) is from about 1:1 to about 10:1, such as from about 2:1 to about 8:1, such as from about 2.5:1 to about 7:1, such as from about 2.8:1 to about 6:1, or from about 1:1 to about 20:1, such as from about 2:1 to about 20:1, such as from about 2.3:1 to about 10:1, such as from about 2.5:1 to about 6.5:1 (donor molecule:bis-Cp metallocene compound represented by formula (I)).

Aspect 112. The method according to any one of Aspects 97-111, wherein: (a) the donor molecule coordinates to M of formula (II) as the donor ligand (D); (b) the donor molecule comprises at least one heteroatom or heteroatom-containing group, such as one or more elements from Group 13-16 of the periodic table of the elements; or (c) a combination thereof.

Aspect 113. The method according to any one of Aspects 97-112, wherein the donor molecule comprises a donor molecule represented by one or more of formulas (D-1)-(D-20):

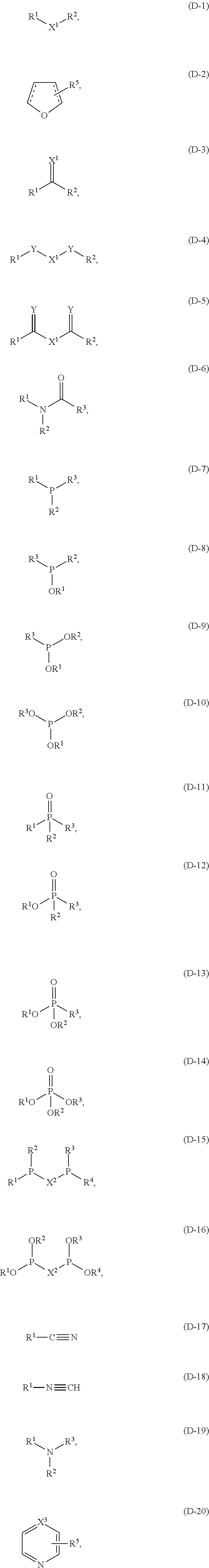

or combinations thereof,
wherein: each of R¹, R², R³, R⁴, and R⁵ of formulas (D-1)-(D-20) is, independently, hydrogen, a C1-C18 unsubstituted hydrocarbyl, such as a C1-C12 unsubstituted hydrocarbyl, such as a C1-C10 unsubstituted hydrocarbyl, such as a C1-C10 alkyl, alkenyl, or aryl, such as methyl, ethyl, propyl, butyl, pentyl, hexyl, heptyl, octyl, nonyl, decyl, 2-propen-1-yl, 3-buten-1-yl, 4-penten-1-yl, 5-hexen-1-yl, 6-hepten-1-yl, 7-octen-1-yl, 8-nonen-1-yl, 9-decen-lyl, phenyl, benzyl, naphthyl, or an isomer thereof, or two or more of R¹, R², R³, R⁴, or R⁵ join together to form a monocyclic or polycyclic ring structure; each X¹ of formulas (D-1)-(D-20) is, independently, O, S, (CH₂)ₙ, or Si; each X² of formulas (D-1)-(D-20) is (CH₂) n or phenylene; each X³ of formulas (D-1)-(D-20) is, independently, C or N; each Y of formulas (D-1)-(D-20) is, independently, O or S; and each n of formulas (D-1)-(D-20) is, independently, from 1 to 4.

Aspect 114. The method according to any one of Aspects 97-113, wherein the donor molecule comprises an alkylether, an arylether, a cyclic ether, a ketone, a glyme, or combinations thereof.

Aspect 115. The method according to Aspect 114, wherein the donor molecule comprises the alkylether, the alkylether comprising dimethyl ether, diethyl ether, methyl ethyl ether, methyl propyl ether, ethyl propyl ether, di-n-propyl ether, methyl butyl ether, ethyl butyl ether, di-n-butyl ether, methyl isopropyl ether, isomers thereof, or combinations thereof.

Aspect 116. The method according to any one of Aspects 114-115, wherein the donor molecule comprises the arylether, the arylether comprising anisole (methoxybenzene), phenyl ethyl ether, phenyl propyl ether, diphenyl ether, phenyl isopropyl ether, phenyl butyl ether, phenyl tert-butyl ether, phenyl pentyl ether, phenyl hexyl ether, phenyl heptyl ether, isomers thereof, or combinations thereof.

Aspect 117. The method according to any one of Aspects 114-116, wherein the donor molecule comprises the cyclic ether, the cyclic ether comprising tetrahydrofuran, dioxane, tetrahydropyran, 1,3-dioxane, 1,4-dioxane, furan, 2,5-dihydrofuran, pyran, 2H-pyran, 3,4-dihydro-2H-pyran, isomers thereof, or combinations thereof.

Aspect 118. The method according to any one of Aspects 114-117, wherein the donor molecule comprises the ketone, the ketone comprising methyl ethyl ketone, diethyl ketone, methyl isobutyl ketone, methyl n-propyl ketone, diisobutyl ketone, cyclohexanone, 2-pentanone, 3-pentanone, 2-hexanone, 3-hexanone, 4-methyl-2-pentanone, 2-heptanone, 3-heptanone, 4-heptanone, isomers thereof, or combinations thereof.

Aspect 119. The method according to any one of Aspects 114-118, wherein the donor molecule comprises the glyme, the glyme comprising 1,3-dimethoxypropane, 1-(2-methoxyethoxy) butane, 1,3-diethoxypropane, 1,2-dimethoxyethane, dimethoxymethane, 1-ethoxy-2-methoxyethane, 4,7-dioxadecane, 1-butoxy-2-ethoxyethane, ethylene glycol diethyl ether, glycol dibutyl ether, 1,1-dimethoxyethane, diethoxymethane, 2,2-dimethoxypropane, 1,2,3-trimethoxypropane, diglyme, trimethyl orthoformate, 2-(2-methoxyethoxy)-2-methylpropane, isomers thereof, or combinations thereof.

Aspect 120. The method according to any one of Aspects 97-119, wherein D of formula (II) is neutral, monoanionic, or dianionic.

Aspect 121. The method according to any one of Aspects 97-120, wherein X, D, and n of formula (II) are chosen such that the mono-Cp metallocene compound represented by formula (II) is, overall, neutral.

Aspect 122. The method according to any one of Aspects 97-121, wherein each D of formula (II) are monodentate donor ligands.

Aspect 123. The method according to Aspect 122, wherein each monodentate donor ligand (D) is the same or different monodentate donor ligand, such as the same monodentate donor ligand.

Aspect 124. The method according to any one of Aspects 97-123, wherein the donor molecule comprises dimethyl ether, diethyl ether, acetone, diethyl ketone, tetrahydrofuran, 1,2-dimethoxyethane, 1,3-dimethoxypropane, or combinations thereof.

Aspect 125. The method according to any one of Aspects 97-124, wherein the mono-Cp metallocene compound represented by formula (II) comprises a mono-Cp metallocene compound represented by one or more of formulas (II-A)-(II-C):

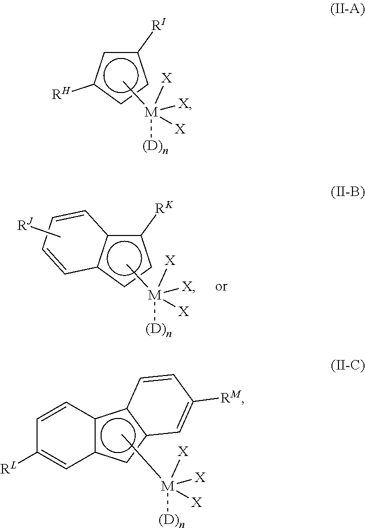

wherein: each of R^{H}, R^{I}, R^{J}, R^{K}, R^{L}, and R^{M} of formulas (II-A)-(II-C) is, independently, hydrogen or C1-C10 unsubstituted hydrocarbyl, such as C1-C10 alkyl, alkenyl, or aryl, such as methyl, ethyl, propyl, butyl, pentyl, hexyl, heptyl, octyl, nonyl, decyl, 2-propen-1-yl, 3-buten-1-yl, 4-penten-1-yl, 5-hexen-1-yl, 6-hepten-1-yl, 7-octen-1-yl, 8-nonen-1-yl, 9-decen-lyl, phenyl, benzyl, naphthyl, or an isomer thereof; each X of formulas (II-A)-(II-C) is, independently, a halide, such as F, Cl, Br, or I; each D of formulas (II-A)-(II-C) is, independently, a monodentate donor ligand or a bidentate donor ligand; D and X of formulas (II-A)-(II-C) are different; and n of formulas (II-A)-(II-C) is a number greater than 0 (including non-integers), such as from greater than 0 to 2 or less, such as 1 or 2, a number less than 1, or a number between 1 and 2.

Aspect 126. The method according to Aspect 125, wherein: each of R^{H}, R^{I}, R^{J}, R^{K}, R^{L}, and R^{M} of formulas (II-A)-(II-C) is, independently, hydrogen, methyl, ethyl, propyl, isopropyl, n-butyl, i-butyl, t-butyl, n-pentyl, i-pentyl, neo-pentyl, n-hexyl, CH₂═CHCH₂—, CH₂═CH(CH₂)₂—, phenyl, or Ph(CH₂)—.

Aspect 127. The method according to any one of Aspects 97-126, wherein the mono-Cp metallocene compound represented by formula (II) comprises one or more of mono-Cp metallocene compounds (II-1)-(II-44).

Aspect 128. The method according to any one of Aspects 97-127, wherein the donor molecule (or donor ligand) is configured to: stabilize the mono-Cp metallocene compound represented by formula (II); mitigate formation of oligomers ({(Cp^{A})(X)₃M}ₚ, P=2, 3, 4, etc.); mitigate decomposition of the mono-Cp metallocene compound represented by formula (II) to the metallocene compound represented by formula (III); mitigate formation of the metal salt and the bis-Cp metallocene compound represented by formula (I); or combinations thereof.

Aspect 129. The method according to any one of Aspects 97-128, wherein the donor molecule (or donor ligand) is configured to facilitate isolation, purification, or both, of the mono-Cp metallocene compound represented by formula (II).

Aspect 130. The method according to any one of Aspects 97-129, further comprising: isolating the mono-Cp metallocene compound represented by formula (II) from a second reaction product mixture formed from the reacting the second mixture, wherein the isolating the mono-Cp metallocene compound represented by formula (II) from the second reaction product mixture comprises: removing solvent from the second reaction product mixture; and then precipitating the mono-Cp metallocene compound represented by formula (II).

Aspect 131. The method according to any one of Aspects 97-130, further comprising:
contacting the mono-Cp metallocene compound represented by formula (II) with a complex of a Cp^{B} ligand to form an unbridged asymmetric metallocene compound represented by formula (VII):

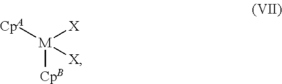

wherein: M of formula (VII) is the Group 4 metal, such as Ti, Zr, or Hf; each of Cp^{A} and Cp^{B} of formula (VII) are, independently, an unsubstituted cyclopentadienyl group, a substituted cyclopentadienyl group, an unsubstituted indenyl group, a substituted indenyl group, an unsubstituted fluorenyl group, or a substituted fluorenyl group; Cp^{A} and Cp^{B} of formula (VII) are different; each X of formula (VII) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; and each X of formula (VII) is different from D of formula (II).

Aspect 132. The method according to Aspect 131, wherein the unbridged asymmetric metallocene compound represented by formula (VII) comprises any suitable unbridged asymmetric metallocene compound described herein, for example, one or more of metallocene compounds (VII-1)-(VII-192).

Aspect 133. A method of synthesizing an unbridged asymmetric bis-Cp metallocene compound, the method comprising:
(a) reacting a first mixture comprising a bis-Cp metallocene compound represented by formula (I), a metal salt, and a first solvent to form a reaction product mixture comprising a liquid component and an optional solid component, the liquid component comprising the metallocene compound represented by formula (III), the bis-Cp metallocene compound represented by formula (I) is:

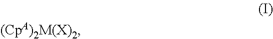

wherein: M of formula (I) is a Group 4 metal, such as Ti, Zr, or Hf; Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; and each X of formula (I) is, independently, a monoanionic ligand, such as halogen (such as F, Cl, Br, or I), H (hydride), unsubstituted hydrocarbyl, substituted hydrocarbyl, or a functional group comprising at least one element from Group 13-16 of the periodic table of the elements;
(b) isolating the metallocene compound represented by formula (III) from the reaction product mixture (for example, by filtration of the optional solid component followed by evaporation of volatiles such as the first solvent);
(c) reacting a second mixture comprising the metallocene compound represented by formula (III) and a donor molecule to form a reaction product mixture comprising a mono-Cp metallocene compound represented by formula (II):

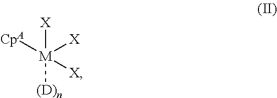

wherein: M of formula (II) is the Group 4 metal; Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group; each X of formula (II) is, independently, a monoanionic ligand, such as halogen (such as F, Cl, Br, or I), H (hydride), unsubstituted hydrocarbyl, substituted hydrocarbyl, or a functional group comprising at least one element from Group 13-16 of the periodic table of the elements; each D of formula (II) is, independently, a monodentate donor ligand or a bidentate donor ligand; D and X of formula (II) are different; and n of formula (II) is a number greater than 0 (including non-integers), such as from greater than 0 to 2 or less, such as 1 or 2, a number less than 1, or a number between 1 and 2;
(d) precipitating the mono-Cp metallocene compound represented by formula (II) from the reaction product mixture formed at (c) by adding a second solvent to the reaction product mixture formed at (c), the first solvent and the second solvent being the same or different; and
(e) contacting the mono-Cp metallocene compound represented by formula (II) with a complex of a Cp^{B} ligand to form an unbridged asymmetric metallocene compound represented by formula (VII):

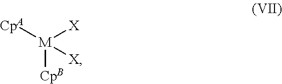

wherein: M of formula (VII) is the Group 4 metal, such as Ti, Zr, or Hf; each of Cp^{A} and Cp^{B} of formula (VII) are, independently, an unsubstituted cyclopentadienyl group, a substituted cyclopentadienyl group, an unsubstituted indenyl group, a substituted indenyl group, an unsubstituted fluorenyl group, or a substituted fluorenyl group; Cp^{A} and Cp^{B} of formula (VII) are different; each X of formula (VII) is, independently, a monoanionic ligand, such as halogen (such as F, Cl, Br, or I), H (hydride), unsubstituted hydrocarbyl, substituted hydrocarbyl, or a functional group comprising at least one element from Group 13-16 of the periodic table of the elements; and each X of formula (VII) is different from D of formula (II).

Aspect 134. The method according to Aspect 133, wherein the reaction product mixture comprises the optional solid component, and the method further comprises: separating the liquid component of the reaction product mixture from the optional solid component of the reaction product mixture prior to the reacting the second mixture.

Aspect 135. The method according to Aspect 134, wherein the separating the liquid component of the reaction product mixture from the optional solid component of the reaction product mixture comprises: performing a solid-liquid separation on the reaction product mixture, the solid-liquid separation comprising any suitable solid liquid separation technique, such as filtration, vacuum filtration, centrifugation, decantation, decanting centrifugation, or combinations thereof.

Aspect 136. The method according to any one of Aspects 133-135, wherein the Group 4 metal (M) is Zr, Hf, or Ti, such as Zr or Hf.

Aspect 137. The method according to any one of Aspects 133-136, wherein Cp^{A} is represented by formula (IV), formula (V), or formula (VI):

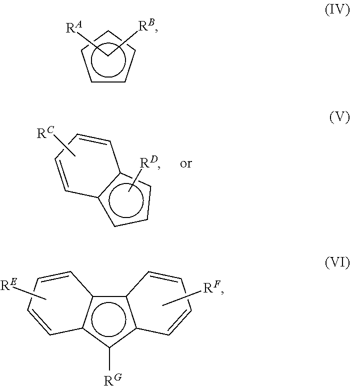

wherein: R^{A} and R^{B} are substituents on the 1, 2, 3, 4, and 5 positions of the cyclopentadienyl group; R^{C} is a substituent on the 1, 2, and 3 positions of the indenyl group; R^{D} is a substituent on the 4, 5, 6, and 7 positions of the indenyl group; R^{E} is a substituent on the 1, 2, 3, and 4 positions of the fluorenyl group; R^{F} is a substituent on the 5, 6, 7, and 8 positions of the fluorenyl group; R^{G} is a substituent on the 9 position of the fluorenyl group; and each of R^{A},
R^{B}, R^{C}, R^{D}, R^{E}, R^{E}, and R^{G} of formulas (IV)-(VI) is, independently, hydrogen, a C1-C18 unsubstituted hydrocarbyl, a C1-C18 substituted hydrocarbyl, halogen (such as F, Cl, Br, or I), or a functional group comprising at least one element from Group 13-16 of the periodic table of the elements, such as hydrogen or C1-C18 unsubstituted hydrocarbyl (for example, a C1-C12 unsubstituted hydrocarbyl, such as a C1-C8 unsubstituted hydrocarbyl, such as a C1-C6 unsubstituted hydrocarbyl, such as n-butyl or t-butyl).

Aspect 138. The method according to any one of Aspects 133-137, wherein: Cp^{A} is an unsubstituted cyclopentadienyl group, an unsubstituted indenyl group, an unsubstituted fluorenyl group, a monosubstituted cyclopentadienyl group, a monosubstituted indenyl group, a monosubstituted fluorenyl group, a disubstituted cyclopentadienyl group, a disubstituted indenyl group, or a disubstituted fluorenyl group.

Aspect 139. The method according to any one of Aspects 133-138, wherein the reacting the first mixture comprising the bis-Cp metallocene compound represented by formula (I), the metal salt, and the solvent to form the reaction product mixture is performed under first reaction conditions, the first reaction conditions comprising: a reaction temperature in a range from about 60° C. to about 140° C., such as from about 70° C. to about 130° C., such as from about 80° C. to about 120° C., such as from about 90° C. to about 110° C., such as from about 95° C. to about 105° C., such as from about 100° C. to 105° C., or from about 100° C. to about 110° C.; a reaction period in a range from about 1 hour to about 48 hours, such as from about 3 hours to about 36 hours, such as from about 5 hours to about 20 hours; or a combination thereof.

Aspect 140. The method according to any one of Aspects 133-139, wherein the metal salt comprises a halide of a Group 4 metal, such as ZrCl₄, HfCl₄, ZrBr₄, HfBr₄, or combinations thereof.

Aspect 141. The method according to any one of Aspects 133-140, wherein a molar ratio of the metal salt to the bis-Cp metallocene compound represented by formula (I) in the first mixture is in a range from about 0.7:1 to about 1.5:1, such as from about 0.8:1 to about 1.4:1, such as from about 0.9:1 to about 1.3:1, such as from about 1.1:1 to about 1:1 (metal salt:bis-Cp metallocene compound represented by formula (I)).

Aspect 142. The method according to any one of Aspects 133-141, wherein: the solvent comprises a non-coordinating solvent with a boiling point in a range from about 80° C. to about 180° C., such as a non-coordinating solvent with a boiling point in a range from about 80° C. to about 150° C.; and/or the solvent comprises heptane, octane, nonane, decane, toluene, ethylbenzene, o-xylene, m-xylene, p-xylene, or combinations thereof.

Aspect 143. The method according to any one of Aspects 133-142, wherein the liquid component of the reaction product mixture comprises a metallocene compound represented by formula (III):

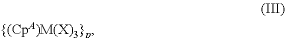

wherein: M of formula (III) is the Group 4 metal; each X of formula (III) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; Cp^{A} of formula (III) is the unsubstituted cyclopentadienyl group, the substituted cyclopentadienyl group, the unsubstituted indenyl group, the substituted indenyl group, the unsubstituted fluorenyl group, or the substituted fluorenyl group; and p of formula (III) is 1 or more, such as 1, 2, 3, 4, 5, etc.

Aspect 144. The method according to Aspect 143, wherein the metallocene compound represented by formula (III) is soluble in the solvent present in the liquid component.

Aspect 145. The method according to any one of Aspects 133-144, wherein the reacting the second mixture comprising the liquid component of the reaction product mixture and the donor molecule to form the mono-Cp metallocene compound represented by formula (II) comprises: contacting the donor molecule with a metallocene compound represented by formula (III): {(Cp^{A})M(X)₃}ₚ (III).

Aspect 146. The method according to any one of Aspects 133-145, wherein the reacting the second mixture comprising the liquid component of the reaction product mixture and the donor molecule to form the mono-Cp metallocene compound represented by formula (II) is performed under second reaction conditions, the second reaction conditions comprising: a reaction temperature in a range from about −20° C. to about 100° C., such as from about 0° C. to about 70° C., such as from about 10° C. to about 50° C., such as from about 15° C. to about 40° C., such as from about 20° C. to about 30° C.; a reaction period in a range from about 1 min to about 24 hours; or a combination thereof.

Aspect 147. The method according to any one of Aspects 133-146, wherein an amount of the donor molecule in the second mixture is based on an amount of the bis-Cp metallocene compound represented by formula (I) in the first mixture, a molar ratio of the donor molecule to the bis-Cp metallocene compound represented by formula (I) is from about 1:1 to about 10:1, such as from about 2:1 to about 8:1, such as from about 2.5:1 to about 7:1, such as from about 2.8:1 to about 6:1, or from about 1:1 to about 20:1, such as from about 2:1 to about 20:1, such as from about 2.3:1 to about 10:1, such as from about 2.5:1 to about 6.5:1 (donor molecule:bis-Cp metallocene compound represented by formula (I)).

Aspect 148. The method according to any one of Aspects 133-147, wherein: (a) the donor molecule coordinates to M of formula (II) as the donor ligand (D); (b) the donor molecule comprises at least one heteroatom or heteroatom-containing group, such as one or more elements from Group 13-16 of the periodic table of the elements; or (c) a combination thereof.

Aspect 149. The method according to any one of Aspects 133-148, wherein the donor molecule comprises a donor molecule represented by one or more of formulas (D-1)-(D-20):

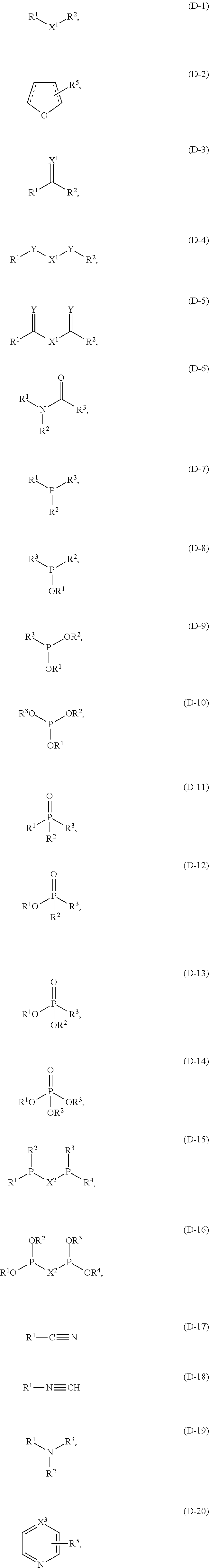

or combinations thereof,
wherein: each of R¹, R², R³, R⁴, and R⁵ of formulas (D-1)-(D-20) is, independently, hydrogen, a C1-C18 unsubstituted hydrocarbyl, such as a C1-C12 unsubstituted hydrocarbyl, such as a C1-C10 unsubstituted hydrocarbyl, such as a C1-C10 alkyl, alkenyl, or aryl, such as methyl, ethyl, propyl, butyl, pentyl, hexyl, heptyl, octyl, nonyl, decyl, 2-propen-1-yl, 3-buten-1-yl, 4-penten-1-yl, 5-hexen-1-yl, 6-hepten-1-yl, 7-octen-1-yl, 8-nonen-1-yl, 9-decen-lyl, phenyl, benzyl, naphthyl, or an isomer thereof, or two or more of R¹, R², R³, R⁴, or R⁵ join together to form a monocyclic or polycyclic ring structure; each X¹ of formulas (D-1)-(D-20) is, independently, O, S, (CH₂)ₙ, or Si; each X² of formulas (D-1)-(D-20) is (CH₂)ₙ or phenylene; each X³ of formulas (D-1)-(D-20) is, independently, C or N; each Y of formulas (D-1)-(D-20) is, independently, O or S; and each n of formulas (D-1)-(D-20) is, independently, from 1 to 4.

Aspect 150. The method according to any one of Aspects 133-149, wherein the donor molecule comprises an alkylether, an arylether, a cyclic ether, a ketone, a glyme, or combinations thereof.

Aspect 151. The method according to Aspect 150, wherein the donor molecule comprises the alkylether, the alkylether comprising dimethyl ether, diethyl ether, methyl ethyl ether, methyl propyl ether, ethyl propyl ether, di-n-propyl ether, methyl butyl ether, ethyl butyl ether, di-n-butyl ether, methyl isopropyl ether, isomers thereof, or combinations thereof.

Aspect 152. The method according to any one of Aspects 150-151, wherein the donor molecule comprises the arylether, the arylether comprising anisole (methoxybenzene), phenyl ethyl ether, phenyl propyl ether, diphenyl ether, phenyl isopropyl ether, phenyl butyl ether, phenyl tert-butyl ether, phenyl pentyl ether, phenyl hexyl ether, phenyl heptyl ether, isomers thereof, or combinations thereof.

Aspect 153. The method according to any one of Aspects 150-152, wherein the donor molecule comprises the cyclic ether, the cyclic ether comprising tetrahydrofuran, dioxane, tetrahydropyran, 1,3-dioxane, 1,4-dioxane, furan, 2,5-dihydrofuran, pyran, 2H-pyran, 3,4-dihydro-2H-pyran, isomers thereof, or combinations thereof.

Aspect 154. The method according to any one of Aspects 150-153, wherein the donor molecule comprises the ketone, the ketone comprising methyl ethyl ketone, diethyl ketone, methyl isobutyl ketone, methyl n-propyl ketone, diisobutyl ketone, cyclohexanone, 2-pentanone, 3-pentanone, 2-hexanone, 3-hexanone, 4-methyl-2-pentanone, 2-heptanone, 3-heptanone, 4-heptanone, isomers thereof, or combinations thereof.

Aspect 155. The method according to any one of Aspects 150-154, wherein the donor molecule comprises the glyme, the glyme comprising 1,3-dimethoxypropane, 1-(2-methoxyethoxy) butane, 1,3-diethoxypropane, 1,2-dimethoxyethane, dimethoxymethane, 1-ethoxy-2-methoxyethane, 4,7-dioxadecane, 1-butoxy-2-ethoxyethane, ethylene glycol diethyl ether, glycol dibutyl ether, 1,1-dimethoxyethane, diethoxymethane, 2,2-dimethoxypropane, 1,2,3-trimethoxypropane, diglyme, trimethyl orthoformate, 2-(2-methoxyethoxy)-2-methylpropane, isomers thereof, or combinations thereof.

Aspect 156. The method according to any one of Aspects 133-155, wherein D of formula (II) is neutral, monoanionic, or dianionic.

Aspect 157. The method according to any one of Aspects 133-156, wherein X, D, and n of formula (II) are chosen such that the mono-Cp metallocene compound represented by formula (II) is, overall, neutral.

Aspect 158. The method according to any one of Aspects 133-157, wherein each D of formula (II) are monodentate donor ligands.

Aspect 159. The method according to Aspect 158, wherein each monodentate donor ligand (D) is the same or different monodentate donor ligand, such as the same monodentate donor ligand.

Aspect 160. The method according to any one of Aspects 133-159, wherein the donor molecule comprises dimethyl ether, diethyl ether, acetone, diethyl ketone, tetrahydrofuran, 1,2-dimethoxyethane, 1,3-dimethoxypropane, or combinations thereof.

Aspect 161. The method according to any one of Aspects 133-160, wherein the mono-Cp metallocene compound represented by formula (II) comprises a mono-Cp metallocene compound represented by one or more of formulas (II-A)-(II-C):

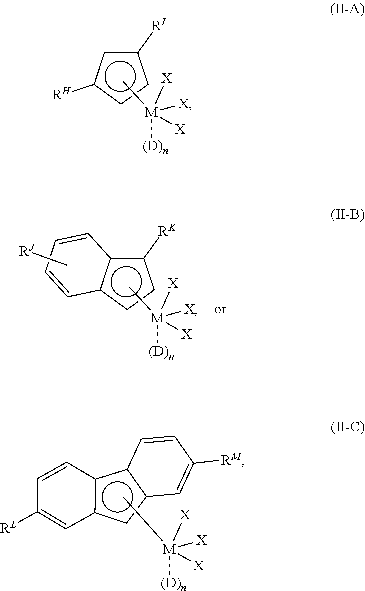

wherein: each of R^{H}, R^{I}, R^{J}, R^{K}, R^{L}, and R^{M} of formulas (II-A)-(II-C) is, independently, hydrogen or C1-C10 unsubstituted hydrocarbyl, such as C1-C10 alkyl, alkenyl, or aryl, such as methyl, ethyl, propyl, butyl, pentyl, hexyl, heptyl, octyl, nonyl, decyl, 2-propen-1-yl, 3-buten-1-yl, 4-penten-1-yl, 5-hexen-1-yl, 6-hepten-1-yl, 7-octen-1-yl, 8-nonen-1-yl, 9-decen-lyl, phenyl, benzyl, naphthyl, or an isomer thereof; each X of formulas (II-A)-(II-C) is, independently, a halide, such as F, Cl, Br, or I; each D of formulas (II-A)-(II-C) is, independently, a monodentate donor ligand or a bidentate donor ligand; D and X of formulas (II-A)-(II-C) are different; and n of formulas (II-A)-(II-C) is a number greater than 0 (including non-integers), such as from greater than 0 to 2 or less, such as 1 or 2, a number less than 1, or a number between 1 and 2.

Aspect 162. The method according to Aspect 161, wherein: each of R^{H}, R^{I}, R′, R^{K}, R^{L}, and R^{M} of formulas (II-A)-(II-C) is, independently, hydrogen, methyl, ethyl, propyl, isopropyl, n-butyl, i-butyl, t-butyl, n-pentyl, i-pentyl, neo-pentyl, n-hexyl, CH₂═CHCH₂—, CH₂═CH(CH₂)₂—, phenyl, or Ph(CH₂)—.

Aspect 163. The method according to any one of Aspects 133-162, wherein the mono-Cp metallocene compound represented by formula (II) comprises one or more of mono-Cp metallocene compounds (II-1)-(II-44).

Aspect 164. The method according to any one of Aspects 133-163, wherein the donor molecule (or donor ligand) is configured to: stabilize the mono-Cp metallocene compound represented by formula (II); mitigate formation of oligomers ({(Cp^{A})(X)₃M}ₚ, p=2, 3, 4, etc.); mitigate decomposition of the mono-Cp metallocene compound represented by formula (II) to the metallocene compound represented by formula (III); mitigate formation of the metal salt and the bis-Cp metallocene compound represented by formula (I); or combinations thereof.

Aspect 165. The method according to any one of Aspects 133-164, wherein the donor molecule (or donor ligand) is configured to facilitate isolation, purification, or both, of the mono-Cp metallocene compound represented by formula (II).

Aspect 166. The method according to any one of Aspects 133-165, further comprising: isolating the mono-Cp metallocene compound represented by formula (II) from a second reaction product mixture formed from the reacting the second mixture, wherein the isolating the mono-Cp metallocene compound represented by formula (II) from the second reaction product mixture comprises: removing solvent from the second reaction product mixture; and then precipitating the mono-Cp metallocene compound represented by formula (II).

Aspect 167. The method according to any one of Aspects 133-166, further comprising:
contacting the mono-Cp metallocene compound represented by formula (II) with a complex of a Cp^{B} ligand to form an unbridged asymmetric metallocene compound represented by formula (VII):

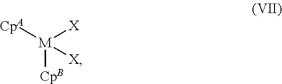

wherein: M of formula (VII) is the Group 4 metal, such as Ti, Zr, or Hf; each of Cp^{A} and Cp^{B} of formula (VII) are, independently, an unsubstituted cyclopentadienyl group, a substituted cyclopentadienyl group, an unsubstituted indenyl group, a substituted indenyl group, an unsubstituted fluorenyl group, or a substituted fluorenyl group; Cp^{A} and Cp^{B} of formula (VII) are different; each X of formula (VII) is, independently, a monoanionic ligand, such as H, halogen (such as F, Cl, Br, or I), unsubstituted hydrocarbyl, substituted hydrocarbyl, or a functional group comprising at least one element from Group 13-16 of the periodic table of the elements; and each X of formula (VII) is different from D of formula (II).

Aspect 168. The method according to Aspect 167, wherein the unbridged asymmetric metallocene compound represented by formula (VII) comprises any suitable unbridged asymmetric metallocene compound described herein, for example, one or more of metallocene compounds (VII-1)-(VII-192).

Aspect 169. The method according to any one of Aspects 1-168, wherein the method is a solution-based method.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), may be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Generally, groups of elements are indicated using the numbering scheme indicated in the version of the periodic table of elements published in Chemical and Engineering News, 63(5), 27, 1985. In some instances, a group of elements may be indicated using a common name assigned to the group; for example, alkali metals for Group 1 elements, alkaline earth metals for Group 2 elements, transition metals for Group 3-12 elements, and halogens or halides for Group 17 elements.

“Hydrocarbon” refers to a compound containing only carbon and hydrogen. The term “hydrocarbyl group” is used herein in accordance with the definition specified by IUPAC: a univalent group formed by removing a hydrogen atom from a hydrocarbon (that is, a group containing only carbon and hydrogen). Other identifiers may be utilized to indicate the presence of particular groups in the hydrocarbon (e.g., halogenated hydrocarbon indicates the presence of one or more halogen atoms replacing an equivalent number of hydrogen atoms in the hydrocarbon). Hydrocarbyl groups may be linear or branched, saturated or unsaturated, cyclic or acyclic, aromatic or non-aromatic. Regarding saturation, hydrocarbyl groups may be fully saturated, partially unsaturated, or fully unsaturated.

A group or groups may be referred to herein as “unsubstituted” or by equivalent terms such as “non-substituted,” which refers to the original group (e.g., a hydrocarbyl, an R group, a ring, or other group) in which a non-hydrogen moiety does not replace a hydrogen within that group. For example, an unsubstituted R group refers to an R group that consists of hydrogen and carbon atoms only. “Unsubstituted hydrocarbyl” includes groups having a C1-C100 group and may be linear or branched, acyclic or cyclic, saturated or unsaturated. When cyclic, the unsubstituted hydrocarbyl may be aromatic or non-aromatic. Regarding saturation, the unsubstituted hydrocarbyl may be fully saturated, partially unsaturated, or fully unsaturated. Examples of unsubstituted hydrocarbyl groups may include alkyl, alkenyl, aryl, and aralkyl groups, amongst other groups Non-limiting examples of unsubstituted hydrocarbyl include a group having from 1 to 100 carbon atoms, such as from 1 to 30 carbon atoms, such as 1 to 20 carbon atoms, such as 3 to 10 carbon atoms, such as methyl, ethyl, n-propyl, isopropyl, n-butyl, iso-butyl, sec-butyl, and tert-butyl, pentyl, hexyl, heptyl, octyl, ethyl-2-hexyl, isooctyl, butyl-2-octyl, nonyl, n-decyl, isodecyl, or isomers thereof; a cycloaliphatic group having from 3 to 20 carbon atoms such as, for example, cyclopentyl or cyclohexyl; an alkenyl group having from 2 to 20 carbon atoms such as propenyl, butenyl, pentenyl, or hexenyl, an aromatic group having from 6 to 20 carbon atoms such as, for example, phenyl, tolyl, or naphthyl; or any combination thereof.

The term “substituted” when used to describe a group (e.g., a hydrocarbyl, an R group, a ring, or other group), for example, when referring to a substituted analog of a particular group, is intended to describe any non-hydrogen moiety that formally replaces a hydrogen in that group, and is intended to be non-limiting. Unless otherwise specified, “substituted” is intended to be non-limiting and include inorganic substituents or organic substituents as understood by one of ordinary skill in the art. For example, a substituted R group or substituted hydrocarbyl refers to a group where at least one hydrogen of the R group or the unsubstituted hydrocarbyl has been substituted with at least one heteroatom or heteroatom-containing group, such as a halogen or one or more elements from Group 13-16 of the periodic table of the elements, such as O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or hydrocarbyl, or where at least one heteroatom has been inserted within the R group or the unsubstituted hydrocarbyl. Substituted hydrocarbyl groups may be linear or branched, saturated or unsaturated, cyclic or acyclic, aromatic or non-aromatic. Regarding saturation, hydrocarbyl groups may be fully saturated, partially unsaturated, or fully unsaturated.

Unless specified to the contrary or the context clearly indicates otherwise, the term “halogen” refers to fluorine, chlorine, bromine, and iodine, regardless of whether these elements are in neutral or anionic form or occur as molecular or polymeric substituents or atoms in a solid-state structure.

A functional group comprising at least one element from Group 13-16 of the periodic table of the elements may include O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or hydrocarbyl. Functional group comprising at least one element from Group 13-16 include at least one non-carbon atom.

When a compound is described herein such that a particular isomer, enantiomer, or diastereomer of the compound is not specified, for example, in a formula or in a chemical name, that description is intended to include each isomer and enantiomer of the compound described individual or in any combination. For example, any general structure, formula, or name presented is also intended to encompass all structural isomers, conformational isomers, regioisomers, stereoisomers (such as enantiomers, diastereomers, and other optical isomers whether in enantiomeric or racemic forms, as well as mixtures of stereoisomers, as the context permits or requires) that may arise from a particular set of substituents, unless indicated otherwise. Thus, a general reference to a compound includes all structural isomers unless specified to the contrary or the context clearly indicates otherwise. For example, reference to a hydrocarbon without specifying a particular isomer (such as butyl) expressly discloses all isomers (such as n-butyl, iso-butyl, sec-butyl, and tert-butyl). For example, reference to a C4 hydrocarbon expressly discloses all isomers thereof.

The term “metallocene” describes compounds comprising at least one η³ to η⁵-cycloalkadienyl-type moiety, wherein η³ to η⁵-cycloalkadienyl moieties include cyclopentadienyl ligands, indenyl ligands, fluorenyl ligands, and the like, including partially saturated or substituted derivatives or analogs of any of these. Possible substituents on these ligands may include H, therefore aspects described herein may include ligands such as tetrahydroindenyl, tetrahydrofluorenyl, octahydrofluorenyl, partially saturated indenyl, partially saturated fluorenyl, substituted partially saturated indenyl, substituted partially saturated fluorenyl, and the like. Metallocene compounds described herein may be in the form of a metallocene complex.

The term “contacting” refers to materials which may be blended, mixed, slurried, dissolved, reacted, treated, or otherwise combined in some other manner.

As is apparent from the foregoing general description and the specific aspects, while forms of the aspects have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a formulation, a composition, an element or a group of elements is preceded with the transitional phrase “comprising,” it is understood that we also contemplate the same formulation, composition or group of elements with transitional phrases “consisting essentially of,” “consisting of,” “selected from the group of consisting of,” or “is” preceding the recitation of the formulation, composition, element, or elements and vice versa, for example, the terms “comprising,” “consisting essentially of,” “consisting of” also include the product of the combinations of elements listed after the term.

References cited herein are incorporated by reference herein in their entirety to indicate the state of the art as of their publication or filing date and it is intended that this information may be employed herein, if desired, to exclude specific aspects that are in the prior art.

For purposes of this present disclosure, and unless otherwise specified, all numerical values within the detailed description and the claims herein are modified by “about” or “approximately” the indicated value, and consider experimental error and variations that would be expected by a person having ordinary skill in the art. It will be further understood that there are a number of values disclosed therein, and that each value is also herein disclosed as “about” that particular value in addition to the value itself. Herein experimental error and experimental variations may refer to ±20% of the stated value, ±15% of the stated value, ±10% of the stated value, ±5% of the stated value, ±3% of the stated value, ±2% of the stated value, or ±1% of the stated value.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited. For example, by disclosing a temperature of from 70° C. to 80° C., an intent is to recite individually 70° C., 71° C., 72° C., 73° C., 74° C., 75° C., 76° C., 77° C., 78° C., 79° C., and 80° C., including any sub-ranges and combinations of sub-ranges encompassed therein such that any of the foregoing numbers may be used singly to describe an open-ended range or in combination to describe a close-ended range. Moreover, all numerical end points of ranges disclosed herein are approximate, unless excluded by proviso. As a representative example, if one or more operations in the processes described herein may be conducted at a temperature in a range from 10° C. to 75° C., this range should be interpreted as encompassing temperatures in a range from “about” 10° C. to “about” 75° C. As another example, when a chemical moiety having a certain number of carbon atoms is disclosed or claimed, the intent is to disclose or claim individually every possible number that such a range could encompass, consistent with the disclosure herein. For example, the disclosure that a moiety is a C1-C18 hydrocarbyl group, or in alternative language, a hydrocarbyl group having from 1 to 18 carbon atoms, refers to a moiety that may have 1, 2, 3, 4, 5, 6, 7, 8, 9, 10, 11, 12, 13, 14, 15, 16, 17, or 18 carbon atoms, as well as any range between these two numbers (for example, a C1-C8 hydrocarbyl group), and also including any combination of ranges between these two numbers (for example, a C₂ to C₄ and a C₁₂ to C₁₆ hydrocarbyl group).

A “composition” may include component(s) of the composition, reaction product(s) of two or more components of the composition, a remainder balance of remaining starting component(s), or combinations thereof.

The indefinite article “a” or “an” shall mean “at least one” unless specified to the contrary or the context clearly indicates otherwise. For example, aspects comprising “a donor molecule” include aspects comprising one, two, or more donor molecules, unless specified to the contrary or the context clearly indicates only one donor molecule is included.

While the foregoing is directed to aspects of the present disclosure, other and further aspects of the disclosure may be devised without departing from the basic scope thereof, and the scope thereof is determined by the claims that follow.

What is claimed is:

1. A method of synthesizing a metallocene compound, the method comprising:
reacting a first mixture comprising a bis-Cp metallocene compound represented by formula (I), a metal salt, and a solvent to form a reaction product mixture comprising a liquid component and an optional solid component, the bis-Cp metallocene compound represented by formula (I) is: 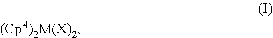
wherein:
M of formula (I) is a Group 4 metal;
Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; and
each X of formula (I) is, independently, H (hydride), a halogen, unsubstituted hydrocarbyl, substituted hydrocarbyl, or a functional group comprising at least one element from Group 13-16 of the periodic table of the elements; and
reacting a second mixture comprising the liquid component of the reaction product mixture and a donor molecule to form a mono-Cp metallocene compound represented by formula (II): 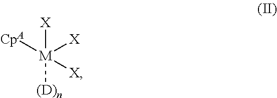
wherein:
M of formula (II) is the Group 4 metal;
Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group;
each X of formula (II) is, independently, H (hydride), a halogen, unsubstituted hydrocarbyl, substituted hydrocarbyl, or a functional group comprising at least one element from Group 13-16 of the periodic table of the elements;
D of formula (II) is, independently, a monodentate donor ligand or a bidentate donor ligand;
D and X of formula (II) are different; and
n of formula (II) is a number greater than 0.

2. The method according to claim 1, wherein the reaction product mixture comprises the optional solid component, the method further comprises:
separating the liquid component of the reaction product mixture from the optional solid component of the reaction product mixture prior to reacting the second mixture.

3. The method according to claim 1, wherein the Group 4 metal is Zr or Hf.

4. The method according to claim 1, wherein Cp^{A} is represented by formula (IV), formula (V), or formula (VI): 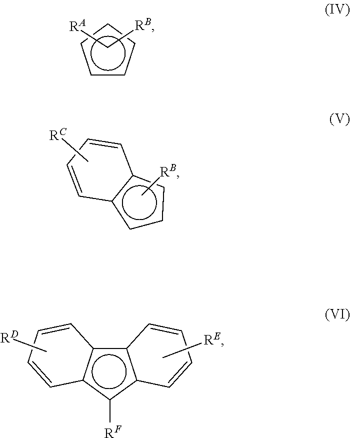
wherein:
each of R^{A}, R^{B}, R^{C}, R^{D}, R^{E}, R^{F}, and R^{G} of formulas (IV)-(VI) is, independently, hydrogen, a C1-C18 unsubstituted hydrocarbyl, a C1-C18 substituted hydrocarbyl, or a functional group comprising at least one element from Group 13-16 of the periodic table of the elements.

5. The method according to claim 1, wherein:
reacting the first mixture comprising the bis-Cp metallocene compound represented by formula (I), the metal salt, and the solvent to form the reaction product mixture is performed under first reaction conditions, the first reaction conditions comprising:
a reaction temperature in a range from about 60° C. to about 140° C.;
a molar ratio of the metal salt to the bis-Cp metallocene compound represented by formula (I) in the first mixture is in a range from about 0.7:1 to about 1.5:1 (metal salt:bis-Cp metallocene compound represented by formula (I));
the solvent comprises a non-coordinating solvent with a boiling point in a range from about 80° C. to about 180° C.; or
combinations thereof.

6. The method according to claim 1, wherein reacting the second mixture comprising the liquid component of the reaction product mixture and the donor molecule to form the mono-Cp metallocene compound represented by formula (II) comprises:
contacting the donor molecule with a metallocene compound represented by formula (III): 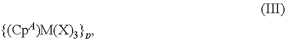
wherein:
M of formula (III) is the Group 4 metal;
each X of formula (III) is, independently, H, a halogen, unsubstituted hydrocarbyl, substituted hydrocarbyl, or a functional group comprising at least one element from Group 13-16 of the periodic table of the elements;
Cp^{A} of formula (III) is the unsubstituted cyclopentadienyl group, the substituted cyclopentadienyl group, the unsubstituted indenyl group, the substituted indenyl group, the unsubstituted fluorenyl group, or the substituted fluorenyl group; and
p of formula (III) is 1 or more.

7. The method according to claim 1, wherein:
reacting the second mixture comprising the liquid component of the reaction product mixture and the donor molecule to form the mono-Cp metallocene compound represented by formula (II) is performed under second reaction conditions, the second reaction conditions comprising: a reaction temperature in a range from about −20° C. to about 100° C.;
an amount of the donor molecule in the second mixture is based on an amount of the bis-Cp metallocene compound represented by formula (I) in the first mixture, a molar ratio of the donor molecule to the bis-Cp metallocene compound represented by formula (I) is from about 1:1 to about 10:1 (donor molecule:bis-Cp metallocene compound represented by formula (I)); or
a combination thereof.

8. The method according to claim 1, wherein the donor molecule comprises a donor molecule represented by one or more of formulas (D-1)-(D-20): 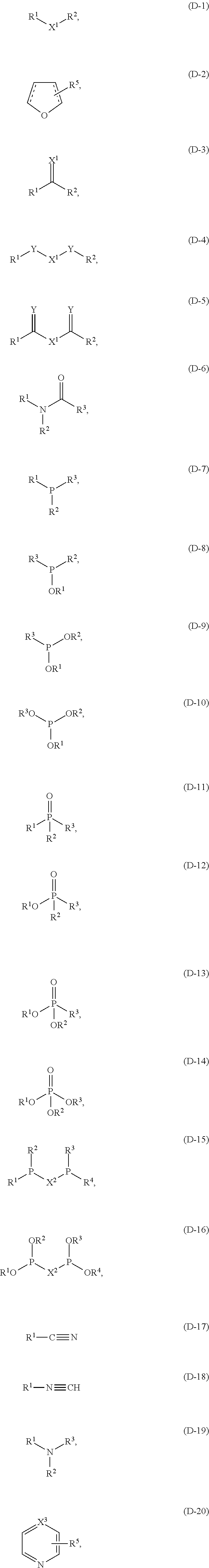
or combinations thereof,
wherein:
each of R¹, R², R³, R⁴, and R⁵ of formulas (D-1)-(D-20) is, independently, hydrogen, a C1-C10 alkyl, alkenyl, or aryl, or two or more of R¹, R², R³, R⁴, or R⁵ join together to form a monocyclic or polycyclic ring structure;
each X¹ of formulas (D-1)-(D-20) is, independently, O, S, (CH₂)ₙ, or Si;
each X² of formulas (D-1)-(D-20) is, independently, (CH₂)ₙ or phenylene;
each X³ of formulas (D-1)-(D-20) is, independently, C or N;
each Y of formulas (D-1)-(D-20) is, independently, O or S; and
each n of formulas (D-1)-(D-20) is, independently, from 1 to 4.

9. The method according to claim 1, wherein the donor molecule comprises an alkylether, an arylether, a cyclic ether, a ketone, a glyme, or combinations thereof.

10. The method according to claim 1, wherein the donor molecule comprises dimethyl ether, diethyl ether, acetone, diethyl ketone, tetrahydrofuran, 1,2-dimethoxyethane, 1,3-dimethoxypropane, or combinations thereof.

11. The method according to claim 1, wherein D of formula (II) is a bidentate donor ligand.

12. The method according to claim 1, wherein the mono-Cp metallocene compound represented by formula (II) comprises a metallocene compound represented by one or more of formulas (II-A)-(II-C): 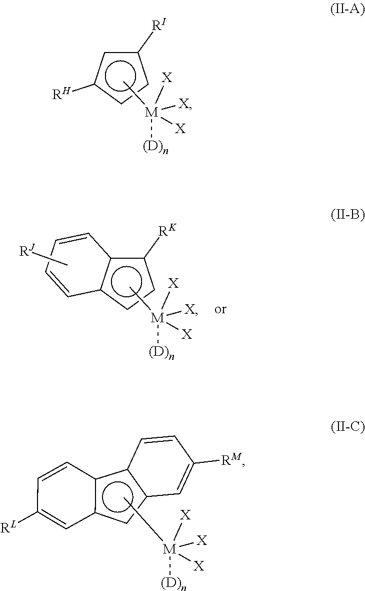
wherein:
each of R^{H}, R^{I}, R^{J}, R^{K}, R^{L}, and R^{M} of formulas (II-A)-(II-C) is, independently, hydrogen, methyl, ethyl, propyl, isopropyl, n-butyl, i-butyl, t-butyl, n-pentyl, i-pentyl, neo-pentyl, n-hexyl, CH₂═CHCH₂—, CH₂═CH(CH₂)₂—, phenyl, or Ph(CH₂);
each X of formulas (II-A)-(II-C) is, independently, a monoanionic ligand;
each D of formulas (II-A)-(II-C) is, independently, a monodentate donor ligand or a bidentate donor ligand;
D and X of formulas (II-A)-(II-C) are different; and
n of formulas (II-A)-(II-C) is a number greater than 0.

13. The method according to claim 1, further comprising:
contacting the mono-Cp metallocene compound represented by formula (II) with a complex of a Cp^{B} ligand to form an unbridged asymmetric metallocene compound represented by formula (VII): 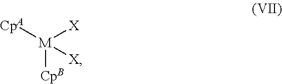
wherein:
M of formula (VII) is the Group 4 metal;
each of Cp^{A} and Cp^{B} of formula (VII) are, independently, an unsubstituted cyclopentadienyl group, a substituted cyclopentadienyl group, an unsubstituted indenyl group, a substituted indenyl group, an unsubstituted fluorenyl group, or a substituted fluorenyl group;
Cp^{A} and Cp^{B} of formula (VII) are different;
each X of formula (VII) is, independently H, a halogen, unsubstituted hydrocarbyl, substituted hydrocarbyl, or a functional group comprising at least one element from Group 13-16 of the periodic table of the elements; and
each X of formula (VII) is different from D of formula (II).

14. A method of synthesizing a metallocene compound, the method comprising:
reacting a first mixture comprising a bis-Cp metallocene compound represented by formula (I), a metal salt, and a solvent to form a reaction product mixture comprising a liquid component and a solid component, the bis-Cp metallocene compound represented by formula (I) is: 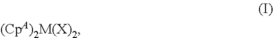
wherein:
M of formula (I) is a Group 4 metal;
Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; and
each X of formula (I) is, independently, H (hydride), a halogen, unsubstituted hydrocarbyl, substituted hydrocarbyl, or a functional group comprising at least one element from Group 13-16 of the periodic table of the elements;
separating the liquid component of the reaction product mixture from the solid component of the reaction product mixture; and
reacting a second mixture comprising the liquid component of the reaction product mixture and a donor molecule to form a mono-Cp metallocene compound represented by formula (II): 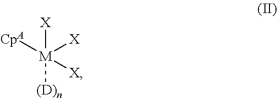
wherein:
M of formula (II) is the Group 4 metal;
Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group;
each X of formula (II) is, independently, H (hydride), a halogen, unsubstituted hydrocarbyl, substituted hydrocarbyl, or a functional group comprising at least one element from Group 13-16 of the periodic table of the elements;
D of formula (II) is, independently, a monodentate donor ligand or a bidentate donor ligand;
D and X of formula (II) are different; and
n of formula (II) is a number greater than 0.

15. The method according to claim 14, wherein Cp^{A} is an unsubstituted cyclopentadienyl group, an unsubstituted indenyl group, an unsubstituted fluorenyl group, a monosubstituted cyclopentadienyl group, a monosubstituted indenyl group, a monosubstituted fluorenyl group, a disubstituted cyclopentadienyl group, a disubstituted indenyl group, or a disubstituted fluorenyl group.

16. The method according to claim 14, wherein:
a molar ratio of the metal salt to the bis-Cp metallocene compound represented by formula (I) in the first mixture is in a range from about 0.9:1 to about 1.3:1 (metal salt:bis-Cp metallocene compound represented by formula (I));
the solvent comprises a non-coordinating solvent with a boiling point in a range from about 80° C. to about 150° C.;
an amount of the donor molecule in the second mixture is based on an amount of the bis-Cp metallocene compound represented by formula (I) in the first mixture, a molar ratio of the donor molecule to the bis-Cp metallocene compound represented by formula (I) is from about 1:1 to about 20:1 (donor molecule:bis-Cp metallocene compound represented by formula (I));
the donor molecule comprises an alkylether, an arylether, a cyclic ether, a ketone, a glyme, or combinations thereof;
reacting the second mixture comprising the liquid component of the reaction product mixture and the donor molecule to form the mono-Cp metallocene compound represented by formula (II) is performed under second reaction conditions, the second reaction conditions comprising: a reaction temperature in a range from about −20° C. to about 100° C.; or
or combinations thereof.

17. The method according to claim 14, wherein the donor molecule comprises dimethyl ether, diethyl ether, acetone, diethyl ketone, tetrahydrofuran, 1,2-dimethoxyethane, 1,3-dimethoxypropane, or combinations thereof.

18. The method according to claim 14, further comprising:
contacting the mono-Cp metallocene compound represented by formula (II) with a complex of a Cp^{B} ligand to form an unbridged asymmetric metallocene compound represented by formula (VII): 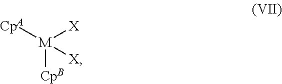
wherein:
M of formula (VII) is the Group 4 metal;
each of Cp^{A} and Cp^{B} of formula (VII) are, independently, an unsubstituted cyclopentadienyl group, a substituted cyclopentadienyl group, an unsubstituted indenyl group, a substituted indenyl group, an unsubstituted fluorenyl group, or a substituted fluorenyl group;
Cp^{A} and Cp^{B} of formula (VII) are different;
each X of formula (VII) is, independently H, a halogen, unsubstituted hydrocarbyl, substituted hydrocarbyl, or a functional group comprising at least one element from Group 13-16 of the periodic table of the elements; and
each X of formula (VII) is different from D of formula (II).

19. A method of synthesizing an unbridged asymmetric metallocene compound, the method comprising:
reacting a first mixture comprising a bis-Cp metallocene compound represented by formula (I), a metal salt, and a solvent to form a reaction product mixture comprising a liquid component and an optional solid component, the bis-Cp metallocene compound represented by formula (I) is: 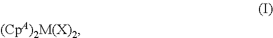
wherein:
M of formula (I) is a Group 4 metal;
Cp^{A} of formula (I) is an unsubstituted cyclopentadienyl group, a substituted cyclopentadienyl group, an unsubstituted indenyl group, a substituted indenyl group, an unsubstituted fluorenyl group, or a substituted fluorenyl group; and
each X of formula (I) is, independently, H (hydride), a halogen, unsubstituted hydrocarbyl, substituted hydrocarbyl, or a functional group comprising at least one element from Group 13-16 of the periodic table of the elements;
reacting a second mixture comprising the liquid component of the reaction product mixture and a donor molecule to form a mono-Cp metallocene compound represented by formula (II): 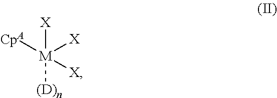
wherein:
M of formula (II) is the Group 4 metal;
Cp^{A} of formula (II) is the unsubstituted cyclopentadienyl group, the substituted cyclopentadienyl group, the unsubstituted indenyl group, the substituted indenyl group, the unsubstituted fluorenyl group, or the substituted fluorenyl group;
each X of formula (II) is, independently, H (hydride), a halogen, unsubstituted hydrocarbyl, substituted hydrocarbyl, or a functional group comprising at least one element from Group 13-16 of the periodic table of the elements;
D of formula (II) is, independently, a monodentate donor ligand or a bidentate donor ligand;
D and X of formula (II) are different; and
n of formula (II) is a number greater than 0; and
contacting the mono-Cp metallocene compound represented by formula (II) with a complex of a Cp^{B} ligand to form an unbridged asymmetric metallocene compound represented by formula (VII): 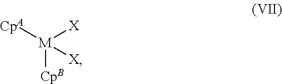
wherein:
M of formula (VII) is the Group 4 metal;
Cp^{A} of formula (VII) is the unsubstituted cyclopentadienyl group, the substituted cyclopentadienyl group, the unsubstituted indenyl group, the substituted indenyl group, the unsubstituted fluorenyl group, or the substituted fluorenyl group;
Cp^{B} of formula (VII) is an unsubstituted cyclopentadienyl group, a substituted cyclopentadienyl group, an unsubstituted indenyl group, a substituted indenyl group, an unsubstituted fluorenyl group, or a substituted fluorenyl group;
Cp^{A} and Cp^{B} of formula (VII) are different;
each X of formula (VII) is, independently H, a halogen, unsubstituted hydrocarbyl, substituted hydrocarbyl, or a functional group comprising at least one element from Group 13-16 of the periodic table of the elements; and
each X of formula (VII) is different from D of formula (II).

20. The method according to claim 19, wherein the reaction product mixture comprises the optional solid component, and the method further comprises:
separating the liquid component of the reaction product mixture from the optional solid component of the reaction product mixture prior to reacting the second mixture.
